(19) United States
(12) Patent Application Publication
(10) Pub. No.: US 2011/0243422 A1
(43) Pub. Date: Oct. 6, 2011

(54) PAPER-SHEET PROCESSING APPARATUS AND PAPER-SHEET PROCESSING METHOD

(75) Inventors: Kenichi Matsuo, Hyogo (JP); Koichi Nishida, Hyogo (JP)

(73) Assignee: GLORY LTD.

(21) Appl. No.: 12/751,304

(22) Filed: Mar. 31, 2010

(51) Int. Cl. G06K 9/00

(52) U.S. Cl. 382/139

(57) ABSTRACT

A paper-sheet processing apparatus including a reading unit, a risk-level determining unit, and a check processing unit is provided. The reading unit reads, from a check, check information containing drawer information for identifying a drawer of the check. The risk-level determining unit acquires a transaction history associated with a check in the name of the drawer based on the drawer information read by the reading unit, and determines a risk level of the check based on a comparison result between the acquired transaction history and the check information read by the reading unit. The check processing unit processes the check based on a processing content corresponding to the risk level determined by the risk-level determining unit.

### BACKGROUND OF THE INVENTION

1. Field of the Invention

The present invention relates to a paper-sheet processing apparatus and a paper-sheet processing method for processing a paper sheet including a check.

2. Description of the Related Art

Conventionally, check cashing has been performed manually by bank staff and the like. Therefore, in a financial institution such as a bank, teller windows are sometimes crowded with a large number of customers cashing checks. In such a case, the financial institution needs to assign a large number of staff to deal with the customers.

In recent years, to solve the above-mentioned problem, automation of check cashing has been tried. For example, Japanese Patent Application Laid-open No. 2006-155531 discloses a check processing apparatus that reads amount information written on a check, and deposits money into a user's account in an amount corresponding to the read amount information.

Furthermore, in recent years, ATMs (Automated Teller Machines) equipped with functions similar to those of the check processing apparatus disclosed in Japanese Patent Application Laid-open No. 2006-155531 have been increasingly installed in stores such as convenience stores and supermarkets. In this case, stores may charge a uniform expensive handling fee to users for processing a check by taking risks such as counterfeiting or dishonor into consideration.

However, the above-mentioned ATMs have a problem in that convenience for both users and stores is low because uniform handling fees are charged to the users regardless of whether the actual risk is high or low.

In other words, some users may be charged unfairly expensive fees even when they actually perform highly secure transactions. Furthermore, stores may fail to attract prospective customers when users avoid using the above-mentioned ATMs because of the expensive handling fees.

Thus, when a check is processed based on a uniform processing content without considering the risk for handling the check, convenience for both users and stores may be reduced.

Furthermore, it is desired by stores to improve attraction of customers and sales by installing the above-mentioned ATMs.

In view of the above, there is a growing demand for a paper-sheet processing apparatus and a paper-sheet processing method that are able to process checks based on individual processing contents corresponding to risks borne by stores.

### SUMMARY OF THE INVENTION

According to one embodiment of the invention, a paper-sheet processing apparatus is for processing a paper sheet including a check, and includes a reading unit that reads, from the check, check information containing an amount of the check; a risk-level determining unit that determines a risk level related to handling of the check based on a matching result between the check information read by the reading unit and a predetermined confirmation item; and a check processing unit that processes the check based on a processing content corresponding to the risk level determined by the risk-level determining unit.

In another aspect of the invention, a paper-sheet processing apparatus is for processing a paper sheet including a check, and includes an authenticating unit that authenticates a user; a reading unit that reads, from the check, check information containing an amount of the check; a fee changing unit that changes a fee necessary for cashing the check based on either user information associated with the user authenticated by the authenticating unit or the check information read by the reading unit; and a cashing processing unit that performs a cashing process of the check based on the amount read by the reading unit and a fee changed by the fee changing unit.

In still another aspect of the invention, a check processing apparatus is for processing a check, and includes a check inlet unit that receives the check; a transport unit that transports the check input from the check inlet unit; a reading unit that reads, from the check transported by the transport unit, check information containing a check amount; a storing unit that stores therein the check; and a post-processing determining unit that determines, as post processing of a check from which the check information has been read by the reading unit, whether to store the check to the storing unit or to return the check based on the check information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A to 1C are diagrams illustrating an overview of a paper-sheet processing technique according to the present invention;

FIG. 2 is a diagram illustrating a network environment to which a check processing apparatus according to a first embodiment is connected;

FIG. 3 is a block diagram of a configuration of the check processing apparatus according to the first embodiment;

FIG. 4 is an external view of the check processing apparatus;

FIGS. 5A and 5B are diagrams representing an example of check information;

FIG. 6 is a diagram representing an example of a handling disapproval condition;

FIGS. 7A and 7B are diagrams representing an example of determination by using a handling disapproval history;

FIGS. 8A and 8B are diagrams representing an example of determination by using a disallowed list or an allowed list;

FIGS. 9A and 9B are diagrams representing an example of determination by using information provided by a regional company;

FIGS. 10A and 10B are diagrams representing an example of determination by using a result of learning combinations of users and drawers;

FIG. 11 is a flowchart of a process procedure performed by the check processing apparatus according to the first embodiment;

FIG. 12 is a block diagram of a configuration of a check processing apparatus according to a second embodiment;

FIGS. 13A and 13B are diagrams representing an example of operations by a risk-level determining unit, a fee setting unit, and an abnormality-handling processing unit;

FIG. 14 is a diagram for explaining a remote confirmation process;

FIGS. 15A and 15B are diagrams representing an example of another operation by the risk-level determining unit;

FIGS. 16A and 16B are diagrams representing an example of another operation by the risk-level determining unit;

FIG. 17 is a flowchart of a process procedure performed by the check processing apparatus according to the second embodiment;

FIGS. 18A to 18C are diagrams for explaining a case in which a risk level is determined based on a transaction history for a drawer;

FIGS. 19A to 19C are diagrams for explaining a case in which the risk level is determined by signature matching;

FIGS. 20A and 20B are diagrams representing an example of another operation by the risk-level determining unit;

FIG. 21 is a diagram representing another example of confirmation items;

FIG. 22 is a diagram illustrating a network environment to which a check processing apparatus according to a third embodiment is connected;

FIG. 23 is a block diagram of a configuration of the check processing apparatus according to the third embodiment;

FIG. 24 is a diagram representing an example of a reduction condition;

FIGS. 25A to 25C are diagrams representing an example of operations by a fee changing unit;

FIGS. 26A to 26C are diagrams representing an example of operations by a cashing processing unit;

FIG. 27 is a flowchart of a process procedure performed by the check processing apparatus according to the third embodiment;

FIG. 28 is a diagram illustrating an overview of a check processing technique according to the present invention;

FIG. 29 is a block diagram of a configuration of a check processing apparatus according to the present embodiment;

FIG. 30 is a diagram illustrating external and internal structures of the check processing apparatus;

FIGS. 31A and 31B are diagrams representing an example of operations performed by a control unit when check information has normally been read;

FIGS. 32A and 32B are diagrams representing an example of operations performed by the control unit when an unreadable item is present in the check information;

FIG. 33 is a flowchart of a process procedure performed by the check processing apparatus according to the present embodiment; and

FIGS. 34A to 34C are diagrams for explaining situations in which checks are stacked in a sorted manner.

### DETAILED DESCRIPTION OF THE PREFERRED EMBODIMENTS

Exemplary embodiments of a paper-sheet processing apparatus and a paper-sheet processing method according to the present invention will be explained in detail below with reference to the accompanying drawings. In the following descriptions, a check processing apparatus that performs a check-cashing process will be explained as an example of the paper-sheet processing apparatus. However, the present invention is not limited to this example, and the paper-sheet processing apparatus of the present invention may be applied to banknote handling apparatuses that perform a banknote deposit/dispense process and the like.

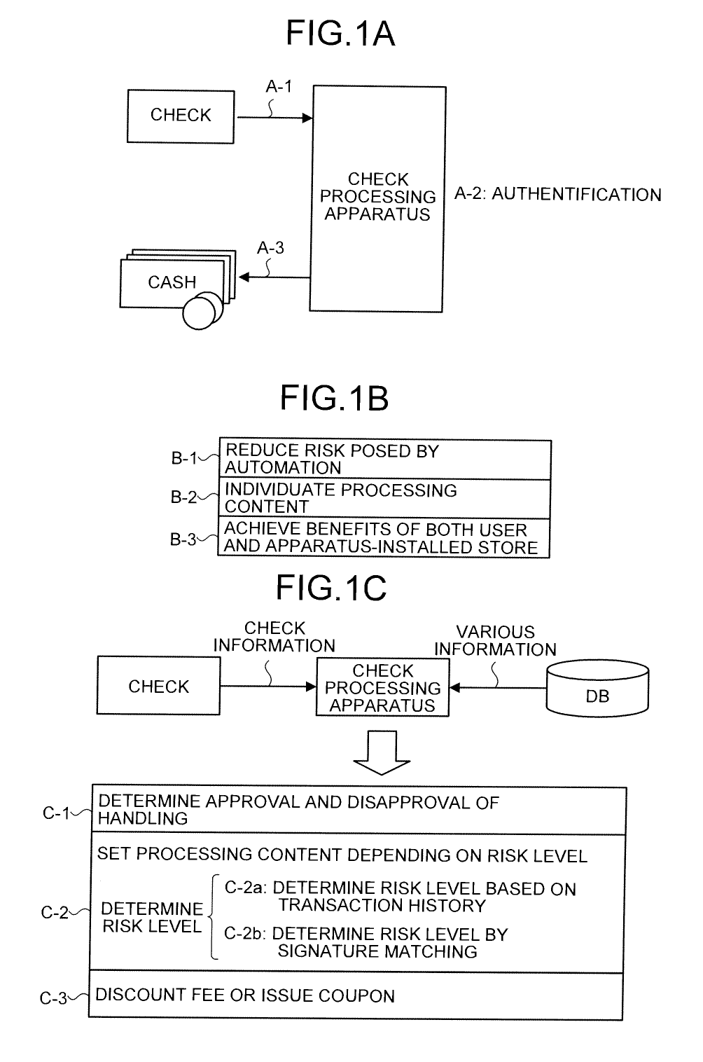

An overview of a paper-sheet processing technique of the present invention is described below with reference to FIGS. 1A to 1C before presenting detailed descriptions of the embodiments. FIGS. 1A to 1C are diagrams illustrating the overview of the paper-sheet processing technique according to the present invention. More specifically, FIG. 1A illustrates an overview of a check processing apparatus; FIG. 1B illustrates problems related to automation of a check-cashing process; and FIG. 1C illustrates an overview of processes performed by the check processing apparatus of the present invention, as solutions to each problem.

As shown in FIG. 1A, when receiving a check (see A-1 of FIG. 1A), the check processing apparatus of the present invention verifies authenticity of the received check (see A-2 of FIG. 1A), and dispenses cash in a check amount (see A-3 of FIG. 1A). Thus, the check processing apparatus of the present invention functions as an apparatus that automates a check-cashing process that has been performed manually at teller windows in financial institutions. Such functions performing a banknote deposit/dispense process are described more fully in U.S. Pat. No. 6,771,180 on Aug. 3, 2004 and No. 7,040,476 on May 9, 2006, the contents of which are hereby incorporated by reference.

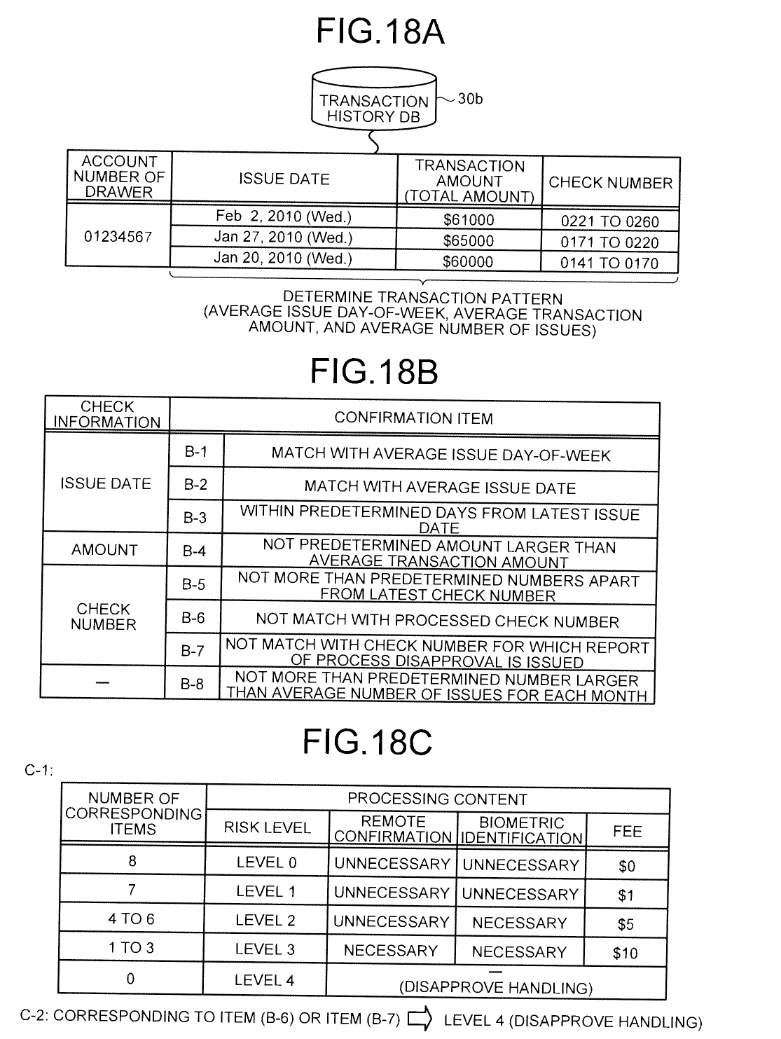

When the check-cashing process is to be automated, it is desirable to prevent financial institutions from being disadvantaged because of handling of counterfeit checks, bounced checks, and the like. That is, it is desirable to provide a scheme for reducing risks borne by the financial institutions (see B-1 of FIG. 18).

Furthermore, the check processing apparatus of the present invention may be installed not only in the financial institutions but also in stores other than the financial institutions, e.g., convenience stores and supermarkets. In this case, stores may charge a fee for the check-cashing process by taking risks such as counterfeiting or dishonor into consideration.

If a uniform fee is charged to a user regardless of whether the risk is high or low, it is likely that convenience for both the user and the store is reduced. Therefore, when the check-cashing process is to be automated, it is desirable to take risks borne by the store into consideration and process a check based on a processing content corresponding to each transaction (see B-2 of FIG. 1B).

Moreover, when the check processing apparatus of the present invention is installed in the stores other than the financial institutions, it is desirable to consider improvement in attraction of customers and sales of the stores with the check processing apparatus (see B-3 of FIG. 1B).

To solve the problems illustrated in B-1 to B-3 of FIG. 1B, the check processing apparatus of the present invention performs the processes illustrated in C-1 to C-3 of FIG. 1C by using various types of information read from a check and various types of information stored in a DB (database).

More specifically, the check processing apparatus of the present invention determines whether handling of the received check is approved or disapproved by confirming whether the various types of information read from the check (hereinafter, referred to as “check information”) match a predetermined handling disapproval condition (see C-1 of FIG. 1C).

In other words, the check processing apparatus of the present invention does not handle a high-risk check at least by the apparatus, so that it is possible to reduce risks borne by the financial institutions. When determining that the handling of the received check is disapproved, the check processing apparatus of the present invention may inform a user that the check needs to be processed at a teller window. In this case, the check processing apparatus of the present invention is able to streamline operations at the teller window by notifying a result of the process such as the determination process performed by the apparatus.

Furthermore, the check processing apparatus of the present invention determines a risk level related to the handling of the check by using the check information and the information acquired from the DB, and processes the check based on a processing content corresponding to the determined risk level (see C-2 of FIG. 1C). Consequently, it is possible to process the check based on an individual processing content corresponding to the risk borne by the store. The check processing apparatus is able to set a higher fee as the risk level is increased, or to request an operator to perform remote confirmation when the risk level is high.

When determining the risk level, the check processing apparatus of the present invention may determine the risk level based on a transaction history (see C-2a of FIG. 1C). More specifically, the check processing apparatus of the present invention acquires from the DB a transaction history associated with a drawer of the check or a user of the check processing apparatus, and determines the risk level based on the acquired transaction history (see C-2a of FIG. 1C). By determining the risk level based on past records of use by the drawer or the user in this manner, it is possible to perform more specific and concrete operations.

Furthermore, the check processing apparatus of the present invention may determine the risk level by signature matching (see C-2b of FIG. 1C). More specifically, the check processing apparatus of the present invention acquires from the DB a history of images of signatures that have been written on checks in the past by the drawer of the check or by the user of the check processing apparatus, and determines the risk level based on a matching result with a currently-acquired signature image. By determining the risk level by the signature matching in this manner, it is possible to perform a transaction with higher security.

Moreover, the check processing apparatus of the present invention discounts a fee or issues a coupon ticket available at the store with the check processing apparatus based on the check information and the information acquired from the DB (see C-3 of FIG. 1C).

Accordingly, the user is able to benefit from the discounted fee or using the coupon ticket, and the store with the check processing apparatus is able to improve attraction of customers or sales by issuing the coupon ticket. Therefore, benefits of both the user and the store with the check processing apparatus can be achieved simultaneously. The check processing apparatus may increase a discount amount as the user uses the store with the check processing apparatus more number of times or spends more amount of money at the store with the check processing apparatus. With this configuration, it is possible to further improve the ability to attract customers.

Described below are exemplary embodiments of the paper-sheet processing apparatus and the paper-sheet processing method to which the paper-sheet processing technique described above with reference to FIGS. 1A to 1C is applied.

### First Embodiment

In a first embodiment, with the aim of reducing a risk borne by the financial institution, a case is described in which whether handling of a check is approved or disapproved is determined based on a matching result between the check information and the handling disapproval condition (corresponding to C-1 of FIG. 1C).

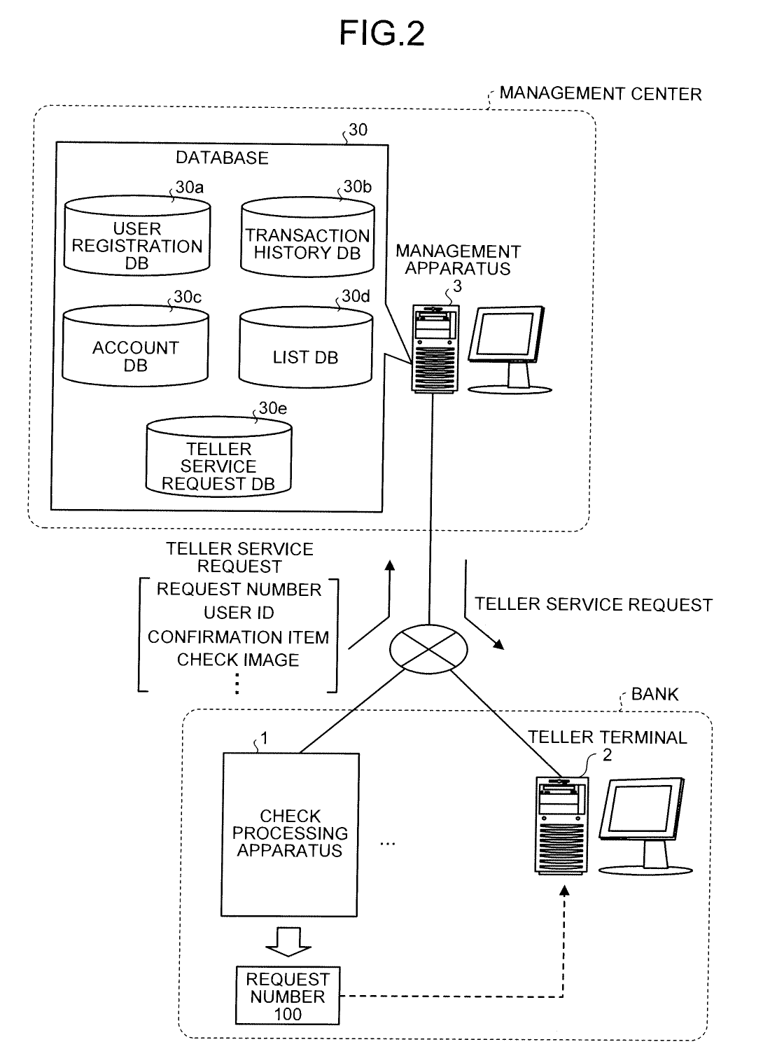

FIG. 2 is a diagram illustrating a network environment to which a check processing apparatus according to the first embodiment is connected. As shown in the figure, a check processing apparatus 1 according to the first embodiment is installed in a bank, and connected to a teller terminal 2 via a network such as a LAN (Local Area Network). The teller terminal 2 is a terminal equipment such as a PC (Personal Computer) installed at a teller window in the bank, and is used by a bank teller.

The check processing apparatus 1 is also connected to a management apparatus 3 in a management center located in a remote place, via a network such as a WAN (Wide Area Network). The management apparatus 3 is an apparatus that centrally manages each check-processing apparatus installed in a head office and branches of the bank.

The management apparatus 3 includes a database 30 containing various types of DBs such as a user registration DB 30a, a transaction history DB 30b, an account DB 30c, a list DB 30d, and a teller service request DB 30e.

The user registration DB 30a is a database for storing registration information associated with users of the check processing apparatus 1. More specifically, the user registration DB 30a stores therein information, such as names, contact information, passwords, and biometric information of users, in association with respective user IDs.

The user registration DB 30a also stores therein a “high usage day” and an “average cashed amount” for each user, in association with a corresponding user ID. The “high usage day” is information indicating days on which a user frequently uses the check processing apparatus 1. For example, several days before and after a payday may be stored as the “high usage day”. Furthermore, the “average cashed amount” is information indicating an average check amount cashed by a user by using the check processing apparatus 1. The “high usage day” and the “average cashed amount” are calculated by the management apparatus 3 based on the transaction history DB 30b.

The transaction history DB 30b is a database for storing transaction histories associated with users and drawers of checks, respectively. More specifically, the transaction history DB 30b stores therein information, e.g., a transaction date and a transaction amount for a check processed by the check processing apparatus 1, a signature image of a user, and the like, in association with each user ID. The transaction history DB 30b also stores therein information, such as an issue date of a check, a check amount, or a check number of the issued check, in association with an account number of a drawer.

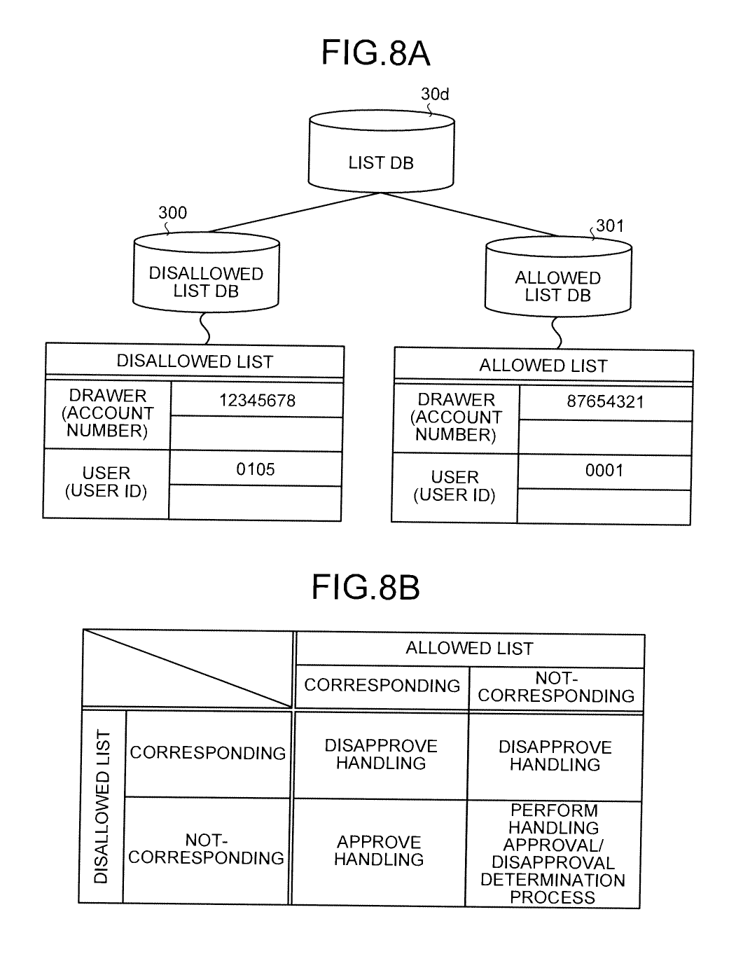

The account database 30c is a database for storing information associated with an account owned by a drawer of a check. The list DB 30d is a database for storing a disallowed list and an allowed list. A method of using the list DB 30d will be described later with reference to FIGS. 8A and 8B.

The teller service request DB 30e is a database for storing teller-service request information received from the check processing apparatus 1. The teller-service request information is information created by the check processing apparatus 1 when the check processing apparatus 1 determines that handling of a check is disapproved. The teller-service request information contains information such as a request number, a user ID, and an item required to be confirmed at a teller window. When dealing with a user who has been instructed by the check processing apparatus 1 to process a check at the teller window, a bank teller can efficiently deal with the user by performing operations with reference to the various types of information contained in the teller-service request information. This will be described in detail later.

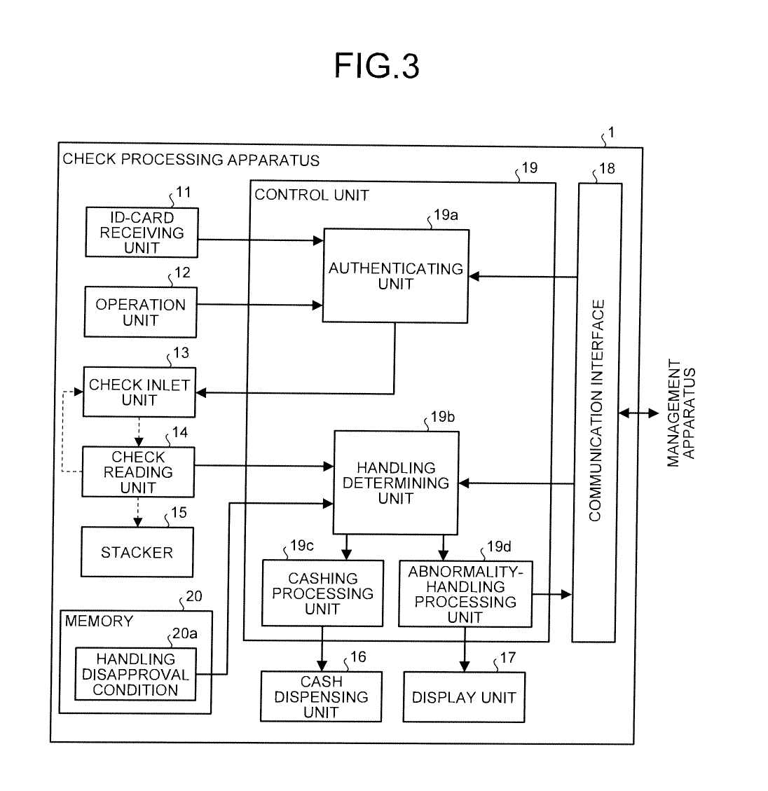

Next, a configuration of the check processing apparatus 1 of the first embodiment is described below with reference to FIG. 3. FIG. 3 is a block diagram of the configuration of the check processing apparatus 1 according to the first embodiment.

As shown in the figure, the check processing apparatus 1 includes an ID-card receiving unit 11, an operation unit 12, a check inlet unit 13, a check reading unit 14, a stacker 15, a cash dispensing unit 16, a display unit 17, a communication interface 18, a control unit 19, and a memory 20. The control unit 19 includes an authenticating unit 19a, a handling determining unit 19b, a cashing processing unit 19c, and an abnormality-handling processing unit 19d. The memory 20 stores therein a handling disapproval condition 20a.

The ID-card receiving unit 11 receives an ID card owned by a user, and reads a user ID from the received ID card. The ID-card receiving unit 11 also performs a process of sending the read user ID to the authenticating unit 19a upon reading the user ID from the ID card.

The operation unit 12 receives various types of operations from the user. More specifically, the operation unit 12 receives an operation of inputting a password from the user, and sends the received password to the authenticating unit 19a.

The check inlet unit 13 is an opening on a top surface of the apparatus, and feeds a check input into a transport path inside the apparatus by using a roller and the like. The check inlet unit 13 is equipped with a shutter at the opening portion, and, when a user is authenticated by the authenticating unit 19a, the check inlet unit 13 drives the shutter in an open direction so that a check can be input.

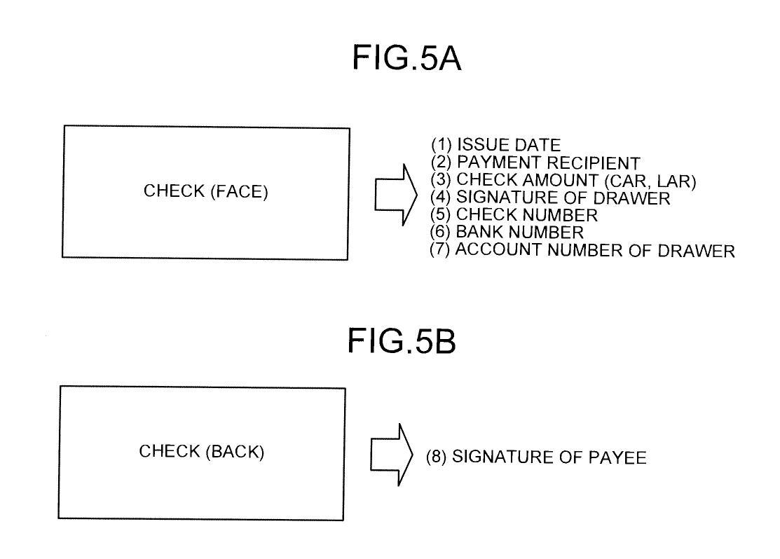

The check reading unit 14 is a check reading apparatus, such as a scanner. The check reading unit 14 reads various types of information, such as a check amount and an account number, from the check transported through the transport path inside the apparatus. Upon reading the information from the check, the check reading unit 14 performs a process of sending the read information (check information) to the handling determining unit 19b. Detailed contents of the check information will be described later with reference to FIGS. 5A and 5B. The stacker 15 is a storing unit for storing the check whose check information has been read by the check reading unit 14.

The cash dispensing unit 16 is an opening formed similarly to the check inlet unit 13, and accumulates banknotes fed from the inside of the apparatus according to an instruction from the cashing processing unit 19c. The display unit 17 is a display device that displays various types of information. For example, the display unit 17 displays a notice that a check needs to be processed at a teller window according to an instruction from the abnormality-handling processing unit 19d. The communication interface 18 is a communication device that transmits and receives communication data to and from the management apparatus 3 in the management center.

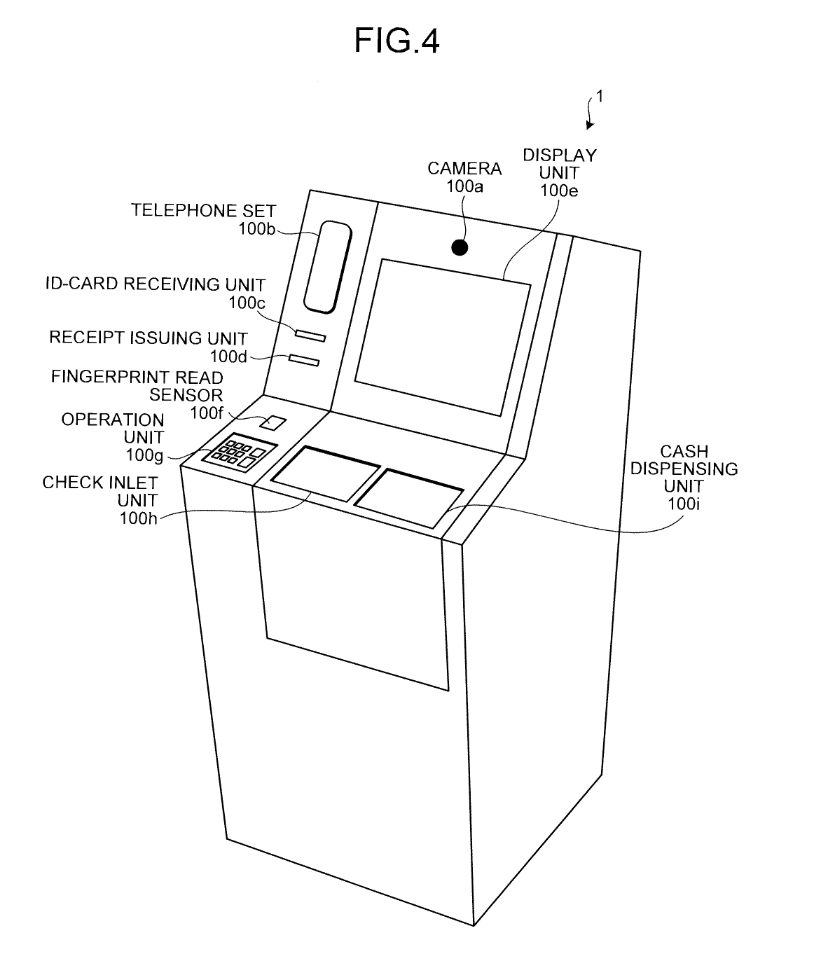

An external structure of the check processing apparatus 1 shown in FIG. 3 is described below with reference to FIG. 4. FIG. 4 is an external view of the check processing apparatus 1.

As shown in FIG. 4, the check processing apparatus 1 includes a camera 100a for imaging a face and the like of a user, and a telephone set 100b for talking to an operator in the management center. The check processing apparatus 1 also includes an ID-card receiving unit 100c (corresponding to “the ID-card receiving unit 11”), a receipt issuing unit 100d that issues a payment slip with a written transaction result and the like, and a display unit 100e (corresponding to “the display unit 17”). The receipt issuing unit 100d also issues a teller service ticket to be described later.

The check processing apparatus 1 also includes a fingerprint read sensor 100f that reads fingerprint information of a user, an operation unit 100g (corresponding to “the operation unit 12”), a check inlet unit 100h (corresponding to “the check inlet unit 13”), and a cash dispensing unit 100i (corresponding to “the cash dispensing unit 16”). The check processing apparatus 1 also includes the transport path for transporting checks and banknotes, the check reading unit 14 for reading the check information, the stacker 15 for storing checks, a stacker for storing banknotes, and the like inside the own apparatus.

Next, contents of the check information read from a check by the check reading unit 14 are described below with reference to FIGS. 5A and 5B. FIGS. 5A and 5B are diagrams representing an example of the check information. More specifically, FIG. 5A represents information to be read from a face of a check, and FIG. 5B represents information to be read from a back of the check.

As shown in FIG. 5A, the check reading unit 14 reads the check information such as an issue date of the check (1), a payment recipient (2), a check amount (3), a signature of a drawer (4), a check number (5), a bank number (6), and an account number of the drawer (7) from the face of the check. Furthermore, as shown in FIG. 5B, the check reading unit 14 reads a signature of a payee of the check (8) (i.e., the user of the check processing apparatus 1).

In order to prevent counterfeiting or read error, the check amount (3) is written in numbers and letters on the check. The check amount written in numbers is called CAR (Courtesy Amount Recognition), and the check amount written in letters is called LAR (Legal Amount Recognition). The check reading unit 14 reads these two types of amount information from the check.

Furthermore, the issue date (1), the payment recipient (2), and the check amount (3) may be written by hand or printed by machines. The check reading unit 14 reads the contents of the issue date (1), the payment recipient (2), the check amount (3), the signature of the drawer (4), and the signature of the payee (8) by character recognition means such as OCR (Optical Character Recognition).

The check number (5) is an issuance number for identifying each check owned by the drawer. The bank number (6) is financial institution information for identifying a financial institution that has issued the check. The check number (5), the bank number (6), and the account number of the drawer (7) are magnetic ink characters printed with magnetic ink, and the check reading unit 14 reads these contents by character recognition means such as MICR (Magnetic ink Character Recognition).

In the following descriptions, the account number of the drawer (7) is explained as an example of drawer information for identifying a drawer. However, the bank number (6) is also used to identify a drawer, and the signature of the drawer (4) may be used as the drawer information. The check reading unit 14 also reads image data of both sides (face and back) of the whole check, a size of the check, and the like as the check information in addition to the information written on the check.

Referring back to FIG. 3, the control unit 19 is explained. The authenticating unit 19a is a processing unit that authenticates a user. More specifically, the authenticating unit 19a acquires, from the user registration DB 30a of the management apparatus 3, user registration information associated with the user ID received from the ID-card receiving unit 11. When a password received from the operation unit 12 matches a password contained in the user registration information, the authenticating unit 19a authenticates the user.

Furthermore, when the user is authenticated, the authenticating unit 19a instructs the check inlet unit 13 to open the shutter. On the other hand, when the user is not authenticated, the authenticating unit 19a returns the ID card and stops the process.

The authenticating unit 19a is also able to perform identification by using biometric information. For example, the authenticating unit 19a may acquire fingerprint information of a user by using the fingerprint read sensor 100f, and identify the user when the acquired fingerprint information matches fingerprint information contained in the user registration information.

Furthermore, the authenticating unit 19a may perform identification using the biometric information when a usage situation is different from a normal situation. For example, the authenticating unit 19a may perform the biometric identification when a user who usually performs a paycheck-cashing process on a specific day of every month comes to perform the process on a different day, or a user attempts to cash a check for a larger check amount than usual.

Consequently, even when a third person who has stolen the ID card from the user attempts to fraudulently perform the cashing process, the third person can be identified easily by recording his/her biometric information. The authenticating unit 19a identifies a usage situation for the user by referring to the “high usage day” or the “average cashed amount” contained in the user registration information.

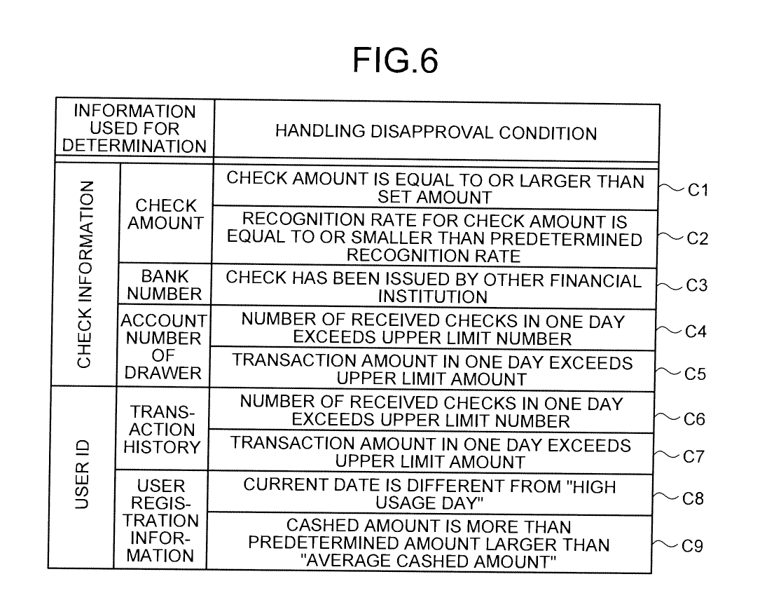

The handling determining unit 19b is a processing unit that determines approval and disapproval of handling of a check based on a matching result between either the check information read by the check reading unit 14 or information associated with the user authenticated by the authenticating unit 19a, and the handling disapproval condition 20a. Contents of the handling disapproval condition 20a and an example of operations by the handling determining unit 19b are described below with reference to FIG. 6. FIG. 6 is a diagram representing an example of the handling disapproval condition.

As shown in the figure, the handling determining unit 19b determines approval and disapproval of handling of a check by using information such as “the check amount”, “the bank number”, and “the account number of the drawer” contained in the check information (see C1 to C5 of the figure). Furthermore, the handling determining unit 19b determines approval and disapproval of the handling of the check by using the transaction history or the user registration information, as the information associated with the user authenticated by the authenticating unit 19a (see C6 to C9 of the figure).

Firstly, with reference to C1 to C5 of the figure, a case is described in which approval and disapproval of the handling of the check is determined by using the check information. For example, when the amount written on the check is equal to or larger than a set check amount (e.g., $5,000), the handling determining unit 19b determines that the handling of the check is disapproved (see C1 of the figure). In other words, because a risk borne by the financial institution is increased as the check amount is increased, the risk borne by the financial institution can be reduced by disapproving the handling of a check for more than the set amount.

Furthermore, when a recognition rate for the check amount read from the check by the check reading unit 14 is equal to or smaller than a predetermined recognition rate, the handling determining unit 19b determines that the handling of the check is disapproved (see C2 of the figure). In other words, because there is a risk for error recognition and the like when the recognition rate for the check amount is low, a risk borne by the financial institution can be reduced by disapproving the handling of a check that satisfies this condition.

Moreover, when a financial institution identified by the bank number read from the check by the check reading unit 14 is different from the own financial institution, i.e., when the received check has been issued by other financial institutions, the handling determining unit 19b determines that the handling of the check is disapproved (see C3 of the figure). In other words, because credibility of the check issued by the other financial institutions is lower than that of the check issued by the own financial institution, a risk borne by the financial institution can be reduced by disapproving the handling of a check issued by the other financial institutions.

It has been explained that the handling of a check issued by a financial institution other than the own financial institution is disapproved; however, it is not limited thereto. For example, it is possible to disapprove the handling of a check issued by a financial institution other than the own financial institution and a specific financial institution affiliated to the own financial institution.

Furthermore, the handling determining unit 19b determines approval and disapproval of the handling of the check based on the account number of the drawer. More specifically, the handling determining unit 19b acquires, from the account DB 30c of the management apparatus 3, an account history corresponding to the account number of the drawer read from the check by the check reading unit 14. Then, when the number of received checks in one day for the acquired account exceeds a predetermined upper limit number (e.g., 100 checks), the handling determining unit 19b determines that the handling of the check is disapproved (see C4 of the figure).

Moreover, when a transaction amount in one day for the acquired account exceeds an upper limit amount (e.g., 500,000 dollars), the handling determining unit 19b determines that the handling of the check is disapproved (see C5 of the figure).

In other words, when transaction frequency or a transaction amount for the account of the drawer is abnormally increased, it may be likely that the drawer attempts to commit a fraud. Therefore, by disapproving handling of the check when the transaction frequency or the transaction amount for the account corresponding to the account number read by the check reading unit 14 is equal to or larger than a predetermined threshold within a predetermined period, a risk borne by the financial institution can be reduced.

The handling determining unit 19b may determine that the handling of the check is disapproved when an account balance of the drawer is equal to or smaller than a predetermine amount (e.g., the check amount read by the check reading unit 14). Consequently, it is possible to avoid a risk for dishonor.

Next, with reference to C6 to C9 of the figure, a case is described in which approval and disapproval of the handling of the check is determined by using the information associated with the user. The handling determining unit 19b acquires, from the transaction history DB 30b of the management apparatus 3, a transaction history associated with the user ID read by the ID-card receiving unit 11. Then, when the number of received checks in one day according to the acquired transaction history exceeds a predetermined upper limit number (e.g., 100 checks), the handling determining unit 19b determines that the handling of the check is disapproved (see C6 of the figure).

Furthermore, when a transaction amount in one day exceeds an upper limit amount (e.g., 100 thousand dollars) according to the acquired transaction history, the handling determining unit 19b determines that the handling of the check is disapproved (see C7 of the figure).

In other words, when transaction frequency or a transaction amount for an identical user is abnormally increased, it may be likely that the user attempts to commit a fraud. Therefore, the handling of the check is determined to be disapproved when the transaction frequency or the transaction amount for transactions performed by each user by using the check processing apparatus 1 within a predetermined period is equal to or larger than a predetermined threshold. As a result, a risk borne by the financial institution can be reduced.

The transaction history is created and transmitted to the management apparatus 3 by the check processing apparatus 1. More specifically, after dispensing money in a cashed amount, the cashing processing unit 19c creates the transaction history associated with a user ID of the user authenticated by the authenticating unit 19a. The transaction history includes cashing information, which contains the cashed amount, a transaction date, and the account number of the drawer. The cashing processing unit 19c transmits the transaction history to the management apparatus 3. The management apparatus 3 updates a transaction history for each user and a transaction history for each drawer, which are stored in the transaction history DB 30b, based on the transaction history received from the check processing apparatus 1.

Furthermore, the handling determining unit 19b acquires, from the user registration DB 30a of the management apparatus 3, the registration information associated with the user ID read by the ID-card receiving unit 11. Then, the handling determining unit 19b compares the “high usage day” contained in the acquired user registration information with a current date. When the current date is different from the “high usage day”, the handling determining unit 19b determines that the handling of the check is disapproved (see C8 of the figure).

Moreover, the handling determining unit 19b compares the “average cashed amount” contained in the user registration information with the check amount read by the check reading unit 14. When the check amount is more than predetermined amount larger than the “average cashed amount”, the handling determining unit 19b determines that the handling of the check is disapproved (see C9 of the figure).

In other words, when the usage situation for the user is different from the normal situation, it may be likely that a third person who has stolen the ID card from the user attempts to fraudulently perform the cashing process. Therefore, by determining approval and disapproval of the handling of the check based on the transaction history for the user, such as the “high usage day” and the “average cashed amount”, a risk borne by the financial institution can be reduced.

The transaction history DB 30b may store therein a transaction history for a case in which the handling of the check is determined to be disapproved (hereinafter, referred to as a “handling disapproval history”) for each user. In this case, the check processing apparatus 1 may not perform a transaction for a user when the number of times that the handling is determined to be disapproved for the user exceeds a predetermined number of times.

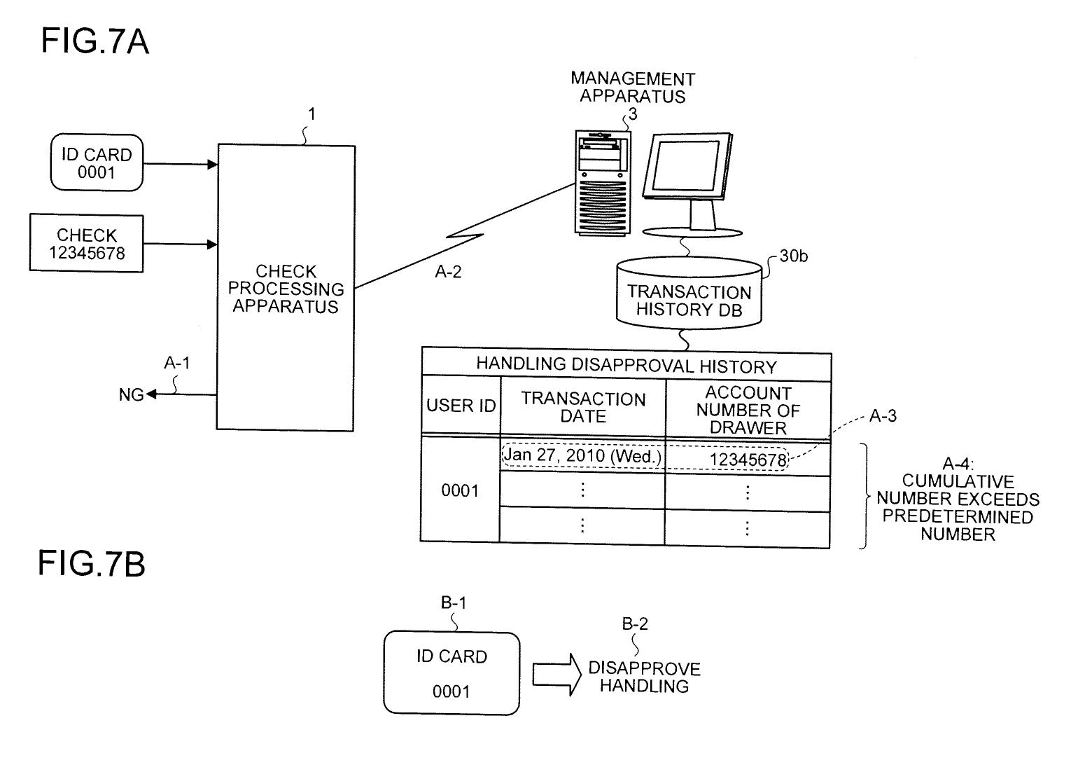

This is described below with reference to FIGS. 7A and 7B. FIGS. 7A and 7B are diagrams representing an example of determination by using the handling disapproval history. More specifically, FIG. 7A illustrates a situation in which the handling disapproval histories are accumulated; and FIG. 7B illustrates a determination operation by the handling determining unit 19b.

For example, as shown in FIG. 7A, it is assumed that the handling determining unit 19b determines that the handling of the check received from a user with a user ID “0001” is disapproved (see A-1 of FIG. 7A). In this case, the abnormality-handling processing unit 19d performs an abnormality handling process to be described later (e.g., a rejection process). The abnormality-handling processing unit 19d creates a transaction disapproval history by associating information, such as an account number “12345678” of a drawer of the check or a transaction date, with the user ID “0001”, and transmits the transaction disapproval history to the management apparatus 3 (see A-2 of FIG. 7A).

The management apparatus 3 stores the received handling disapproval history in the transaction history DB 30b (see A-3 of FIG. 7A). It is assumed here that the cumulative number of items of the handling disapproval history for the user with the user ID “0001” exceeds a predetermined number of items (e.g., 50 items) as a result of storing the new handling disapproval history (see A-4 of FIG. 7A).

In this case, when re-receiving a check from the user with the user ID “0001” (see B-1 of FIG. 7B), the handling determining unit 19b determines that the handling of the check is disapproved regardless of contents of the check (see B-2 of FIG. 7B).

In this manner, in the check processing apparatus 1, when performing the abnormality handling process, the abnormality-handling processing unit 19d stores, as an abnormality-handling process history (the handling disapproval history), the user information (the user ID) corresponding to a user authenticated by the authenticating unit 19a in a predetermined memory area (the transaction history DB 30b). Then, the handling determining unit 19b acquires the abnormality-handling process history from the predetermined memory area. Also, when more than predetermined number of pieces of the user information corresponding to the user are stored in the abnormality-handling process history, the handling determining unit 19b determines that the handling of the check is disapproved.

In other words, a check is not handled for a user for whom handling of checks has been determined to be disapproved a large number of times in the past. Consequently, the security of the transaction can further be improved and a risk borne by the financial institution can be reduced.

It has been explained that the determination is performed based on whether more than predetermined number of user IDs identical to the user ID read by the ID-card receiving unit 11 are stored in the handling disapproval history; however, it is not limited thereto. For example, the handling determining unit 19b may determine that the handling of the check is disapproved when more than predetermined number of combinations identical to the user ID and the account number of the drawer are stored in the handling disapproval history.

Furthermore, the handling determining unit 19b is able to determine whether to apply the above-mentioned handling disapproval condition by taking the disallowed list or the allowed list contained in the list DB 30d into consideration. An example of determination by using the disallowed list or the allowed list is described below with reference to FIGS. 8A and 8B. FIGS. 8A and 8B are diagrams representing an example of determination by using the disallowed list or the allowed list. More specifically, FIG. 8A illustrates contents of the disallowed list and the allowed list; and FIG. 8B illustrates an example of determination by the handling determining unit 19b.

As shown in FIG. 8A, the list DB 30d contains a disallowed list DB 300 and an allowed list DB 301. The disallowed list DB 300 is a database for storing the disallowed list as a list of users and drawers for whom handling of a check is highly risky. For example, the disallowed list contains a user ID of a user who has attempted to use a counterfeit check in the past.

The allowed list DB 301 is a database for storing the allowed list as a list of users and drawers to whom preferential treatment may be given in handling a check. For example, the allowed list contains information about a user who owns an account, a drawer and a user whose account balances are high, or a drawer and a user who have not caused troubles for several years.

As shown in FIG. 8B, when the account number of the drawer read by the check reading unit 14 or the user ID of the user authenticated by the authenticating unit 19a corresponds to the disallowed list, the handling determining unit 19b determines that the handling of the check is disapproved without applying the handling disapproval condition.

Furthermore, when the account number of the drawer and the user ID of the user do not correspond to the disallowed list, and the account number of the drawer and the user ID of the user correspond to the allowed list, the handling determining unit 19b determines that the handling of the check is approved without any conditions.

On the other hand, when the account number of the drawer and the user ID of the user do not correspond to both the disallowed list and the allowed list, the handling determining unit 19b performs a handling approval/disapproval determination process by applying the above-mentioned handling disapproval condition.

In this manner, the handling of the check is determined to be disapproved when the account of the drawer read by the check reading unit 14 or the user ID of the user authenticated by the authenticating unit 19a is contained in the disallowed list, so that a fraudulent activity such as counterfeiting can be prevented and a risk borne by the financial institution can further be reduced.

Furthermore, when the account of the drawer read by the check reading unit 14 or the user ID of the user authenticated by the authenticating unit 19a is contained in the allowed list, the handling of the check is determined to be approved without applying the handling disapproval condition. Therefore, a check can be handled without any conditions for users and drawers with good credit, such as users who own accounts.

It has been explained that both the disallowed list and the allowed list are considered; however, it is not limited thereto. Only one of the disallowed list and the allowed list may be considered. For example, when only the disallowed list is considered, the handling determining unit 19b determines that the handling is disapproved when the account of the drawer or the user ID corresponds to the disallowed list, and performs the handling approval/disapproval determination process when the account of the drawer or the user ID does not correspond to the disallowed list.

Furthermore, when only the allowed list is considered, the handling determining unit 19b determines that the handling is approved without any conditions when the account of the drawer or the user ID corresponds to the allowed list, and performs the handling approval/disapproval determination process when the account of the drawer or the user ID does not correspond to the allowed list.

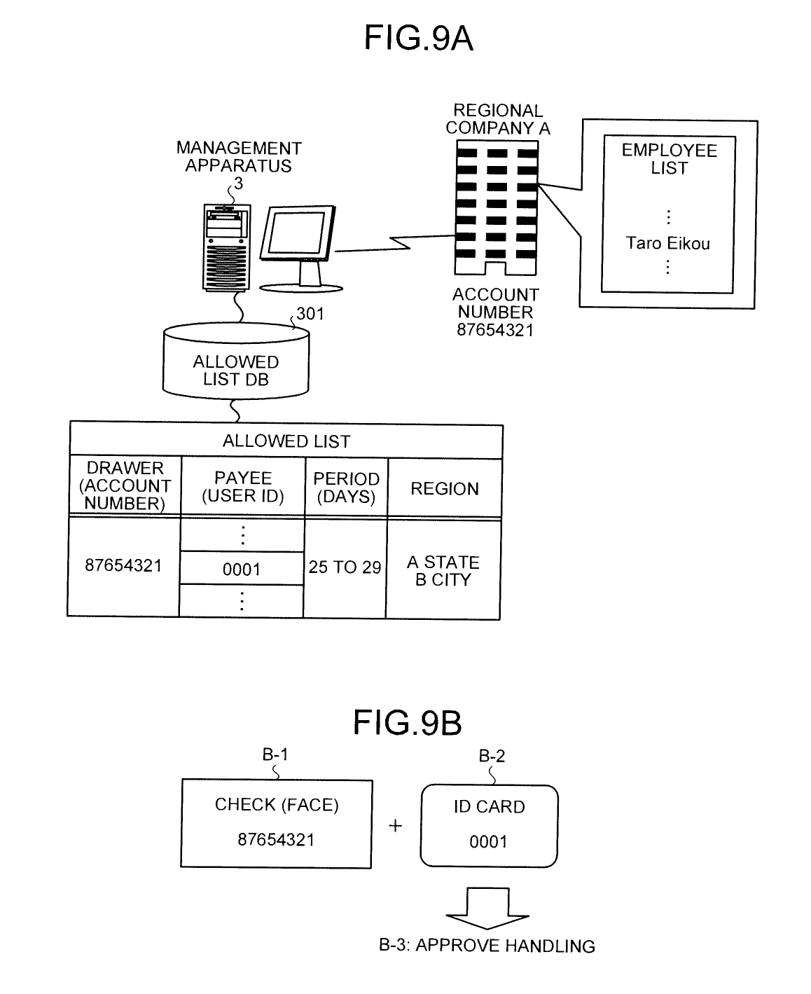

It is desirable that the disallowed list is commonly used in the whole country. However, the allowed list may be customized for each region. For example, the allowed list may be created in cooperation with a regional company. This is described below with reference to FIGS. 9A and 9B. FIGS. 9A and 9B are diagrams representing an example of determination by using information provided by a regional company. More specifically, FIG. 9A illustrates an allowed list created based on an employee list provided by the regional company A; and FIG. 9B illustrates an example of determination by the handling determining unit 19b.

As shown in FIG. 9A, when receiving the employee list from the regional company A, the management apparatus 3 converts names contained in the acquired employee list into respective user IDs, and stores the converted user IDs in the allowed list DB 301, in association with an account number of the regional company A, a predetermined period before and after a payday, and a region to which the regional company A and banks belong.

For example, as shown in FIG. 9A, a user ID “0001” corresponding to a name “Taro Eikou” contained in the employee list is stored in association with an account number “87654321” of the regional company A, a period from “25 to 29” of each month, and a region “A state B city”.

On the other hand, when a combination of the account number of the drawer read by the check reading unit 14 (see B-1 of FIG. 9B) and the user ID of the user authenticated by the authenticating unit 19a (see B-2 of FIG. 9B) is contained in the allowed list, the handling determining unit 19b determines that the handling of the check is approved without applying the handling disapproval condition (see B-3 of FIG. 9B).

In other words, it is normal for “Taro Eikou” who is an employee of the regional company A to perform a process of cashing a paycheck issued by the regional company A, and this is considered as a highly secure transaction. In this manner, when the combination of the account number of the drawer and the user ID corresponds to the allowed list, the handling of the check is approved without applying the handling disapproval condition. Therefore, highly secure transactions can be dealt with actively.

It has been explained that the handling of the check is determined to be approved when the combination of the account number of the drawer and the user ID is contained in the allowed list; however, it is not limited thereto. For example, the handling determining unit 19b may determine that the handling of the check is approved when a combination of the account number of the drawer, the user ID, and a current date is contained in the allowed list. Furthermore, the handling determining unit 19b may determine that the handling of the check is approved when a combination of the account number of the drawer, the user ID, and a region to which the own apparatus belongs is contained in the allowed list.

In other words, it is presumed that an employee of the regional company A normally cashes a paycheck issued by the regional company A, within a predetermined period from a payday and in a region to which the regional company A belongs. Therefore, if the handling of the check is approved without applying the handling disapproval condition when at least the account number of the drawer and the user ID are contained in the allowed list, the security of a transaction can be ensured infallibly.

The check processing apparatus 1 may determine whether the drawer has the ability to pay or not based on the number of user IDs associated with the account number of the drawer in the allowed list shown in FIG. 9A and the account balance of the drawer. In this case, if the check processing apparatus 1 does not handle the check for the drawer for whom it is determined that he/she does not have the ability to pay, a risk due to dishonor can further be reduced.

It has been explained that the information such as “user ID”, “period”, and “region” are acquired based on the drawer (the regional company A) and used as the allowed list. However, the information acquired based on the drawer is not limited to the above-mentioned information. For example, when issuing checks to employees, the regional company A notifies the management apparatus 3 of check numbers and check amounts of the issued checks. The management apparatus 3 registers these check numbers and the check amounts as the allowed list together with the account number of the drawer.

In this case, the check processing apparatus 1 may determine that the handling of the check is approved when a combination of the account number of the drawer, a check number, and a check amount read from the check is contained in the allowed list. The drawer may notify the management apparatus 3 of only a check number of an issued check. In this case, when a combination of an account number of the drawer and a check number read from the check is contained in the allowed list, the check processing apparatus 1 determines that the handling of the check is approved.

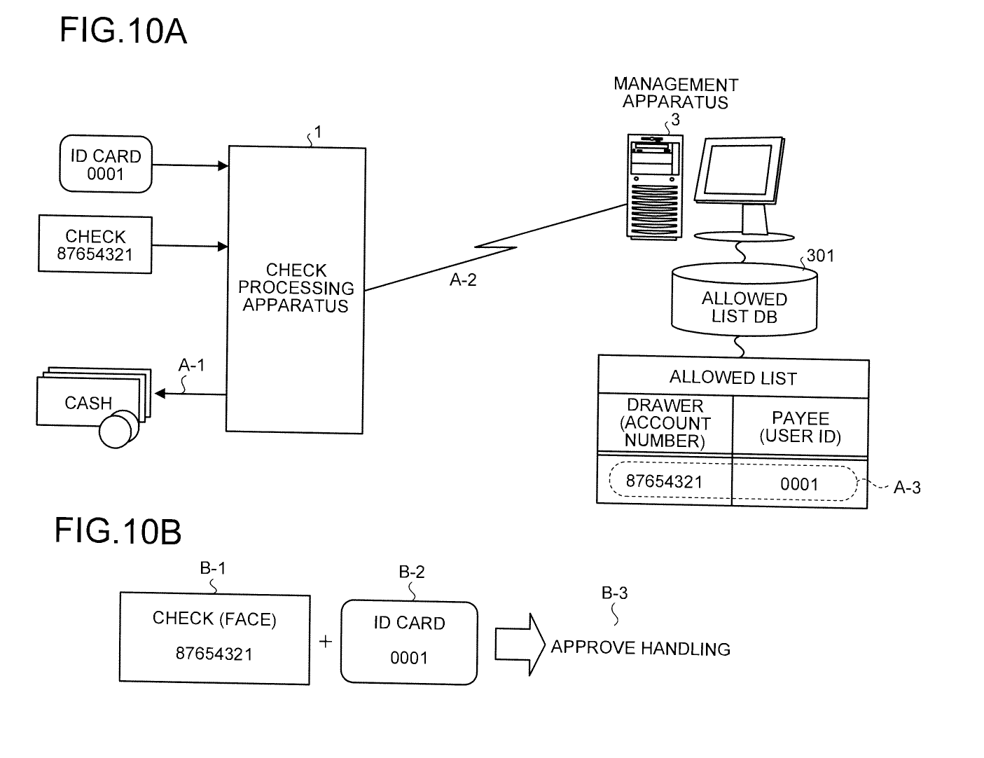

Moreover, the check processing apparatus 1 may determine that the handling of the check is approved without applying the handling disapproval condition when a transaction similar to a transaction that has been determined to be approved in the past is to be performed. This is described below with reference to FIGS. 10A and 10B. FIGS. 10A and 10B are diagrams representing an example of determination by using a result of learning a combination of a user and a drawer. More specifically, FIG. 10A illustrates a situation in which a combination of the user ID and the account number of the drawer is accumulated in the allowed list DB 301; and FIG. 10B illustrates a determination operation by the handling determining unit 19b.

For example, as shown in FIG. 10A, it is assumed that the handling determining unit 19b determines that the handling of the check received from the user with the user ID “0001” is approved. In this case, the cashing processing unit 19c performs a cashing process to be described later (see A-1 of FIG. 10A), and transmits a combination of the account number “87654321” of the drawer of the check and the user ID “0001” to the management apparatus 3 (see A-2 of FIG. 10A), so that the combination is added to the allowed list (see A-3 of FIG. 10A).

Then, when the combination of the account number of the drawer read by the check reading unit 14 (see B-1 of FIG. 10B) and the user ID of the user authenticated by the authenticating unit 19a (see B-2 of FIG. 10B) is contained in the allowed list, the handling determining unit 19b determines that the handling of the check is approved without applying the handling disapproval condition (see B-3 of FIG. 10B).

In this manner, in the check processing apparatus 1, when the cashing processing unit 19c dispenses money in the cashed amount, a combination of the account number of the drawer and the user ID is added to the allowed list. Furthermore, in the check processing apparatus 1, when a combination of the account number of the drawer read by the check reading unit 14 and the user ID of the user authenticated by the authenticating unit 19a is contained in the allowed list, the handling determining unit 19b determines that the handling of the check is approved without performing matching with the handling disapproval condition. As a result, it is possible to ensure the security of a transaction and reduce time necessary for the cashing process.

Referring back to FIG. 3, explanation of the control unit 19 is continued. The cashing processing unit 19c is a processing unit that dispenses, from the cash dispensing unit 16, money in a cashed amount corresponding to the check amount read by the check reading unit 14 when the handling determining unit 19b determines that the handling of the check is approved.

The cashing processing unit 19c displays the check amount read by the check reading unit 14 on the display unit 17 before dispensing money in the cashed amount, and dispenses money in the cashed amount after receiving confirmation from the user. Furthermore, when dispensing money in the cashed amount, the cashing processing unit 19c issues a payment slip with a written transaction result from the receipt issuing unit 100d.

A user is allowed to arbitrarily set denominations of banknotes to be dispensed from the cash dispensing unit 16. For example, the user is allowed to select desired denominations and desired numbers (or amount) by using the operation unit 12 such that all the cashed amount is dispensed with 20-dollar banknotes or some of the cashed amount is dispensed with 1-dollar banknotes.

The abnormality-handling processing unit 19d is a processing unit that executes a predetermined abnormality handling process when the handling determining unit 19b determines that the handling of the check is disapproved. More specifically, the abnormality-handling processing unit 19d performs a teller service request process as the abnormality-handling process. The teller service request process performed by the abnormality-handling processing unit 19d is described below with reference to FIG. 2 described above.

As shown in FIG. 2, in the check processing apparatus 1, when the handling determining unit 19b determines that the handling of the check is disapproved, the abnormality-handling processing unit 19d creates teller-service request information and transmits it to the management apparatus 3. When receiving the teller-service request information from the check processing apparatus 1, the management apparatus 3 stores the received teller-service request information in the teller service request DB 30e.

The teller-service request information is information in which the user ID of the user authenticated by the authenticating unit 19a, confirmation items corresponding to a result of the determination by the handling determining unit 19b, and a check image read by the check reading unit 14 are associated with a request number.

In the confirmation items corresponding to the result of the determination by the handling determining unit 19b, a content such as “confirm an account of the drawer” may be contained when the handling of the check is disapproved because the check has satisfied the handling disapproval condition C5 in FIG. 6.

Subsequently, the abnormality-handling processing unit 19d issues, from the receipt issuing unit 100d, a teller service request ticket including the request number contained in the teller-service request information. Furthermore, the abnormality-handling processing unit 19d displays a notice that the check needs to be processed at a teller window on the display unit 17. Consequently, the user is instructed to go to the teller window along with the teller service request ticket issued from the receipt issuing unit 100d.

On the other hand, a bank teller who receives the teller service request ticket from the user operates the teller terminal 2 to input the request number written on the teller service request ticket, and retrieves a corresponding teller-service request information from the teller service request DB 30e managed by the management apparatus 3. Then, the bank teller deals with the user by confirming the contents of the teller-service request information displayed on the teller terminal 2.

In this manner, when the handling determining unit 19b determines that the handling of the check is disapproved, the abnormality-handling processing unit 19d transmits the teller-service request information to the management apparatus 3 and notifies that the check needs to be cashed at the teller window. Therefore, because the bank teller needs to confirm only the confirmation items contained in the teller-service request information, he/she can deal with the user efficiently.

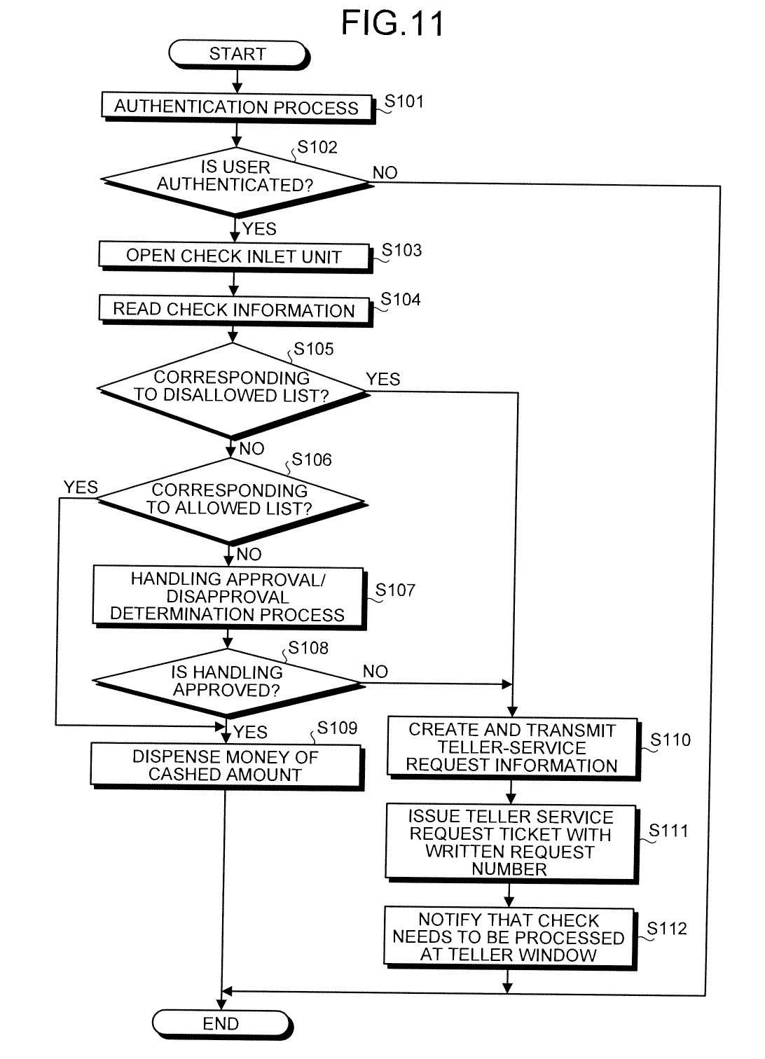

Next, detailed operations performed by the check processing apparatus 1 of the first embodiment are described below with reference to FIG. 11. FIG. 11 is a flowchart of a process procedure performed by the check processing apparatus 1 according to the first embodiment.

As shown in the figure, when the ID card is inserted into the ID-card receiving unit 11, the authenticating unit 19a of the check processing apparatus 1 performs an authentication process (Step S101), and determines whether the user is authenticated or not (Step S102). At this process, when the user is authenticated (YES at Step S102), the authenticating unit 19a drives the shutter of the check inlet unit 13 in the open direction to open the check inlet unit 13 (Step S103).

Subsequently, the check reading unit 14 reads the check information from the check transported by a transport unit (Step S104), and sends the read check information to the handling determining unit 19b.

Then, the handling determining unit 19b determines whether the drawer of the check or the user is included in the disallowed list or not (Step S105). When the drawer of the check or the user is not included in the disallowed list (NO at Step S105), the handling determining unit 19b determines whether the drawer of the check or the user is included in the allowed list (Step S106). When the drawer of the check or the user does not correspond to the allowed list (NO at Step S106), the handling determining unit 19b performs the handling approval/disapproval determination process by applying the handling disapproval condition (Step S107).

In the check processing apparatus 1, when the handling determining unit 19b determines that the handling of the check is approved (YES at Step S108), the cashing processing unit 19c dispenses money in a cashed amount corresponding to the check amount read by the check reading unit 14 (Step S109). The cashing processing unit 19c also performs the same cashing process when the handling determining unit 19b determines that the drawer of the check or the user corresponds to the allowed list (YES at Step S106).

On the other hand, when the handling determining unit 19b determines that the drawer of the check or the user corresponds to the disallowed list (YES at Step S105), or determines that the handling of the check is disapproved (NO at Step S108), the abnormality-handling processing unit 19d creates the teller-service request information and transmits it to the management apparatus 3 (Step S110). The abnormality-handling processing unit 19d issues the teller service request ticket with a written request number from the receipt issuing unit 100d (Step S111), and displays a notice that the check needs to be processed at a teller window on the display unit 17 (Step S112).

When the process at Step S109 or Step S112 is completed, or when the authenticating unit 19a does not authenticate the user at Step S102 (NO at Step S102), the check processing apparatus 1 ends the process.

As described above, according to the first embodiment, the check reading unit 14 reads the check information containing the check amount from the check; the handling determining unit 19b determines approval and disapproval of handling of the check based on a matching result between the check information read by the check reading unit 14 and the handling disapproval condition 20a; the cashing processing unit 19c dispenses money in a cashed amount corresponding to the check amount read by the check reading unit 14 when the handling determining unit 19b determines that the handling of the check is approved; and the abnormality-handling processing unit 19d performs a predetermined abnormality handling process when the handling determining unit 19b determines that the handling of the check is disapproved. Therefore, a risk borne by the financial institution can be reduced and a check can be directly cashed.

The settings of the handling disapproval condition 20a stored in the memory 20 can arbitrarily be changed. For example, it is possible to cause the management apparatus 3 or an upper-layer terminal (not shown) of the check processing apparatuses 1 installed in the bank to remotely change the settings of all the check processing apparatuses 1 via a network. It is also possible to individually download the handling disapproval condition created by the management apparatus 3 or the upper-layer terminal for each check processing apparatus 1. It is also possible to directly change the handling disapproval condition stored in the check processing apparatus 1 by using the operation unit 12.

In the first embodiment described above, the fingerprint information has been explained as an example of the biometric identification information of the user. However, regarding the biometric identification information read from the user, other biometric identification information such as vein patterns, iris patterns, or voiceprint patterns may be used for performing the biometric identification. In this case, the check processing apparatus 1 may be equipped with a biometric-identification-information acquiring unit suitable for the biometric identification information to be used.

### Second Embodiment

In the first embodiment described above, it has been explained that the check processing apparatus 1 is installed in the financial institution such as a bank. However, the check processing apparatus 1 may be installed in a non-financial institution such as a convenience store and a supermarket. When the check processing apparatus 1 is installed in a store as the non-financial institution, it is desirable to consider a risk borne by the store and handle a check based on a processing content corresponding to each transaction (see B-1 of FIG. 1B).

In a second embodiment, with a focus on the above-mentioned point, a case will be described in which a risk level related to handling of a check is determined based on the check information, and the check is handled based on a processing content corresponding to a result of the determination (corresponding to C-2 of FIG. 1C).

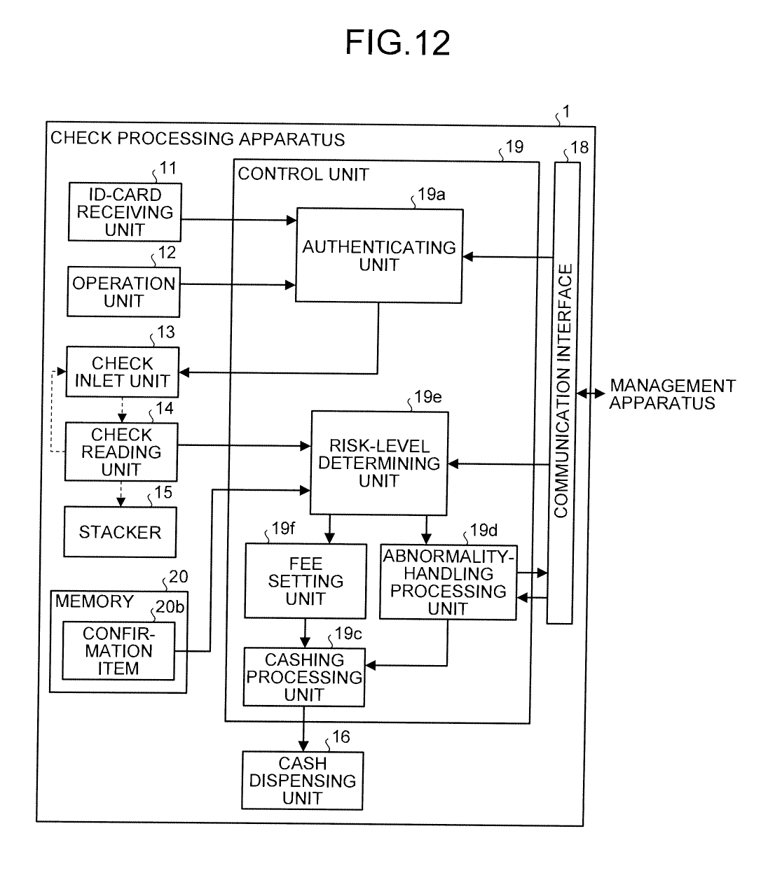

FIG. 12 is a block diagram of a configuration of the check processing apparatus 1 according to the second embodiment. As shown in the figure, the check processing apparatus 1 of the second embodiment includes a risk-level determining unit 19e instead of the handling determining unit 19b. Furthermore, the control unit 19 further includes a fee setting unit 19f. Moreover, the memory 20 stores therein a confirmation item 20b instead of the handling disapproval condition 20a.

The risk-level determining unit 19e is a processing unit that determines a risk level related to handling of a check based on a matching result between the check information read by the check reading unit 14 and the confirmation item 20b stored in the memory 20.

The fee setting unit 19f is a processing unit that sets a fee necessary for cashing a check depending on the risk level determined by the risk-level determining unit 19e. The fee setting unit 19f also performs a process of sending information about the set fee to the cashing processing unit 19c.

When receiving the information about the fee from the fee setting unit 19f, the cashing processing unit 19c dispenses, from the cash dispensing unit 16, money in the amount remaining after deducting the set fee from the check amount read by the check reading unit 14.

The abnormality-handling processing unit 19d is a processing unit that performs the abnormality handling process according to the risk level determined by the risk-level determining unit 19e. For example, the abnormality-handling processing unit 19d performs, as the abnormality handling process, a remote confirmation process for requesting an operator at the management center to perform confirmation, or a biometric identification process for performing biometric identification of the user. The fee setting unit 19f, the cashing processing unit 19c, and the abnormality-handling processing unit 19d are examples of a check processing unit that processes a check based on the risk level of a check processing determined by the risk-level determining unit 19e.

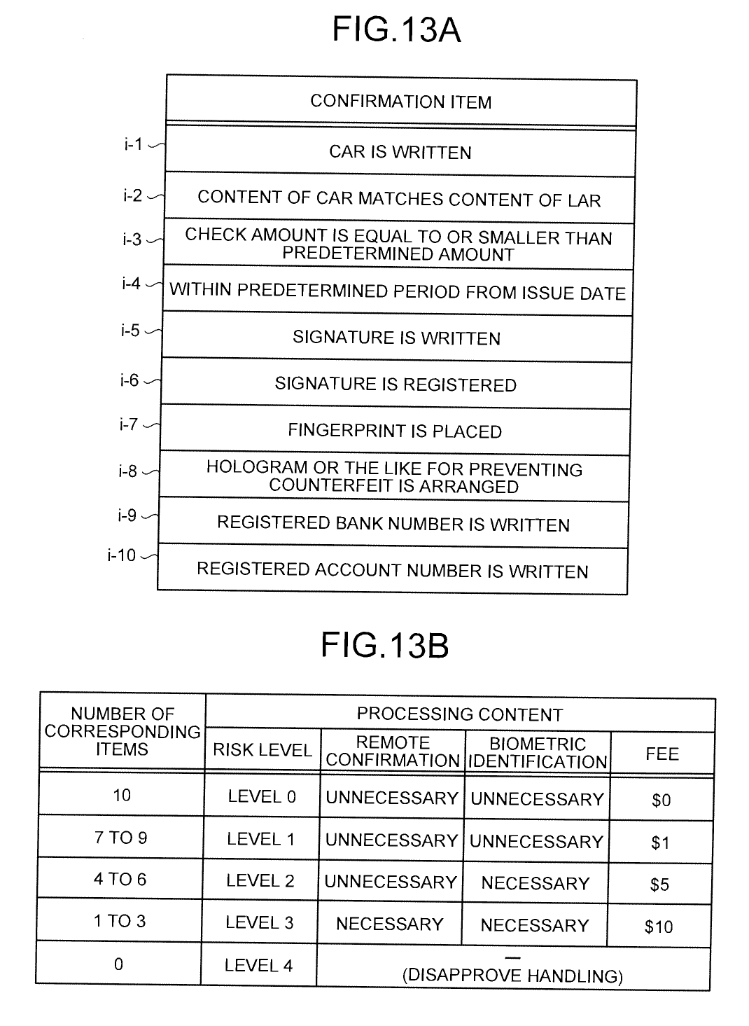

An example of operations by the risk-level determining unit 19e, the fee setting unit 19f, and the abnormality-handling processing unit 19d is described below with reference to FIGS. 13A and 13B. FIGS. 13A and 13B are diagrams representing an example of operations by the risk-level determining unit 19e, the fee setting unit 19f, and the abnormality-handling processing unit 19d. More specifically, FIG. 13A illustrates an example of the confirmation item 20b stored in the memory 20; and FIG. 13B illustrates processing contents, how to process the checks, corresponding to respective risk levels.

As shown in FIG. 13A, the risk-level determining unit 19e confirms whether the check information read by the check reading unit 14 matches each of items i-1 to i-10 in the confirmation item 20b. More specifically, the risk-level determining unit 19e confirms whether CAR is written on the check or not, i-1, and whether a content of CAR matches a content of LAR or not, i-2. This is because a check on which CAR is not written and a check whose CAR and LAR are not identical to each other are not valid as a check.

Furthermore, the risk-level determining unit 19e confirms whether a check amount is equal to or smaller than a predetermined amount or not, i-3. This is because when a check for a large amount is processed automatically without manual operations, a risk borne by the store is increased. Moreover, the risk-level determining unit 19e confirms whether a current date is within a predetermined period from an issue date of the check or not, i-4. This is because handling of a check existing for a long time from the issue date increases a risk borne by the store.

The risk-level determining unit 19e also confirms whether a signature of a drawer of the check or a signature of a user is written or not, i-5, whether a written signature is already registered or not, i-6, and whether fingerprint is placed or not, i-7. This is because when the signature is written on the check or the fingerprint is placed on the check, it is presumed that the security of the transaction is highly assured.

The risk-level determining unit 19e also checks whether a hologram or the like for preventing counterfeits is applied to the check or not, i-8. When the check is provided with a preventive measure against counterfeits, it is presumed that counterfeits are less likely to occur and the security of the transaction is highly assured.

The risk-level determining unit 19e also checks whether a bank number written on the check is registered or not, i-9, and whether an account number of the drawer written on the check is registered or not, i-10. In other words, if a highly-credible bank number and a highly-credible account number are registered in advance, it is possible to ensure that a transaction for a check on which the registered bank number or the registered account number is written is highly secure.

As shown in FIG. 13B, when completing confirmation of these items, the risk-level determining unit 19e determines the risk level depending on the number of corresponding items.

More specifically, when the number of corresponding items is “10”, i.e., when the check information corresponds to all the confirmation items, the risk-level determining unit 19e determines the risk level related to the handling of the check as “level 0”. This means that a risk related to the handling of the check is the lowest, i.e., the transaction is secure.

Furthermore, the risk-level determining unit 19e determines the risk level as “level 1” when the number of corresponding items is “7 to 9”, determines the risk level as “level 2” when the number of corresponding items is “4 to 6”, and determines the risk level as “level 3” when the number of corresponding items is “1 to 3”. Moreover, the risk-level determining unit 19e determines the risk level as “level 4” when the check information does not correspond to all the confirmation items. In this manner, the risk-level determining unit 19e sets a higher risk level as the number of corresponding items is decreased.

On the other hand, as shown in FIG. 13B, the fee setting unit 19f and the abnormality-handling processing unit 19d determine a processing content depending on the risk level determined by the risk-level determining unit 19e.

More specifically, the fee setting unit 19f sets a fee necessary for cashing the check at “$0” when the risk level is determined as “level 0”. Furthermore, the fee setting unit 19f sets the fee at “$1” when the risk level is determined as “level 1”, sets the fee at “$5” when the risk level is determined as “level 2”, and sets the fee at “$10” when the risk level is determines as “level 3”.

In this manner, because the fee necessary for cashing the check is set at a higher amount as the risk level related to the handling of the check is increased, it is possible to charge the fee to the user in accordance with the risk borne by the store.

Furthermore, when the risk level is determined as “level 0” or “level 1”, the abnormality-handling processing unit 19d determines that remote confirmation is “unnecessary” and biometric identification is “unnecessary”. Furthermore, the abnormality-handling processing unit 19d determines that the remote confirmation is “unnecessary” and the biometric identification is “necessary” when the risk level is determined as “level 2”, and determines that the remote confirmation is “necessary” and the biometric identification is “necessary” when the risk level is determined as “level 3”.

Moreover, when the risk level is determined as “level 4”, the abnormality-handling processing unit 19d determines that the handling of the check is disapproved, and performs a rejection process. The rejection process is a process of discontinuing the handling of the check. More specifically, the rejection process includes a process of returning the ID card inserted into the ID-card receiving unit 11 and returning the check input into the check inlet unit 13.

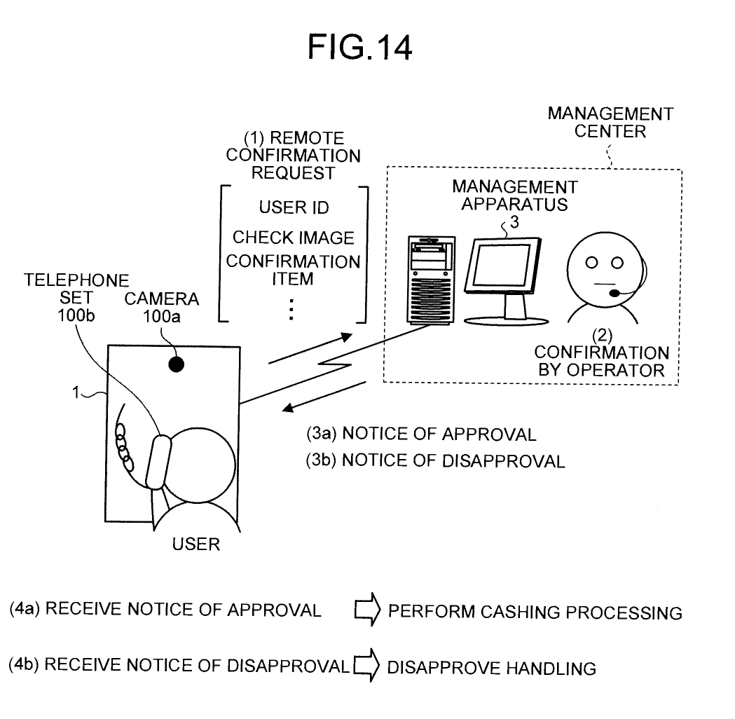

The remote confirmation process performed by the abnormality-handling processing unit 19d is described below with reference to FIG. 14. FIG. 14 is a diagram for explaining the remote confirmation process.

As shown in the figure, when starting the remote confirmation process, the abnormality-handling processing unit 19d creates a remote confirmation request and transmits it to the management apparatus 3 (see (1) of the figure). The remote confirmation request is information containing the user ID of the user authenticated by the authenticating unit 19a, confirmation items determined as not matching the check information by the risk-level determining unit 19e, a check image read by the check reading unit 14, and the like.

Subsequently, in the management center, when the management apparatus 3 receives the remote confirmation request, an operator performs confirmation process (see (2) of the figure). The operator asks the user about necessary information by verifying contents of the remote confirmation request displayed on a display of the management apparatus 3, and determines whether the handling of the check is secure or not based on answers from the user. The user of the check processing apparatus 1 talks to the operator by using the telephone set 100b. The operator confirms a face and the like of the user by using the camera 100a.

When determining that the handling of the check is secure, the operator operates the management apparatus 3 to transmit a notice of approval to the check processing apparatus 1 (see (3a) of the figure). The notice of approval is a notice containing information indicating approval of the check cashing. On the other hand, when determining that there is a risk for handling the check, the operator operates the management apparatus 3 to transmit a notice of disapproval to the check processing apparatus 1 (see (3b) of the figure).

In the check processing apparatus 1, when receiving the notice of approval from the management apparatus 3 (see (4a) of the figure), the cashing processing unit 19c dispenses, from the cash dispensing unit 16, money in the amount remaining after deducting the fee ($10) set by the fee setting unit 19f from the check amount read by the check reading unit 14. Furthermore, in the check processing apparatus 1, when receiving the notice of disapproval from the management apparatus 3 (see (4a) of the figure), the abnormality-handling processing unit 19d determines that the handling of the check is disapproved, and performs the rejection process.

In this manner, when the risk level determined by the risk-level determining unit 19e is higher than a predetermined level, a request for confirmation by an operator is transmitted to the management apparatus 3 connected via the network. Then, when the notice of approval is received from the management apparatus 3, money in the amount remaining after deducting the fee corresponding to the risk level from the check amount is dispensed. Therefore, even when the risk level related to the handling of the check is high, because a confirmation operation by the operator is interposed, the transaction can be performed with security.

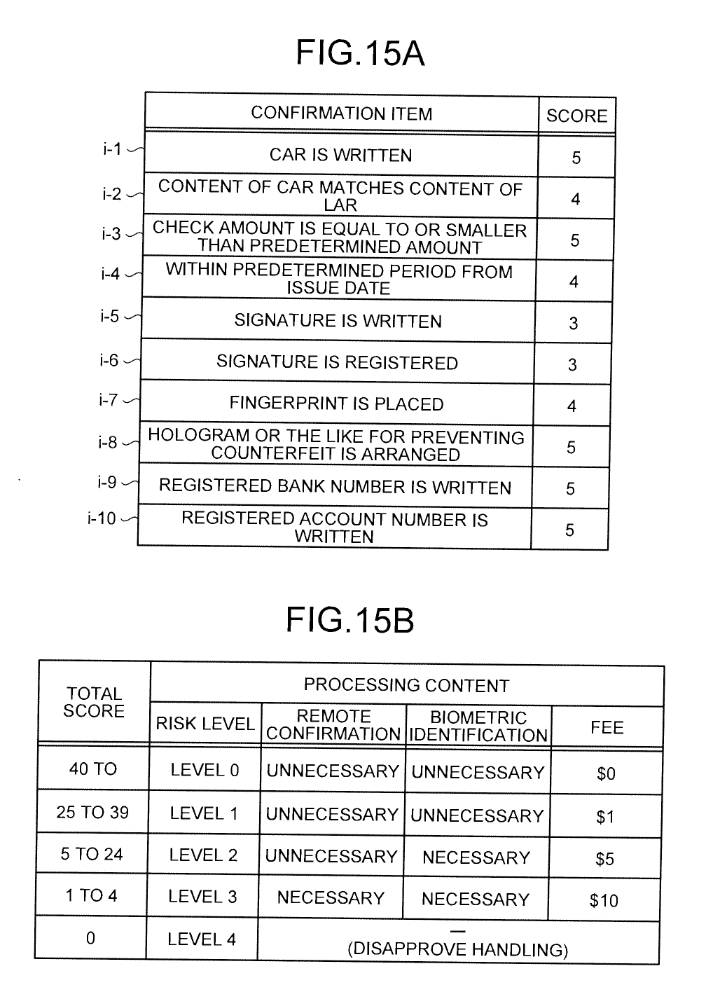

It has been explained with reference to FIGS. 13A and 13B that the risk level is determined depending on the number of corresponding items regardless of the contents of respective confirmation items; however, it is not limited thereto. For example, it is possible to classify the weight of each confirmation item depending on its content. This is described below with reference to FIGS. 15A and 15B. FIGS. 15A and 15B are diagrams representing an example of another operation by the risk-level determining unit 19e.

As shown in FIG. 15A, a score is assigned to each item of the confirmation item 20b depending on the content. The risk-level determining unit 19e calculates a total score of scores assigned to respective items corresponding to the check information, and determines the risk level based on the calculated total value.

More specifically, when the total score is equal to or larger than “40”, the risk-level determining unit 19e determines the risk level as “level 0”. Furthermore, the risk-level determining unit 19e determines the risk level as “level 1” when the total score is “25 to 39”, determines the risk level as “level 2” when the total score is “5 to 24”, and determines the risk level as “level 3” when the total score is “1 to 4”. Moreover, the risk-level determining unit 19e determines the risk level as “level 4” when the total score is “0”.

In this manner, among the scores assigned to respective items contained in the confirmation item 20b, a total score of the scores assigned to respective items corresponding to the check information is calculated, and the risk level is determined based on the calculated total score. Therefore, it is possible to determine the risk level by taking the contents of the confirmation items into consideration. The score for each item can arbitrarily be set by the store.

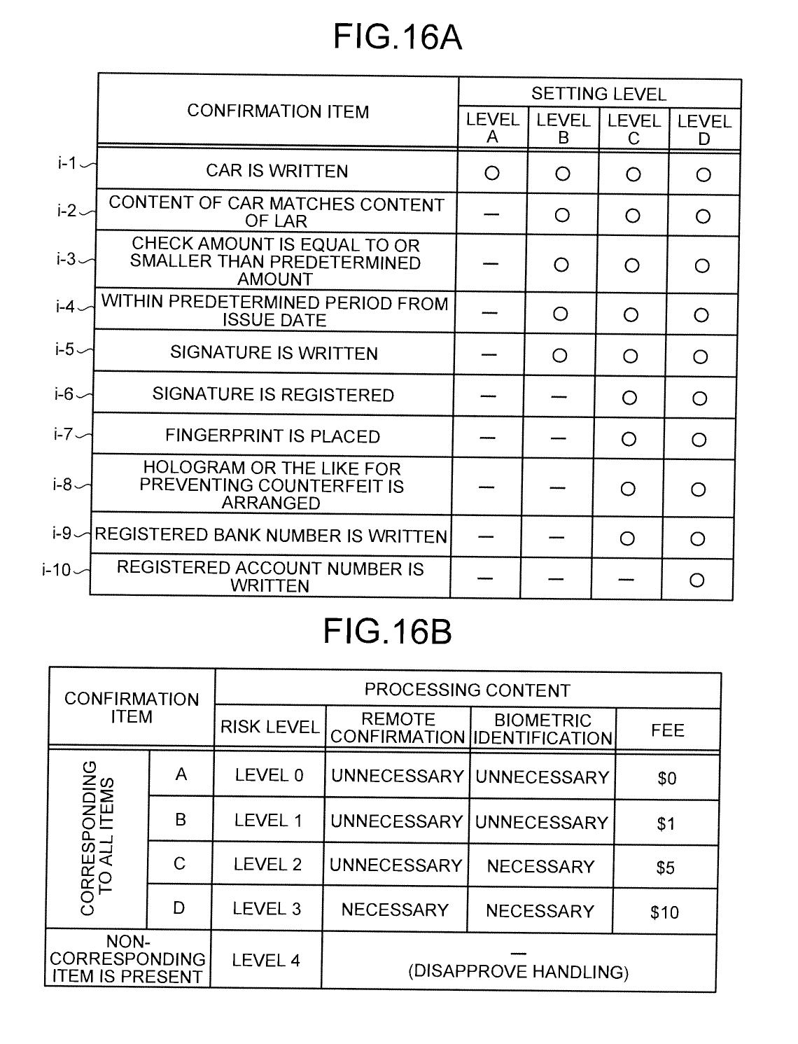

Furthermore, the confirmation items can be changed depending on a setting level set for each check processing apparatus 1. This is described below with reference to FIGS. 16A and 16B. FIGS. 16A and 16B are diagrams representing an example of another operation by the risk-level determining unit 19e.

As shown in FIG. 16A, the check processing apparatus 1 is able to set four levels of “level A” to “level D” as the setting level related to the security of the transaction (a security level). In this example, it is assumed that the security level of the setting level “level A” is the lowest, and the security level of the setting level “level D” is the highest.

More specifically, when the setting level is “level A”, the risk-level determining unit 19e confirms only the item i-1 among the items i-1 to i-10 contained in the confirmation item 20b. Furthermore, the risk-level determining unit 19e determines the items i-1 to i-5 when the setting level is “level B”, and checks the items i-1 to i-9 when the setting level is “level C”. Moreover, when the setting level is “level D”, the risk-level determining unit 19e confirms all the items i-1 to i-10.

Then, when the check information corresponds to all the confirmed items, the risk-level determining unit 19e determines a risk level associated with the setting level, as the risk level related to the handling of the check.

For example, when the setting level of the own apparatus is “level A”, and the check information corresponds to all the confirmation items associated with “level A”, the risk-level determining unit 19e determines that the risk level is “level 0”. Similarly, when the setting level of the own apparatus is “level B”, and the check information corresponds to all the confirmation items associated with “level B”, the risk-level determining unit 19e determines that the risk level is “level 1”. When the check information does not correspond to any one of the items, the risk-level determining unit 19e determines the risk level as “level 4”.

In this manner, the confirmation items are changed depending on the setting level set for the own apparatus, and when the check information read by the check reading unit 14 corresponds to all the confirmation items associated with the setting level, the risk level associated with the setting level is determined as the risk level related to the handling of the check. Therefore, the risk level determination can be performed depending on an environment where the check processing apparatus is installed. The settings level and confirmation items can be arbitrarily changed by the store.

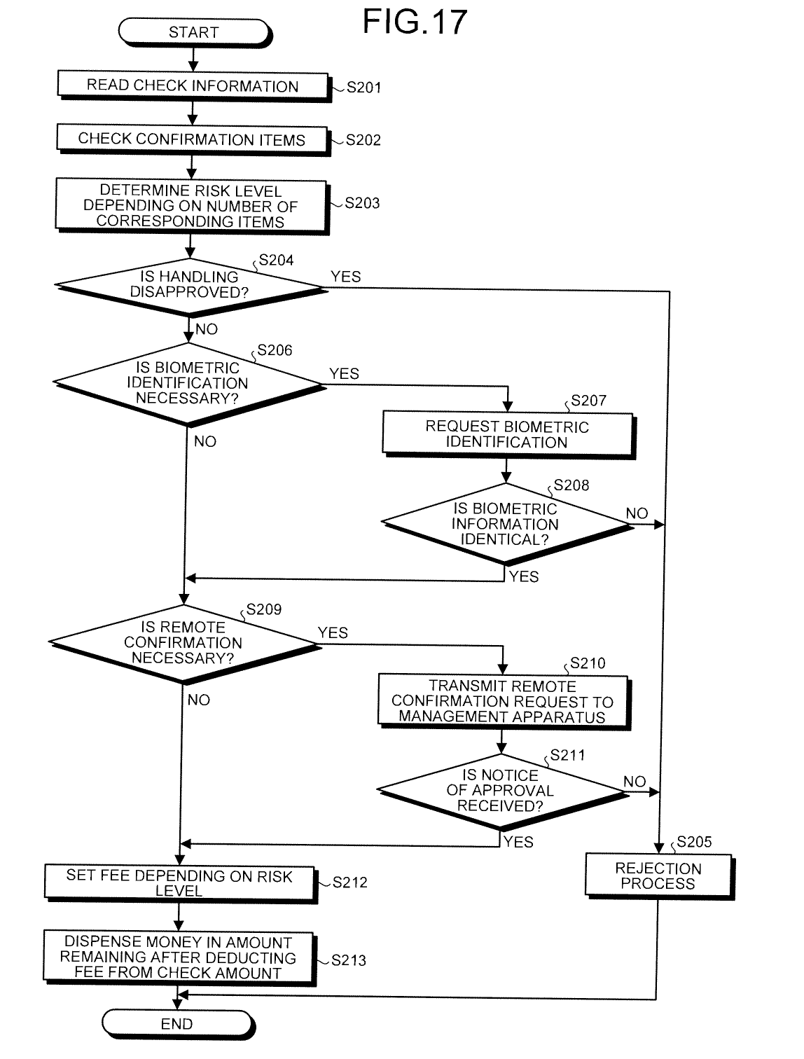

Next, detailed operations by the check processing apparatus 1 of the second embodiment are described below with reference to FIG. 17. FIG. 17 is a flowchart of a process procedure performed by the check processing apparatus 1 according to the second embodiment. In the figure, a process procedure for determining the risk level depending on the number of corresponding items by the risk-level determining unit 19e is illustrated.

As shown in the figure, in the check processing apparatus 1, the check reading unit 14 reads the check information from the check transported by the transport unit (Step S201), and sends the read check information to the risk-level determining unit 19e. Subsequently, the risk-level determining unit 19e confirms whether the check information corresponds to each item of the confirmation item 20b or not (Step S202), and determines the risk level depending on the number of corresponding items (Step S203).

Then, the abnormality-handling processing unit 19d determines whether the handling of the check is disapproved or not (Step S204). More specifically, the abnormality-handling processing unit 19d determines whether the risk level determined by the risk-level determining unit 19e is “level 4” or not. At this process, when the handling of the check is determined to be disapproved (YES at Step S204), the abnormality-handling processing unit 19d performs the rejection process (Step S205).

In this manner, when the risk level determined by the risk-level determining unit 19e is higher than a predetermined level, the handling of the check is discontinued. Therefore, a risk borne by the store can be reduced.

On the other hand, when the handling of the check is not disapproved, i.e., when the risk level is not “level 4” (NO at Step S204), the abnormality-handling processing unit 19d determines whether the biometric identification is necessary or not (Step S206). More specifically, the abnormality-handling processing unit 19d determines whether the risk level determined by the risk-level determining unit 19e is one of “level 2” and “level 3” or not.

At this process, when determining that the biometric identification is necessary (YES at Step S206), the abnormality-handling processing unit 19d requests the user to perform the biometric identification (Step S207). For example, the abnormality-handling processing unit 19d displays, on the display unit 17, a notice that fingerprint identification needs to be performed for the user. Accordingly, the user allows the fingerprint read sensor 100f to read his/her fingerprint information.

Subsequently, the abnormality-handling processing unit 19d determines whether the fingerprint information read by the fingerprint read sensor 100f matches the fingerprint information contained in the user registration information or not (Step S208). At this process, when the pieces of the fingerprint information does not match each other (NO at Step S208), the abnormality-handling processing unit 19d performs the rejection process (Step S205).

It is assumed here that it is determined at Step S208 whether the biometric information read from the user matches biometric information that is registered in advance. However, some financial institutions may not register users' biometric information when registering users.

Therefore, at Step S208, it is possible to determine whether biometric information is acquired from the user or not. In other words, when biometric information is not registered in advance, the user may be allowed to proceed a transaction after providing his/her biometric information. With this configuration, it is possible to trace the user by using the biometric information acquired at the transaction. As a result, the security of the transaction can be increased.

On the other hand, when determining that the biometric identification is not necessary at Step S206 (NO at Step S206), or when determining that the pieces of the biometric information has matched each other at Step S208 (YES at Step S208), the abnormality-handling processing unit 19d determines whether the remote confirmation is necessary or not (Step S209). More specifically, the abnormality-handling processing unit 19d determines whether the risk level is “level 3” or not.

At this process, when determining that the remote confirmation is necessary (YES at Step S209), the abnormality-handling processing unit 19d creates the remote confirmation request and transmits it to the management apparatus 3 (Step S210). Then, the abnormality-handling processing unit 19d determines whether a notice of approval is received from the management apparatus 3 or not (Step S211). When the notice of approval is not received, i.e., when a notice of disapproval is received (NO at Step S211), the abnormality-handling processing unit 19d performs the rejection process (Step S205).

On the other hand, when determining that the remote confirmation is not necessary at Step S209 (NO at Step S209), or when the notice of approval is received from the management apparatus 3 at Step S211 (YES at Step S211), the fee setting unit 19f sets a fee depending on the risk level (Step S212).

Then, the cashing processing unit 19c dispenses, from the cash dispensing unit 16, money in the amount remaining after deducting the fee set by the fee setting unit 19f from the check amount read by the check reading unit 14 (Step S213), and ends the process.

As described above, according to the second embodiment, the check reading unit 14 reads the check information including the check amount from the check; the fee setting unit 19f determines the risk level related to the handling of the check based on a matching result between the check information read by the check reading unit 14 and the predetermined confirmation item 20b; and the fee setting unit 19f, the abnormality-handling processing unit 19d, and the cashing processing unit 19c process the check based on a processing content corresponding to the risk level determined by the risk-level determining unit 19e. Therefore, it is possible to process the check based on a processing content corresponding to the risk borne by the store.

Furthermore, when the risk level determined by the risk-level determining unit 19e is higher than a predetermined level, a user is requested to provide his/her biometric information, and, when the biometric information acquired by the fingerprint read sensor 100f matches pre-registered biometric information of the user, money in the amount remaining after deducting the fee corresponding to the risk level from the check amount is dispensed as the cashed amount. Therefore, even when the risk level is determined as high, the security of the transaction can be ensured by the biometric identification.

It has been explained that the risk level is determined based on the check information; however, it is not limited thereto. For example, the risk-level determining unit 19e may determine the risk level based on a transaction history for the drawer (see C-2a of FIG. 1C), or perform the risk level determination by signature matching (see C-2b of FIG. 1C). These are described below.

Firstly, a case is described in which the risk level is determined based on the transaction history for the drawer, with reference to FIGS. 18A to 18C. FIGS. 18A to 18C are diagrams for explaining a case in which the risk level is determined based on the transaction history for the drawer. More specifically, FIG. 18A illustrates an example of the transaction history for the drawer; FIG. 18B illustrates an example of confirmation items; and FIG. 18C illustrates an example of determination by the risk-level determining unit 19e.

As shown in FIG. 18A, in the transaction history DB 30b, an issue date of the check, a total check amount of checks issued on the same day, and check numbers of the checks issued on the same day are stored as the transaction history for the drawer, in association with an account number of the drawer. In FIG. 18A, for convenience of explanation, a case is illustrated in which the total check amount of checks issued on the same day are stored. However, it is possible to separately store a check amount per check number.

The risk-level determining unit 19e acquires, from the transaction history DB 30b, a transaction history corresponding to the account number of the drawer read by the check reading unit 14, and determines the risk level of the check based on a comparison result between the acquired transaction history and the check information read by the check reading unit 14.

For example, as shown in FIG. 18B, the risk-level determining unit 19e determines whether the issue date contained in the check information matches an average issue day-of-week (see B-1 of FIG. 18B). More specifically, the risk-level determining unit 19e determines, as the “average issue day-of-week”, the most frequent day-of-week from among pieces of issue day-of-week contained in the transaction history. For example, in the example shown in FIG. 18A, the “average issue day-of-week” is “Wednesday”. Subsequently, the risk-level determining unit 19e determines whether a day-of-week identified by the issue date written on the check matches the “average issue day-of-week” or not.

The risk-level determining unit 19e may confirm whether the issue date contained in the check information matches an average issue date (see B-2 of FIG. 18B). In this case, the risk-level determining unit 19e determines, as the “average issue date”, the most frequent date from among pieces of the issue date contained in the transaction history, and confirms whether the issue date written on the check matches the “average issue date” or not.

In this manner, an average issue date or an average issue day-of-week for the check of the drawer is determined as a transaction pattern, and the risk level of the check is determined depending on a degree of consistency between the issue date and the average issue date or a degree of consistency between the issue day-of-week and the average issue day-of-week. Therefore, when the issue date or the issue day-of-week of the received check is different from the transaction pattern, the risk level related to the handling of such a check is determined as high.

Furthermore, the risk-level determining unit 19e determines whether the issue date contained in the check information is within predetermined days from the latest issue date or not (see B-3 of FIG. 18B).

Furthermore, the risk-level determining unit 19e determines whether the amount contained in the check information is predetermined amount larger than an average transaction amount (see B-4 of FIG. 18B). More specifically, the risk-level determining unit 19e determines the “average transaction amount” per transaction based on the transaction amount and the check number contained in the transaction history. Then, the risk-level determining unit 19e confirms whether the check amount written on the check is predetermined amount larger than the “average transaction amount” or not.

In this manner, the average transaction amount for the check of the drawer is determined as the transaction pattern, and the risk level of the check is determined depending on the degree of consistency between the check amount read by the check reading unit 14 and the average transaction amount. Therefore, it is possible to determine that the risk level related to the handling of the check is high when the received check amount greatly exceeds the normal transaction amount.

Furthermore, the risk-level determining unit 19e confirms whether the check number contained in the check information is not more than predetermined numbers apart from the latest check number contained in the transaction history (see B-5 of FIG. 18B). This is because the currently-received check number is normally close (e.g., sequential number) to the latest check number contained in the transaction history. In the example shown in FIG. 18A, the risk-level determining unit 19e compares the check number contained in the check information with the latest check number “0260” contained in the transaction history.

In this manner, when the risk level of the check is determined depending on a comparison result between the latest check number among check numbers contained in the transaction history and the bank number read by the check reading unit 14, it is possible to determine that the risk level related to the handling of the check is high when the received check number is largely apart from the latest check number.

Furthermore, the risk-level determining unit 19e confirms whether the check number contained in the check information does not match a check number contained in the transaction history (see B-6 of FIG. 18B). This is because the check number is an identification number for identifying each check of the same account and the same bank number, and the check numbers do not match each other. When the check number of the received check matches a check number contained in the transaction history, it is likely that the received check is a counterfeit check.

Furthermore, the risk-level determining unit 19e confirms whether the check number contained in the check information does not match a check number of a check for which a report of process disapproval, such as a report of loss of the check or a report of a stolen check, has been issued (see B-7 of FIG. 18B). This is because when the check number of the received check matches the check number of the check for which the above-mentioned reports are issued, it is more likely that the user is a third person who attempts to achieve benefits fraudulently.

Furthermore, the risk-level determining unit 19e determines an “average number of issues” per month from dates of issue and check numbers contained in the transaction history, and checks whether the number of issued checks in a current month is more than predetermined number larger than the “average number of issues” (see B-8 of FIG. 18B). When the employee list can be acquired from the company (see FIGS. 9A and 9B), the risk-level determining unit 19e may check whether the number of issued checks in a current month is predetermined number larger than the number of employees.

Then, the risk-level determining unit 19e determines the risk level depending on the number of corresponding items. More specifically, as shown in C-1 of FIG. 18C, when the number of corresponding items is “8”, i.e., when the check information corresponds to all the confirmation items, the risk-level determining unit 19e determines the risk level as “level 0”.

Furthermore, the risk-level determining unit 19e determines the risk level as “level 1” when the number of corresponding items is “7”, determines the risk level as “level 2” when the number of corresponding items is “4 to 6”, and determines the risk level as “level 3” when the number of corresponding items is “1 to 3”. Moreover, when the number of corresponding items is “0”, i.e., when the check information does not correspond to all the confirmation items, the risk-level determining unit 19e determines the risk level as “level 4”.

On the other hand, when the check information corresponds to the item B-6 or the item B-7 among the items shown in FIG. 18B, the risk-level determining unit 19e determines the risk level as “level 4” regardless of the number of corresponding items (see C-2 of FIG. 18C). As a result, the abnormality-handling processing unit 19d performs the rejection process on the check corresponding to the item B-6 or the item B-7. This is because when the check information corresponds to the item B-6 or the item B-7, the risk related to the handling of the check is extremely high.

The fee setting unit 19f and the abnormality-handling processing unit 19d determine a processing content depending on the risk level determined by the risk-level determining unit 19e. The cashing processing unit 19c transmits to the management apparatus 3 a transaction history containing cashing information with a cashed amount, the user ID, the account number of the drawer, and the like after dispensing money in the cashed amount. Consequently, a new transaction history is stored in the transaction history DB 30b.

In this manner, the check reading unit 14 reads, from the check, the check information containing the drawer information for identifying the drawer of the check; the risk-level determining unit 19e acquires the transaction history associated with the check in the name of the drawer based on the drawer information read by the check reading unit 14, and determines the risk level related to the handling of the check based on a comparison result between the acquired transaction history and the check information read by the check reading unit 14; and the fee setting unit 19f, the abnormality-handling processing unit 19d, and the cashing processing unit 19c process the check based on a processing content corresponding to the risk level determined by the risk-level determining unit 19e. Therefore, it is possible to process the check based on an individual processing content corresponding to the risk borne by the store in handling the check.

Furthermore, when the bank number read by the check reading unit 14 matches the bank number contained in the transaction history, the abnormality-handling processing unit 19d performs the abnormality handling process regardless of the number of corresponding items. Therefore, a risk borne by the store can be reduced infallibly.

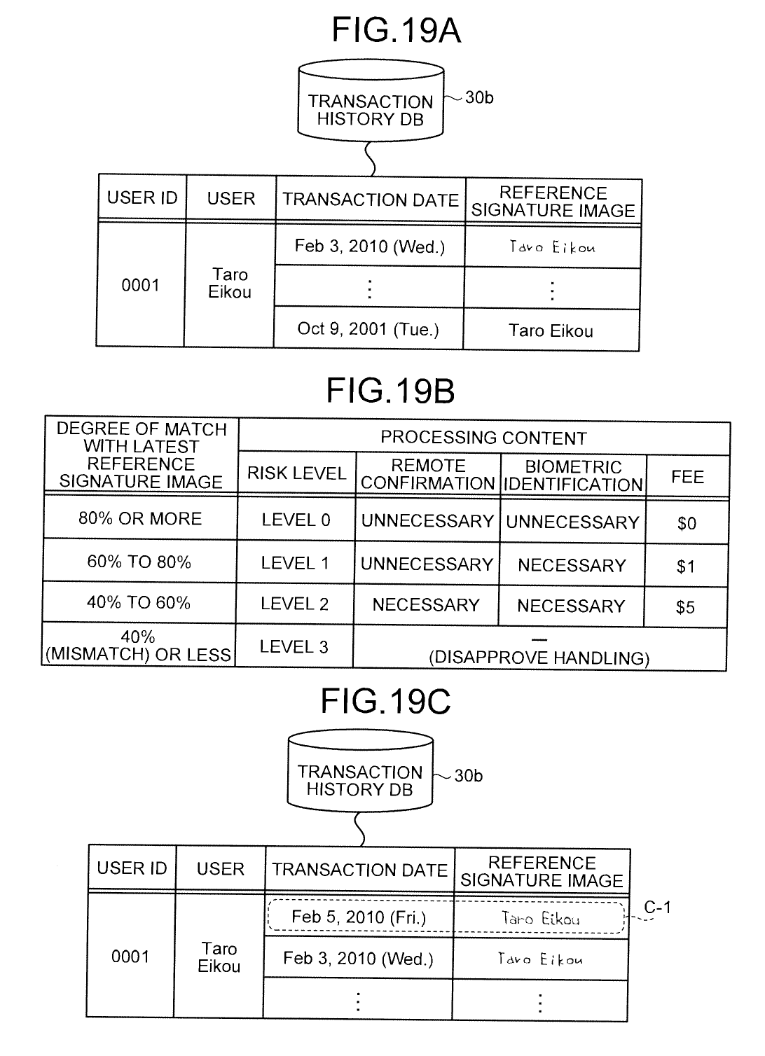

Next, a case in which the risk level determination is performed by signature matching is described below with reference to FIGS. 19A to 19C. FIGS. 19A to 19C are diagrams for explaining a case in which the risk level is determined by the signature matching. More specifically, FIG. 19A illustrates an example of a transaction history for the user; FIG. 19B illustrates an example of confirmation items; and FIG. 19C illustrates a situation in which the transaction history DB 30b is updated.

As shown in FIG. 19A, in the transaction history DB 30b, a user name, a transaction date, and a reference signature image are stored as the transaction history for the user, in association with the user ID. The reference signature image is an image of a signature of the user, which has been read by the check reading unit 14 in the past.

When the user is authenticated by the authenticating unit 19a, the risk-level determining unit 19e acquires the transaction history corresponding to the user ID of the authenticated user from the transaction history DB 30b. Then, the risk-level determining unit 19e determines the risk level of the check based on a matching result between the signature image read from the currently-received check and the latest reference signature image among reference signature images contained in the transaction history.

More specifically, as shown in FIG. 19B, when the degree of match between the current signature image and the latest reference signature image is 80% or more, the risk-level determining unit 19e determines the risk level as “level 0”. Furthermore, the risk-level determining unit 19e determines the risk level as “level 1” when the degree of match between the current signature image and the latest reference signature image is 60% to 80%, and determines the risk level as “level 2” when the degree of match between the current signature image and the latest reference signature image is 40% to 60%. Moreover, when the degree of match is 40% or less, the risk-level determining unit 19e determines the risk level as “level 3”.

Then, the fee setting unit 19f sets the fee at “$0” when the risk level is determined as “level 0”, sets the fee at “$1” when the risk level is determined as “level 1”, and sets the fee at “$5” when the risk level is determined as “level 2”. In this manner, the fee setting unit 19f sets a lower fee for the check-cashing process as the degree of match between the current signature image and the latest reference signature image is increased. Therefore, it is possible to set an appropriate fee for a highly secure transaction.

Furthermore, the abnormality-handling processing unit 19d determines that the remote confirmation and the biometric identification are “unnecessary” when the risk level is determined as “level 0”, determines that the remote confirmation is “unnecessary” and the biometric identification is “necessary” when the risk level is determined as “level 1”, and determines that the remote confirmation and the biometric identification are “necessary” when the risk level is determined as “level 2”.

Furthermore, when the risk level is determined as “level 3”, the abnormality-handling processing unit 19d determines that the handling of the check is disapproved, and performs the rejection process. In this manner, money in the amount remaining after deducting the determined fee from the check amount is dispensed when the degree of match between the current signature image and the latest reference signature image is equal to or larger than a predetermined value. Therefore, a risk borne by the store can be reduced.

Furthermore, when dispensing money in the cashed amount, the cashing processing unit 19c transmits, to the management apparatus 3, the transaction history containing the user ID, the user name, the transaction date, and the currently-acquired signature image. Consequently, as shown in FIG. 19C, a new transaction history is stored in the transaction history DB 30b (see C-1 of FIG. 19C).

In this manner, the risk-level determining unit 19e determines the risk level of the check based on a matching result between the signature image read by the check reading unit 14 and the reference signature image registered as an object to be matched with the signature image; and the fee setting unit 19f, the abnormality-handling processing unit 19d, and the cashing processing unit 19c process the check based on a processing content corresponding to the risk level determined by the risk-level determining unit 19e. Therefore, it is possible to process the check based on an individual processing content corresponding to the risk borne by the store. Furthermore, because the signature matching is performed, it is possible to perform the transaction with increased security.

Moreover, the cashing processing unit 19c stores, as a reference signature image, the signature image read by the check reading unit 14 in a predetermined memory area, in association with the processing date of the check; and the risk-level determining unit 19e determines the risk level of the check based on a matching result between the signature image read by the check reading unit 14 and the latest reference signature image among reference signature images corresponding to the read signature image. Thus, because the matching is performed with the latest reference signature image, it is possible to cope with temporal changes in handwriting of the user.

It has been explained that the handling of the check is determined to be disapproved when the degree of match between the currently-acquired signature image and the latest reference signature image is 40% or less; however, it is not limited thereto. For example, the risk-level determining unit 19e may perform the signature matching with an older reference signature image when the degree of match is 40% or less.

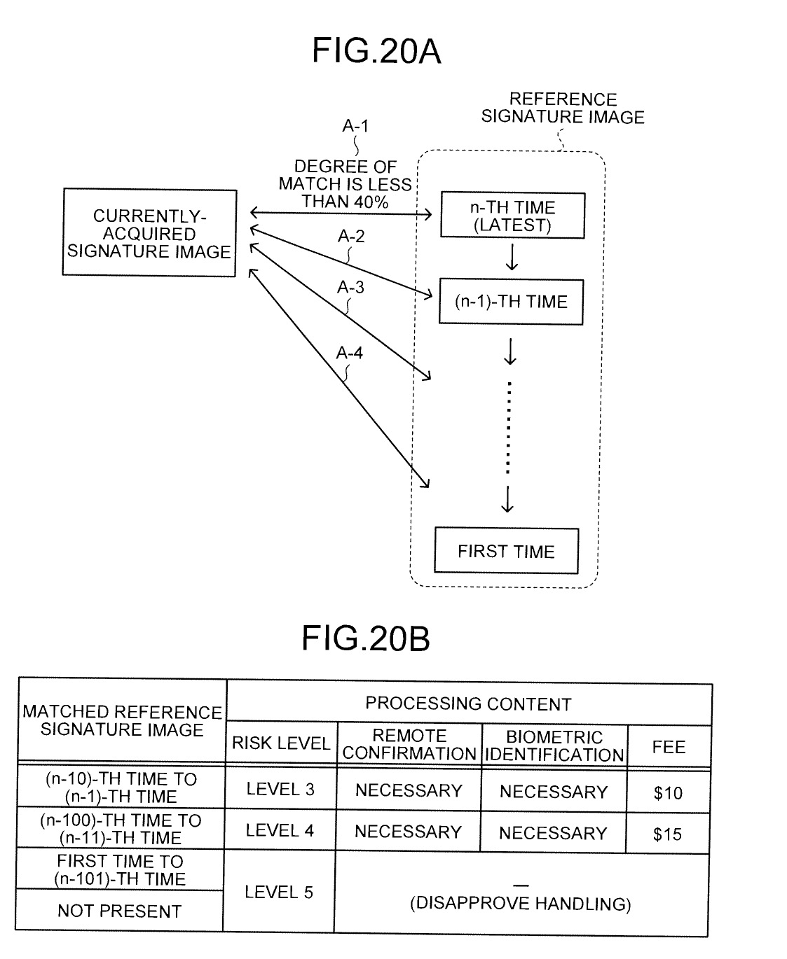

This is described below with reference to FIGS. 20A and 20B. FIGS. 20A and 20B are diagrams representing an example of another operation by the risk-level determining unit 19e. More specifically, FIG. 20A illustrates a situation in which the currently-acquired signature image is matched with a plurality of reference signature images in chronological order; and FIG. 20B illustrates an example of determination by the risk-level determining unit 19e.

As shown in FIG. 20A, when the degree of match between the currently-acquired signature image and the latest reference signature image (n-th time from the first time) is 40% or less (see A-1 of FIG. 20A), the risk-level determining unit 19e performs the signature matching between a second latest reference signature image ((n-1)-th time from the first time) and the currently-acquired signature image (see A-2 of FIG. 20A).

When the degree of match at this time is 40% or less, the risk-level determining unit 19e performs the signature matching between an older reference signature image ((n-2)-th time from the first time) and the currently-acquired signature image (see A-3 of FIG. 20A). In this manner, the risk-level determining unit 19e repeats the signature matching until the currently-acquired signature image matches any one of the reference signature images contained in the transaction history (see A-4 of FIG. 20A).

Then, the risk-level determining unit 19e determines the risk level related to the handling of the check based on how much the matched reference signature image is older. More specifically, when the matched reference signature image is a (n-10)-th to (n-1)-th signature image from the first reference signature image, the risk-level determining unit 19e determines the risk level as “level 3”. Furthermore, when the matched reference signature image is a (n-100)-th to (n-11)-th signature image from the first reference signature image, the risk-level determining unit 19e determines the risk level as “level 4”.

Furthermore, when the matched reference signature image is a first to (n-101)-th signature image, or when the matched reference signature image is not present, the risk-level determining unit 19e determines the risk level as “level 5”.

Then, the fee setting unit 19f sets a fee at “$10” when the risk level is determined as “level 3”, and sets the fee at “$15” when the risk level is determined as “level 4”. Furthermore, the abnormality-handling processing unit 19d determines that the remote confirmation and the biometric identification are “necessary” when the risk level is determined as “level 3” or “level 4”. Furthermore, when the risk level is determined as “level 5”, the abnormality-handling processing unit 19d determines that the handling of the check is disapproved, and performs the rejection process.

In this manner, when the degree of match between the currently-acquired signature image and the latest reference signature image is equal to or smaller than a predetermined value, the risk-level determining unit 19e determines the risk level of the check based on a matching result between the currently-acquired signature image and other reference signature image corresponding to the currently-acquired signature image. Therefore, even when the currently-acquired signature image does not match the latest reference signature image, a check that matches the other signature image can be handled by the own apparatus.

Furthermore, the abnormality-handling processing unit 19d sets a higher fee for cashing the check as the processing date associated with the reference signature image matching the currently-acquired signature image becomes older. Therefore, it is possible to set the fee with considerations to the fact that the risk of the transaction is increased as the matched reference signature image becomes older.

It has been explained that the risk-level determining unit 19e uses reference signature images obtained each time in the past, and determines the fee; however, it is not limited thereto. For example, the risk-level determining unit 19e may use reference signature images based on the obtained date, such as the reference date of one month ago, six months ago or one year ago, and may perform only the remote confirmation process or the biometric identification process.

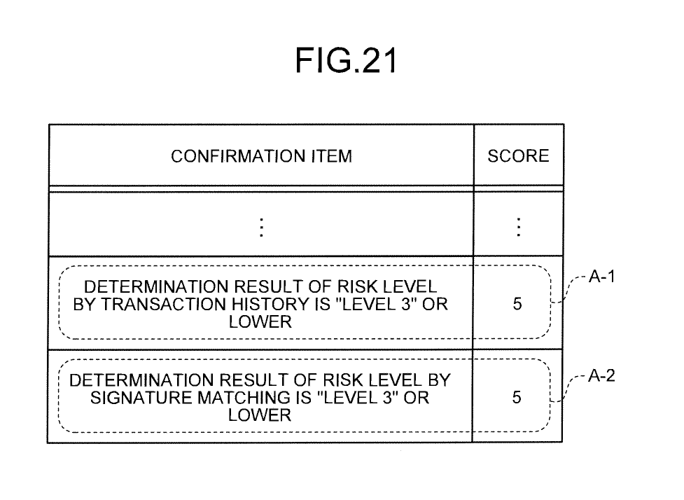

It is possible to incorporate a determination result of the risk level by the transaction history or a determination result of the risk level by the signature matching into the confirmation item 20b illustrated in FIGS. 13A, 15A, and 16A. This is described below with reference to FIG. 21. FIG. 21 is a diagram representing another example of the confirmation item 20b.

As shown in the figure, it is possible to incorporate the determination result of the risk level by the transaction history and the determination result of the risk level by the signature matching into the confirmation item 20b illustrated in FIG. 15A. In this case, the risk-level determining unit 19e confirms whether the determination result of the risk level related to the transaction history is “level 3” or lower (see A-1 of FIG. 21), or checks whether the determination result of the risk level by the signature matching is “level 3” or lower (see A-2 of FIG. 21).

In this manner, when the determination result of the risk level by the transaction history or the determination result of the risk level by the signature matching is incorporated into the confirmation item 20b as one item, it is possible to more strictly determine the risk level related to the handling of the check.

It has been explained in the second embodiment described above that the fee necessary for cashing the check is changed depending on the risk level; however, it is not limited thereto. The fee may be fixed and only operations of the remote confirmation and the biometric identification may be changed depending on the risk level.

### Third Embodiment

When the check processing apparatus 1 is installed in stores such as convenience stores and supermarkets, it is desirable to consider not only the convenience for users of the check processing apparatus 1 but also improvement in attraction of customers and sales of the stores with the check processing apparatus (see B-3 of FIG. 1B). Therefore, in a third embodiment, a case is described in which a fee is discounted or a coupon ticket available at the stores with the check processing apparatus is issued (corresponding to C-3 of FIG. 1C).

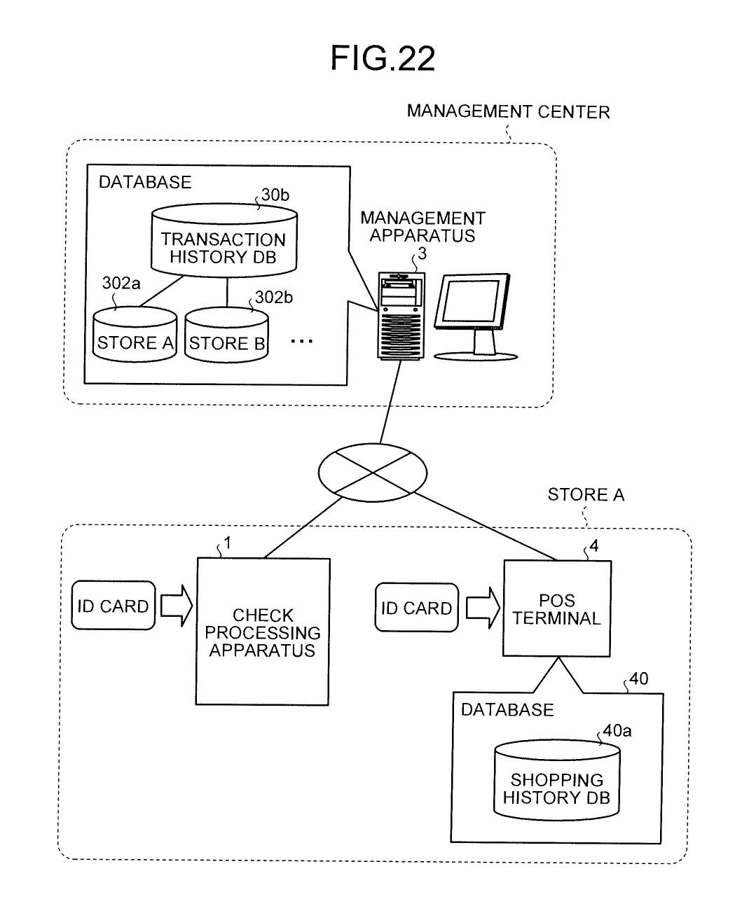

FIG. 22 is a diagram illustrating a network environment to which the check processing apparatus 1 according to the third embodiment is connected. As shown in the figure, the check processing apparatus 1 according to the third embodiment is installed in a store A, and connected to a POS (Point Of Sales) terminal 4 via a network such as a LAN. The POS terminal 4 is a POS register installed to perform a payment process at a payment counter of the store A, and used by an employee of the store A.

The POS terminal 4 includes a database 40 containing a shopping history DB 40a. The shopping history DB 40a is a database for storing a history of product purchase at the store A for each user. In the third embodiment, it is assumed that the ID card for the check processing apparatus 1 is also used as a member's card of the store A. In other words, information associated with the user of the check processing apparatus 1, such as the user registration information and the transaction history, and a shopping history stored in the POS terminal 4 are managed by an identical user ID.

Furthermore, in the third embodiment, the transaction history DB 30b managed by the management apparatus 3 contains a transaction history for each store in which the check processing apparatus 1 is installed. For example, the transaction history DB 30b contains a transaction history 302a for the store A and a transaction history 302b for the store B.

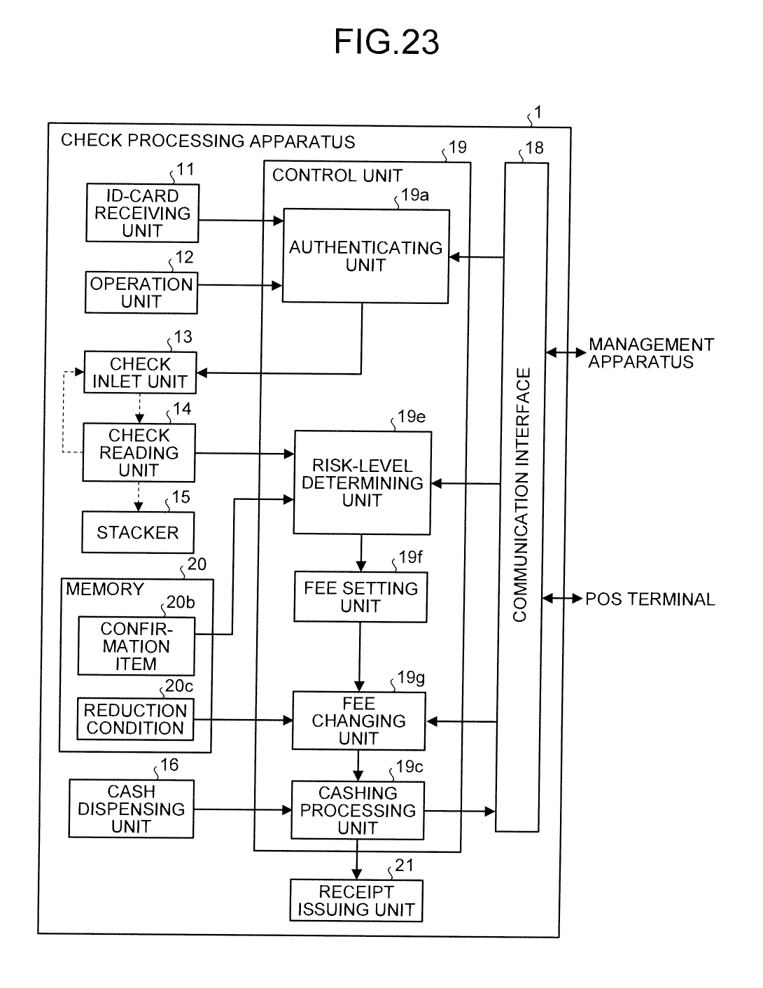

Next, a configuration of the check processing apparatus 1 of the third embodiment is described below with reference to FIG. 23. FIG. 23 is a block diagram of the configuration of the check processing apparatus 1 according to the third embodiment. As shown in the figure, the control unit 19 of the check processing apparatus 1 according to the third embodiment further includes a fee changing unit 19g. The memory 20 of the check processing apparatus 1 further stores therein a reduction condition 20c.

The fee changing unit 19g is a processing unit that changes a fee set by the fee setting unit 19f. More specifically, the fee changing unit 19g changes a fee based on either the user information associated with the user authenticated by the authenticating unit 19a or the check information read by the check reading unit 14, and the reduction condition 20c stored in the memory 20. The user information of this example is a user's shopping history contained in the shopping history managed by the POS terminal 4 or a user's transaction history contained in the transaction history for the store A managed by the management apparatus 3.

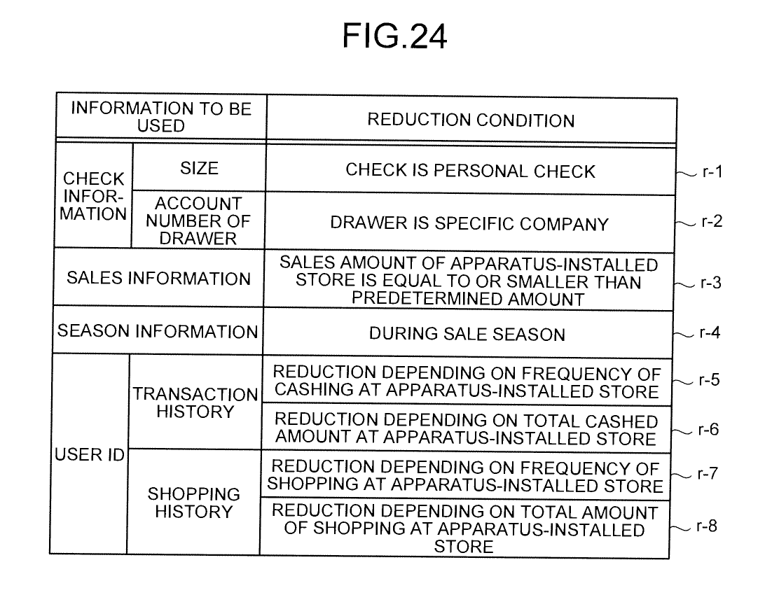

Contents of the reduction condition 20c and an example of operations by the fee changing unit 19g are described below with reference to FIG. 24. FIG. 24 is a diagram representing an example of the reduction condition 20c.

As shown in the figure, the fee setting unit 19f changes a fee depending on the size of a check (see r-1 of the figure). More specifically, because there are two types of checks, i.e., a business check and a personal check smaller than the business check, the fee changing unit 19g is able to identify a type of the check based on the size of the check read by the check reading unit 14.

Then, when the received check is a personal check, the fee changing unit 19g reduces the fee set by the fee setting unit 19f. The fee changing unit 19g may reduce the fee when receiving the business check.

In this manner, when the fee is changed depending on the size of the check read by the check reading unit 14, it is possible to give preferential treatments to either a user who cashes a business check or a user who cashes a personal check.

The check amount of the business check may be larger than the check amount of the personal check when the business check is used for payroll. Therefore, if the fee for the business check is reduced, it is likely that a user who cashes the business check visits the store more number of times. Accordingly, it is likely that the user who has cashed the check for a large amount may purchases a more expensive product at the store A, leading to improvement in sales of the store A.

Furthermore, the fee changing unit 19g is able to change a fee when the drawer is a specific company (see r-2 of the figure). More specifically, the fee changing unit 19g identifies the drawer based on the bank number and the account number of the drawer contained in the check information. Then, when the identified drawer is a specific company which is registered in advance as a client company of the store A and as a blue-chip company with good security and credit, the fee changing unit 19g reduces the fee.

In this manner, by reducing the fee when the drawer identified from the drawer information read by the check reading unit 14 is a specific drawer, it is possible to give preferential treatments in handling a check issued by a specific company such as a client company and a blue-chip company.

Consequently, it is likely that employees of the client company actively visit the store A to cash paychecks, so that a relationship between the client company and the store A can be improved. Furthermore, because the store A comes to handle a number of checks issued by a blue-chip company, a risk borne by the store A in handling a check can be reduced.

The fee changing unit 19g is also able to set a fee depending on the sales of the store A (see r-3 of the figure). More specifically, the fee changing unit 19g acquires, from the POS terminal 4, sales information containing an amount of sales achieved by the store A within a predetermined period (e.g., 3 hours). Then, the fee changing unit 19g reduces the fee when the sales amount contained in the acquired sales information is equal to or smaller than a predetermined amount.

In this manner, when the sales information about sales performed within a predetermined period at the store in which the own apparatus is installed is acquired, and the fee is reduced when a sales amount indicated by the acquired sales information is smaller than a predetermined amount, the number of users who cash checks may be increased because of the reduction of the fees. Therefore, the probability that the user who has cashed a check purchases a product at the store having the check processing apparatus can be increased. As a result, sales of the store having the check processing apparatus can be increased.

Furthermore, the fee changing unit 19g is able to change a fee in accordance with a sale season that is arbitrarily set by the store A (see r-4 of the figure). More specifically, when receiving a notice of start of the sale season from the POS terminal 4, the control unit 19 reduces the fee.

Furthermore, the fee changing unit 19g is able to change the fee based on a transaction history or a shopping history for the user at the store A. More specifically, the fee changing unit 19g determines frequency of cashing or a total cashed amount by the user at the store A based on the transaction history for the user at the store A, and reduces the fee depending on the determined frequency of cashing or the determined total cashed amount (see r-5 and r-6 of the figure).

Furthermore, the fee changing unit 19g determines frequency of shopping or a total amount of shopping by a user at the store A based on the shopping history for the user, and reduces the fee depending on the determined frequency of shopping or the determined total amount of shopping (see r-7 and r-8 of the figure).

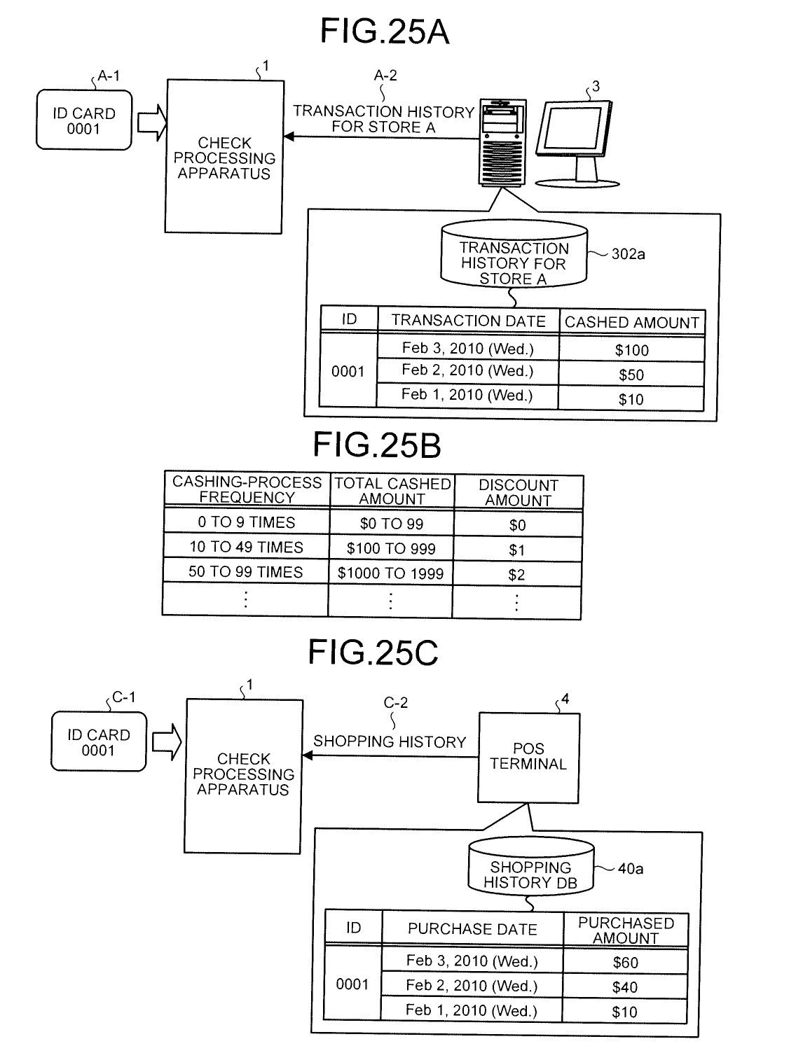

An example of operations performed by the control unit 19 based on the reduction conditions r-5 to r-8 shown in FIG. 24 is described in detail below with reference to FIGS. 25A to 25C. FIGS. 25A to 25C are diagrams representing an example of operations by the fee changing unit 19g. More specifically, FIG. 25A illustrates a situation in which the transaction history for the store A is acquired from the management apparatus 3; FIG. 25B illustrates discount amounts of the fees according to cashing-process frequency or a total cashed amount; and FIG. 25C illustrates a situation in which the shopping history is acquired from the POS terminal 4.

As shown in FIG. 25A, in the check processing apparatus 1, when the user is authenticated by the authenticating unit 19a (see A-1 of FIG. 25A), the transaction history 302a for the store A among transaction histories associated with the user ID of the authenticated user is acquired from the transaction history DB 30b (see A-2 of FIG. 25A).

The transaction history 302a for the store A is information containing a history of a check-cashing process by the check processing apparatus 1 installed in the store A. More specifically, as shown in FIG. 25A, the transaction history 302a for the store A is information containing the transaction date and the cashed amount, in association with the user ID.

Subsequently, the fee changing unit 19g determines the number of times of cashing a check (the cashing-process frequency) or a total cashed amount for the user at the store A within a predetermined period, from the acquired transaction history 302a. Then, the fee changing unit 19g reduces the fee depending on the determined cashing-process frequency or the determined total cashed amount.

For example, as shown in FIG. 25B, the fee changing unit 19g determines a discount amount as “$0” when the determined cashing-process frequency is “0 to 9 times” or the determined total cashed amount is “$0 to $99”. Furthermore, the fee changing unit 19g determines a discount amount as “$1” when the determined cashing-process frequency is “10 to 49 times” or the determined total cashed amount is “$100 to $999”. Moreover, the fee changing unit 19g determines a discount amount as “$2” when the determined cashing-process frequency is “50 to 99 times” or the determined total cashed amount is “$1000 to $1999”.

In this manner, the fee changing unit 19g acquires a cashing process history (in this example, the transaction history 302a for the store A) as the user information from the management apparatus, and changes the fee based on the acquired cashing process history. More specifically, when the number of times of cashing a check or the total cashed amount for the user is determined, and the fee is reduced as the determined number of times of cashing or the determined total cashed amount is increased, it is likely that the user actively visits the store A to increase a discount amount of the fee for the check. Therefore, it is possible to improve the convenience for the user and attraction of customers of the store A.

On the other hand, as shown in FIG. 25C, when the authenticating unit 19a authenticates the user (see C-1 of FIG. 25C), the fee changing unit 19g acquires a shopping history corresponding to the user ID of the authenticated user from the shopping history DB 40a managed by the POS terminal 4 (see C-2 of FIG. 25C). In this example, the shopping history is information in which a product purchase date and a purchased amount corresponding to the user are stored in association with the user ID.

Subsequently, the fee changing unit 19g determines frequency of product purchase or a total amount of product purchase by the user at the store A from the acquired shopping history. Then, the fee changing unit 19g may reduce the fee depending on the determined frequency of product purchase or the determined total amount of product purchase. In this case, similarly to the example shown in FIG. 25B, the fee changing unit 19g determines the discount amount of the fee so that the discount amount is increased as the frequency of product purchase or the total amount of product purchase is increased.

In this manner, the fee changing unit 19g acquires, as the user information, a history of product purchase (in this example, the shopping history) by the user at the store in which the own apparatus is installed, and changes the fee based on the acquired history of product purchase. More specifically, when the frequency of product purchase or the total amount of product purchase by the user at the store in which the check processing apparatus is installed is determined from the history of product purchase, and the fee is reduced as the determined frequency of product purchase or the determined total amount of product purchase is increased, it is likely that the user actively purchases products at the store A to increase the discount amount of the fee for the check. Therefore, it is possible to improve convenience for the user and attraction of customers of the store A.

The operation by the cashing processing unit 19c of the third embodiment is described below. As shown in FIG. 23, the cashing processing unit 19c dispenses, from the cash dispensing unit 16, money in the cashed amount corresponding to the amount remaining after deducing a fee (hereinafter, referred to as “an actual fee”) changed by the fee changing unit 19g from the check amount read by the check reading unit 14. Consequently, the user can cash the check with a fee lower than usual.

The cashing processing unit 19c is able to discount a product price at the store A or issue a coupon ticket available at the store A depending on the discount amount of the fee determined by the fee changing unit 19g.

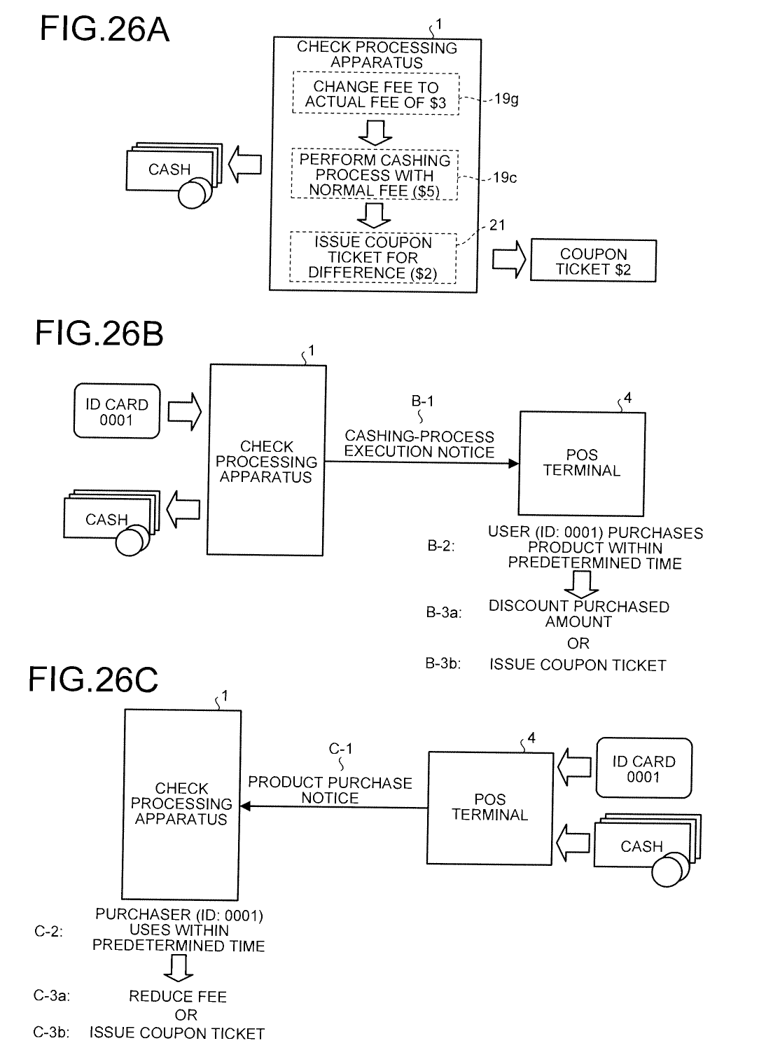

This is described below with reference to FIGS. 26A to 26C. FIGS. 26A to 26C are diagrams representing an example of operations by the cashing processing unit 19c. More specifically, FIG. 26A illustrates a case in which a coupon ticket for the discount amount of the fee is issued; FIG. 26B illustrates a case in which a product price at the store A is discounted or a coupon ticket is issued depending on the discount amount of the fee; and FIG. 26C illustrates a case in which a fee is reduced when a user who has purchased a product at the store A uses the check processing apparatus 1 within a predetermined time.

As shown in FIG. 26A, the cashing processing unit 19c performs a cashing process with a normal fee ($5) even when the fee changing unit 19g changes the fee to the actual fee of $3. The normal fee may be a fee set by the fee setting unit 19for a fee set in advance.

Then, the cashing processing unit 19c instructs a receipt issuing unit 21 to issue a coupon ticket for $2 that is a difference between the normal fee ($5) and the actual fee ($3). Accordingly, the coupon ticket for $2 is output from the receipt issuing unit 21.

In this manner, an instruction is issued to dispense money in the amount remaining after deducting a fixed fee from the check amount read by the check reading unit 14, and to issue a coupon ticket for a difference between the fixed fee and a fee changed by the fee changing unit 19g. As a result, a user who has cashed a check by using the check processing apparatus 1 is more likely to purchase a product at the store A to use the coupon ticket. Therefore, it is possible to improve attraction of customers and sales of the store A.

Furthermore, it is possible to discount a part of a purchased amount or to issue a coupon ticket when a user who has performed the check-cashing process by using the check processing apparatus 1 purchases a product at the store A within a predetermined time. More specifically, as shown in FIG. 26B, when dispensing money in the cashed amount with the normal fee, the cashing processing unit 19c sends a cashing-process execution notice to the POS terminal 4 (see B-1 of FIG. 26B).

The cashing-process execution notice contains the user ID, time when the cashing process is performed, and a difference between the normal fee and the actual fee. The cashing-process execution notice also contains either an instruction to discount a purchased amount or an instruction to issue a coupon ticket.

It is assumed that, at the payment counter of the store A, the user having an user ID identical to the user ID contained in the cashing-process execution notice purchases a product within a predetermined time (e.g., 30 minutes) from the cashing process time contained in the cashing-process execution notice (see B-2 of FIG. 26B). In this case, when the instruction to discount a purchased amount is contained in the cashing-process execution notice, the POS terminal 4 discounts the purchased amount by a difference between the normal fee and the actual fee contained in the cashing-process execution notice (see B-3a of FIG. 26B).

In this manner, an instruction is issued to dispense money in the amount remaining after deducting the fixed fee from the check amount read by the check reading unit 14, and to discount a price of a product purchased by the user by an amount corresponding to a difference between the fixed fee and the fee changed by the fee changing unit 19g. As a result, it is likely that a user who has cashed a check by using the check processing apparatus 1 actively purchases a product at the store A. Thus, the customer attraction effect of the store A and the sales of the store A can be improved.

It has been explained that a price of a purchased product is discounted by a difference between the normal fee and the actual fee; however, it is not limited thereto. For example, the POS terminal 4 may discount a purchased amount by a predetermined percent (e.g., 5%) of the normal fee or the purchased amount when the user purchases a product within a predetermined time after using the check processing apparatus 1 (see B-2 of FIG. 26B). Furthermore, the POS terminal 4 may discount the purchased amount by a predetermined percent of the normal fee or the purchased amount, or may reduce a price of a purchased product by a fixed amount (e.g. $5), every time the number of times of use of the check processing apparatus 1 by the user reaches a predetermined number (e.g., 5 times).

When the instruction to issue a coupon ticket is contained in the cashing-process execution notice, the POS terminal 4 issues a coupon ticket for a difference between the normal fee and the actual fee contained in the cashing-process execution notice (see B-3b of FIG. 26B).

It is also possible to reduce a fee necessary for the check-cashing process when a user who has purchased a product at the store A uses the check processing apparatus 1 within a predetermined time.

More specifically, as shown in FIG. 26C, when the user purchases a product by presenting the ID card, the POS terminal 4 transmits a product purchase notice to the check processing apparatus 1 (see C-1 of FIG. 26C). In this example, the product purchase notice contains the user ID, a product purchase time, and the like. The product purchase notice also contains either an instruction to reduce a fee or an instruction to issue a coupon ticket.

Then, it is assumed that the user who has purchased a product at the store A performs a check-cashing process by using the check processing apparatus 1 within a predetermined time (e.g., 30 minutes) from the product purchase time (see C-2 of FIG. 26C). In this case, when the instruction to reduce the fee is contained in the product purchase notice, the cashing processing unit 19c performs the cashing process by using the fee reduced from the normal fee by a predetermined amount (see C-3a of FIG. 26C). On the other hand, when the instruction to issue the coupon ticket is contained in the product purchase notice, the cashing processing unit 19c performs the cashing process by using the normal fee, and then issues a coupon ticket for a predetermined amount from the receipt issuing unit 21 (see C-3b of FIG. 26C).

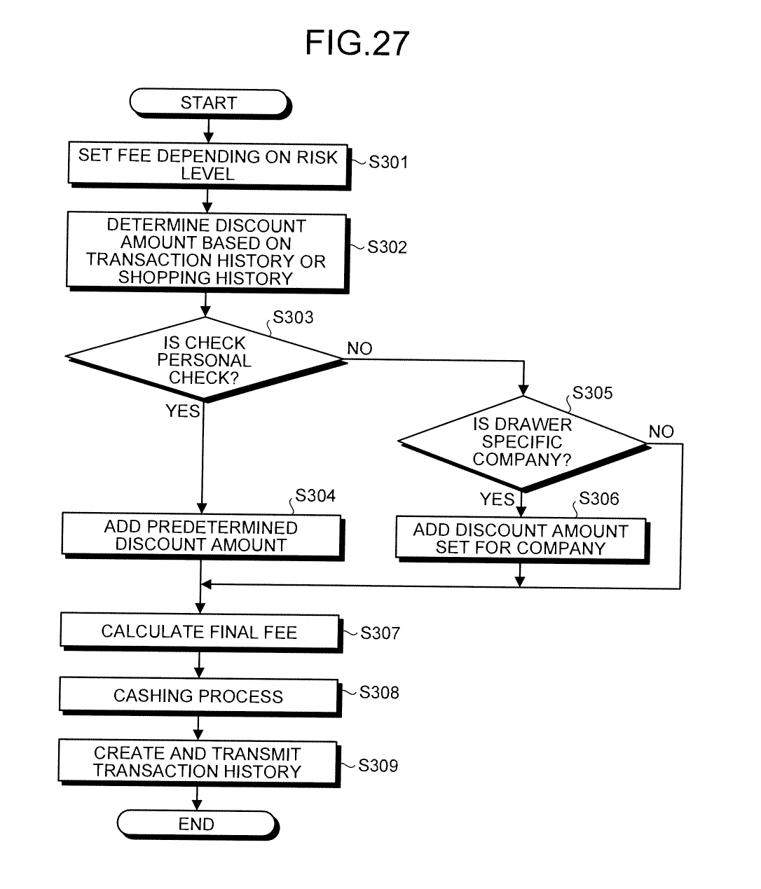

Next, a detailed operation by the check processing apparatus 1 of the third embodiment is described below with reference to FIG. 27. FIG. 27 is a flowchart of a process procedure performed by the check processing apparatus 1 according to the third embodiment. In the figure, a case in which a discount amount of the fee is determined based on the transaction history or the shopping history is illustrated as an example of a fee changing process performed by the fee changing unit 19g.

As shown in the figure, in the check processing apparatus 1, the fee setting unit 19f sets a fee depending on the risk level determined by the risk-level determining unit 19e (Step S301), and the fee changing unit 19g determines a discount amount of the fee based on the transaction history or the shopping history (Step S302).

Subsequently, the fee changing unit 19g determines whether the received check is a personal check or not (Step S303). When the received check is the personal check (YES at Step S303), a predetermine discount amount is further added to the discount amount determined at Step S302 (Step S304).

On the other hand, when the received check is not the personal check (NO at Step S303), i.e., when the received check is the business check, the fee changing unit 19g determines whether the drawer is a specific company or not (Step S305). At this process, when determining that the drawer is the specific company (YES at Step S305), the fee changing unit 19g further adds a discount amount set for the company to the discount amount determined at Step S302 (Step S306).

After the process at Steps S304 or S306 is completed, or when the drawer is not the specific company at Step S305 (NO at Step S305), the fee changing unit 19g calculates an actual fee as a final fee (Step S307). Subsequently, the cashing processing unit 19c dispenses, from the cash dispensing unit 16, money in the amount remaining after deducting the actual fee from the check amount read by the check reading unit 14 (Step S308).

Then, the cashing processing unit 19c creates a transaction history containing the user ID, the cashed amount, the transaction date, information for identifying the store in which the own apparatus is installed, and the like, and transmits the transaction history to the management apparatus 3 (Step S309). Then, the process ends.

As described above, according to the third embodiment, the authenticating unit 19a authenticates a user; the check reading unit 14 reads the check information containing a check amount from a check; the fee changing unit 19g changes a fee necessary for cashing the check based on the user information associated with the user authenticated by the authenticating unit 19a or based on the check information read by the check reading unit 14; and the cashing processing unit 19c performs the check-cashing process based on the check amount read by the check reading unit 14 and the fee changed by the fee changing unit 19g. Therefore, when the check-cashing process is to be automated, it is possible to achieve benefits for both the user and the store by individually setting a fee charged to the user.

As described above, the paper-sheet processing apparatus and the paper-sheet processing method of the present invention are effective to reduce risks borne by a store in which the apparatus is installed and to directly cash a check. More specifically, the paper-sheet processing apparatus and the paper-sheet processing method of the present invention are suitable for processing a check based on an individual processing content corresponding to the risk borne by the sore, and are also suitable for achieving benefits for both the user and the store.

### Fourth Embodiment

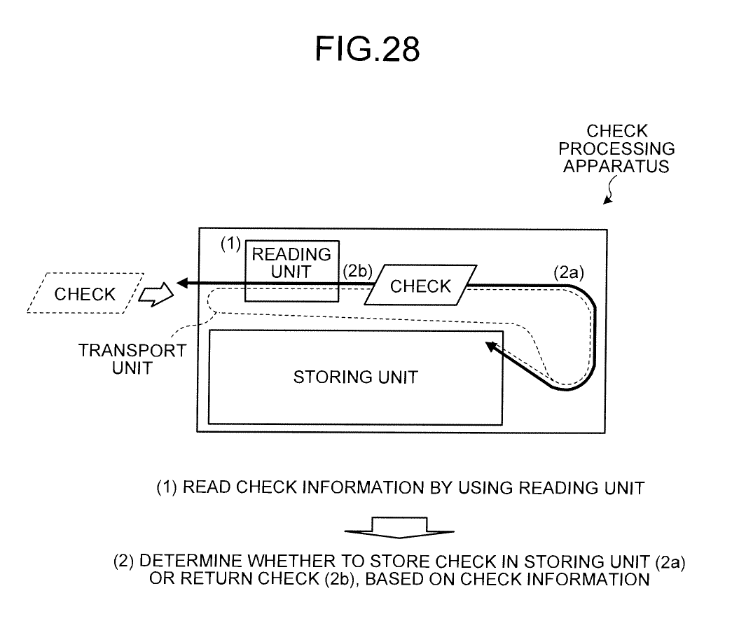

An overview of a check processing technique according to the present embodiment is described below with reference to FIG. 28 before presenting detailed descriptions of the present embodiments. FIG. 28 is a diagram illustrating the overview of the check processing technique according to the present embodiment.

As shown in the figure, with the check processing technique according to the present embodiment, whether a check is stored or returned as post processing of the check from which check information has been read can be determined based on the check information.

Specifically, as shown in the figure, in a check processing apparatus according to the present embodiment, a transport unit transports a received check to a reading unit, and the reading unit reads check information from the check (see (1) of the figure).

More specifically, the reading unit reads information written on the check, such as a check amount, an account number of a drawer, and a bank number, by using character recognition means such as OCR (Optical Character Recognition) and MICR (Magnetic ink Character Recognition). The reading unit also reads an image of a whole or a part of the check (hereinafter, referred to as “a check image”) as the check information, in addition to the information written on the check.

Subsequently, in the check processing apparatus, whether to store the check in a storing unit or to return the check is determined based on the check information read by the reading unit (see (2) of the figure).

For example, the check processing apparatus stores the check in the storing unit when the check amount is equal to or larger than a predetermined amount (see (2a) of the figure), and returns the check to a customer when the check amount is smaller than the predetermined amount (see (2b) of the figure). This is because, when the check amount is large, it is preferable to perform an ex-post confirmation operation by using actual paper checks in view of the security of a transaction.

Furthermore, the check processing apparatus is equipped with a function of displaying a check image read by the reading unit on a predetermined display unit or dispensing the check from the inside of the apparatus to the outside of the apparatus so that when the reading unit cannot read a part of the check information, the unread item can be visually confirmed by store staff. In this case, when the store staff inputs a content of the unread item by using a predetermined operation interface, the check processing apparatus replenishes the information input by the store staff into the check information read by the reading unit. Therefore, it is possible to handle even a check containing an item that cannot be read by the reading unit.

When the check information is replenished with the information by the store staff, the check processing apparatus stores the check in the storing unit (see (2a) of the figure). This is because it is preferable to perform ex-post confirmation to confirm whether the information input by the store staff is correct or not in view of the security of the transaction. Consequently, it is possible to prevent a fraudulent activity in which a customer does not correct information maliciously even when the information input by the store staff is incorrect, or the store staff conspires with a customer to intentionally input incorrect information.

As described above, the check processing apparatus according to the present embodiment includes the storing unit for storing checks. Furthermore, the check processing apparatus determines whether to store a check in the storing unit or to return the check based on the check information. Therefore, it is possible to appropriately perform post processing of a check from which the check information has been read.

When returning a check to a customer, the check processing apparatus drives the transport unit in a direction opposite to a normal transport direction to dispense the check from the check inlet unit. Furthermore, when returning a check, the check processing apparatus returns the check after printing a notice indicating that the check has been used on the check to prevent the check from being reused.

When the check has passed through the reading unit, i.e., when reading of the check information by the reading unit has been completed, the check processing apparatus according to the present embodiment temporarily stops the transport unit to hold the check on the transport unit. In other words, every check from which check information has been read by the reading unit is stopped at a predetermined position on the transport unit until a content of the post processing is determined.

Subsequently, the check processing apparatus displays the check information read by the reading unit onto a display unit while holding the check on the transport unit, and requests a customer to accept the check information. Then, when receiving from a operation unit a notice of acceptance containing a notice that the contents of the check information are accepted, the check processing apparatus resumes driving of the transport unit to transport the check to either the storing unit or the check inlet unit.

In this manner, the check is held on the transport unit by temporarily stopping the transport unit when the check has passed through the reading unit. Therefore, the check processing apparatus can be downsized and costs can be reduced compared with ones equipped with an additional mechanism for holding checks.

Furthermore, in the check processing apparatus, the storing unit may be comprises a plurality of separate stackers and checks may be stacked in a sorted manner based on the check information. For example, the check processing apparatus may sort checks for which ex-post confirmation is necessary and checks for which ex-post confirmation is not necessary from each other. Furthermore, the check processing apparatus may sort checks according to a check amount. By stacking checks in a sorted manner as described above, an operation of collecting checks can be simplified.

The storing unit may be a cassette-type storing unit detachable from the check processing apparatus. Furthermore, the storing unit may be able to not only store checks but also to output stored checks.

Described below are present embodiments of the check processing apparatus to which the check processing technique described above with reference to FIG. 28 is applied. In the present embodiments described below, an example is described in which the check processing apparatus according to the present embodiment is connected to a POS terminal installed in a store such as a convenience store and a supermarket.

In other words, in the present embodiments described below, it is assumed that the check processing apparatus according to the present embodiment is used to pay for purchases of products by check and is installed at a payment counter of a store together with the POS terminal. The check processing apparatus according to the present embodiment may be connected to a cash dispenser such as a change dispenser, a cash depositing/dispensing apparatus, and the like, instead of being connected to a cash register such as the POS terminal. Furthermore, the check processing apparatus according to the present embodiment may be included in a money handling apparatus.

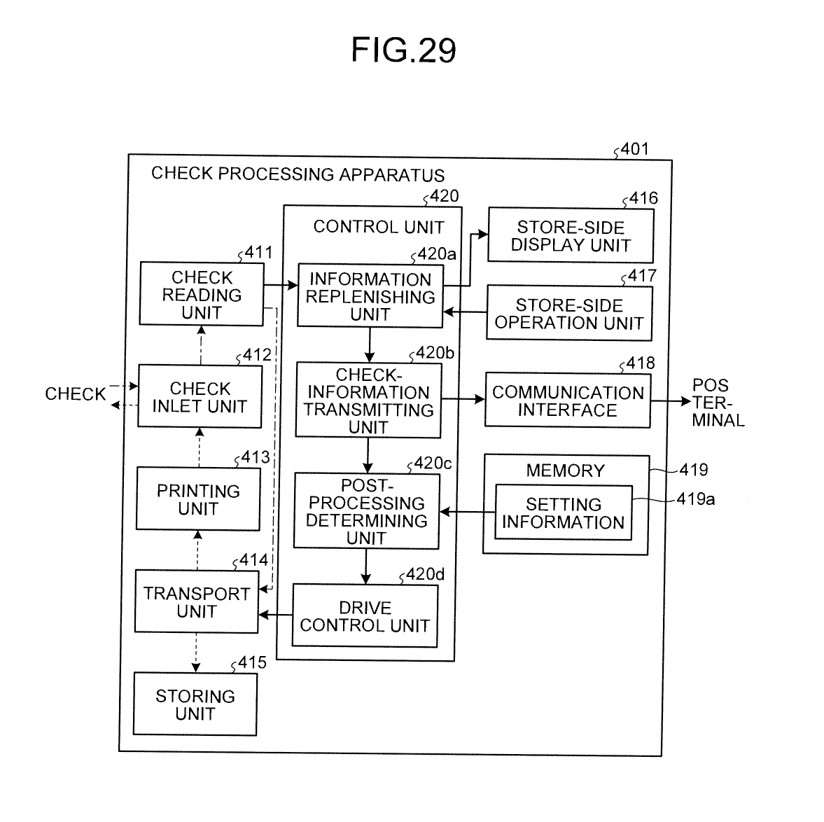

FIG. 29 is a block diagram of a configuration of a check processing apparatus according to a present embodiment. Furthermore, a dash-dot line in the figure indicates a flow of a check from when the check is input into the check processing apparatus to when check information is read, and a chain line in the figure indicates a flow of the check from when reading of the check information is completed to when the check is stored or returned.

As shown in the figure, a check processing apparatus 401 includes a check reading unit 411, a check inlet unit 412, a printing unit 413, a transport unit 414, a storing unit 415, a store-side display unit 416, a store-side operation unit 417, a communication interface 418, a memory 419, and a control unit 420. The memory 419 stores therein setting information 19a. The control unit 420 includes an information replenishing unit 420a, a check-information transmitting unit 420b, a post-processing determining unit 420c, and a drive control unit 420d.

The check reading unit 411 is a check reading device that is arranged on the transport unit 414, and reads check information from a check transported by the transport unit 414. More specifically, the check reading unit 411 reads, as the check information, an issue date of a check, a payment recipient, a check amount, drawer information, payee information, a check number, a bank number, and an account number of a drawer. The check number is an issuance number for identifying each check owned by the drawer, and the bank number is financial institution information for identifying a financial institution that has issued the check. The check reading unit 411 reads the above-mentioned check information by character recognition means such as OCR and MICR.

Moreover, the check reading unit 411 includes a scanner as an image reading device, and reads a check image as the check information in addition to the information written on the check. The check image read by the scanner may be an image of one side surface of the check or an image of both side surfaces of the check. Similarly, the check image read by the scanner may be an image of the whole check or an image of a part of the check.

The check reading unit 411 also performs a process of sending the read check information to the information replenishing unit 420a upon reading the check information from the check.

The check inlet unit 412 receives a check. The check inlet unit 412 may function as a dispensing unit that returns a check to a customer. A check to be input from the check inlet unit 412 may be input by a customer him/herself or store staff who has received the check from the customer.

The printing unit 413 is arranged on the transport unit 414 between the check reading unit 411 and the storing unit 415, and prints predetermined information on a check surface. For example, the printing unit 413 prints on a check a notice that the check has been used. The printing unit 413 may function as an endorser for printing transaction information and the like as endorsement of the check to be stored in the storing unit 415.

Furthermore, the printing unit 413 may be equipped with a function of printing on a check magnetic ink characters to be recognized by MICR. With this configuration, the check processing apparatus 401 is allowed to print a check amount on a check in magnetic ink characters.

In other words, when financial institutions process checks, a check amount written by hand or printed by machines is printed on a predetermined space on each check in magnetic ink characters, and then various processes are performed by reading, through MICR, the check amount printed in the magnetic ink characters. Therefore, when the printing unit 413 is equipped with the function of performing printing in the magnetic ink characters, the check processing apparatus 401 can perform, as a series of processes, a process of reading a check amount written on a check and a process of printing the read check amount in the magnetic ink characters.

The printing unit 413 need not necessarily print the check amount in the magnetic ink characters, and may print the check amount in characters other than the magnetic ink characters. Furthermore, the printing unit 413 may print information other than the check amount, such as “check processing date”, “store information”, and “cashier information” that may be useful when troubles occur during the post processing.

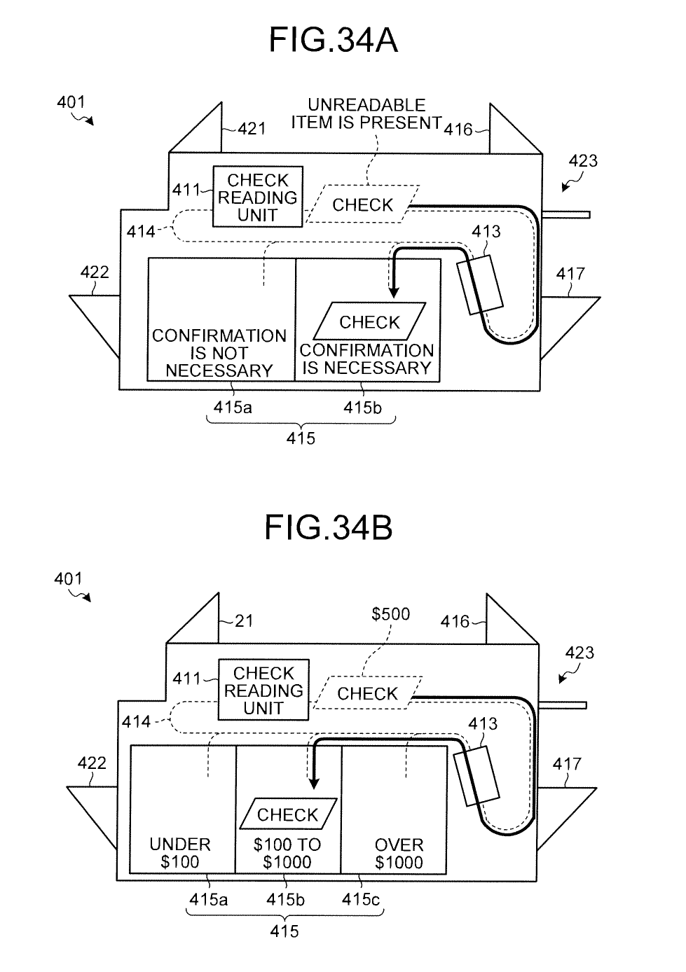

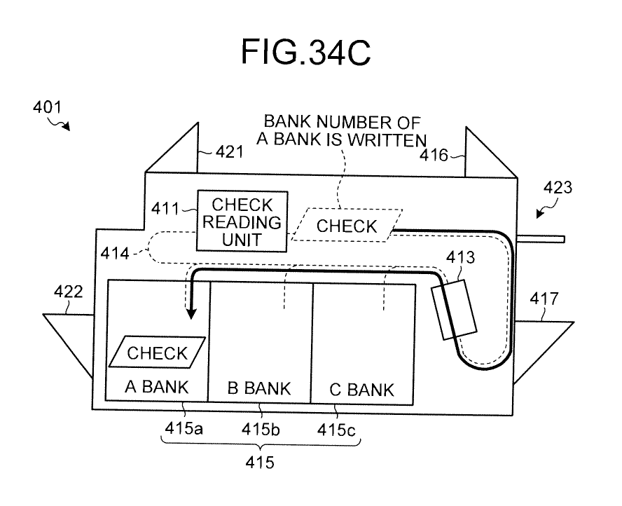

The transport unit 414 includes a belt conveyor for transporting checks one by one by holding the checks, a drive unit of the belt conveyor, rollers for driving the belt conveyor, and diverters arranged at each branch point of the transport path, and the like. The storing unit 415 is for storing a check from which check information has been read by the check reading unit 411. The storing unit 415 may comprises a plurality of storages, which will be described later with reference to FIGS. 34A to 34C.

The store-side display unit 416 is a display device for presenting various types of information to store staff of stores in which the check processing apparatus is installed. For example, when an item that has not been read by the check reading unit 411 (hereinafter, referred to as “unreadable item”) is present in items contained in the check information, a check image read by the check reading unit 411 is displayed on the store-side display unit 416. The store staff reads contents of the unreadable item by viewing the check image displayed on the store-side display unit 416, and manually inputs the read contents by using the store-side operation unit 417.

The store-side operation unit 417 is a processing unit that receives various types of operations from the store staff. For example, the store-side operation unit 417 receives an operation of inputting contents of an unreadable item from the store staff, and sends the contents of the received input operation to the information replenishing unit 420a. Accordingly, the information replenishing unit 420a replenishes the check information with the information received from the store-side operation unit 417. The communication interface 418 is a communication device that transmits and receives communication data to and from the POS terminal.

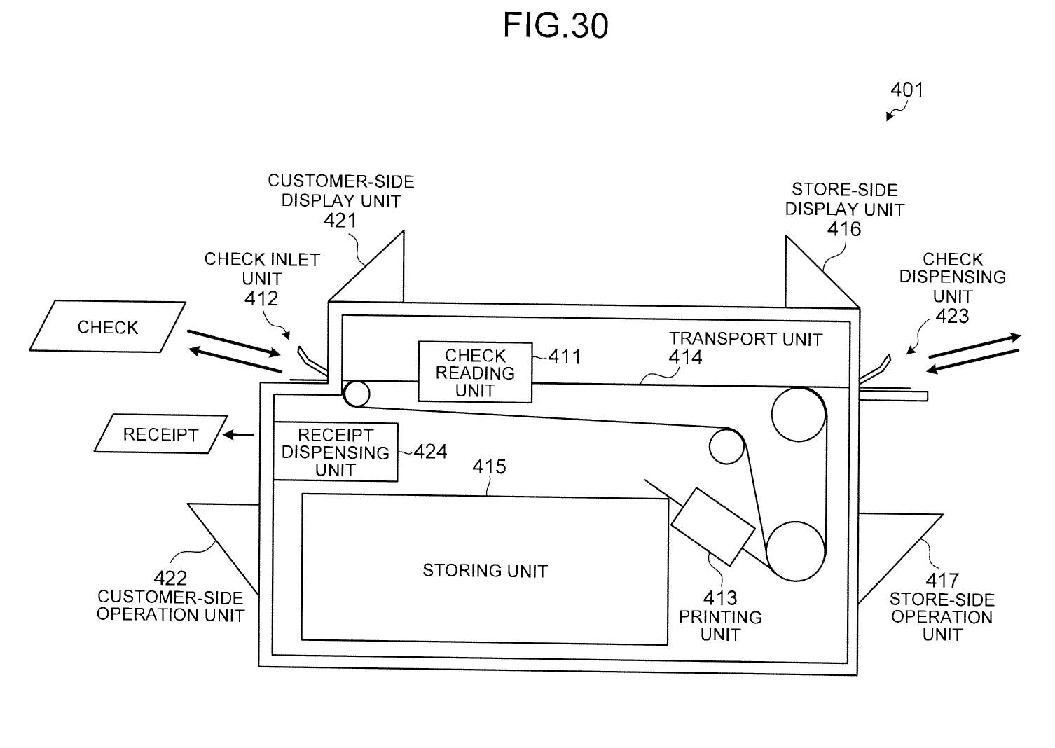

An external structure and an internal structure of the check processing apparatus 401 shown in FIG. 29 are described below with reference to FIG. 30. FIG. 30 is a diagram illustrating the external and internal structures of the check processing apparatus 401.

As shown in the figure, the check processing apparatus 401 comprises a customer-side display unit 421, the check inlet unit 412, a customer-side operation unit 422, the store-side display unit 416, a check dispensing unit 423, and the store-side operation unit 417.

The customer-side display unit 421 is a display device for presenting various types of information to customers. For example, when the check information has normally been read by the check reading unit 411, a confirmation screen containing the read check information, the check image, and the like is displayed on the customer-side display unit 421.

The customer-side operation unit 422 is a processing unit that receives various types of operations from customers. For example, the customer-side operation unit 422 includes an accept button. The accept button is a button to be pressed by customers when the customers accept contents of the check information. The customers press the accept button after confirming whether the contents of the check information are correct or not by viewing the confirmation screen displayed on the customer-side display unit 421.

Furthermore, the customers are allowed to request return of a check by using the customer-side operation unit 422. When receiving a check return request from the customers, the check processing apparatus 1 confirms whether a check amount is equal to or smaller than a predetermined amount or the like. Then, when determining that there is no problem with return of the check, the check processing apparatus 401 returns the check.

The check dispensing unit 423 dispenses checks transported by the transport unit 414 to the outside of the apparatus. The check dispensing unit 423 may function as an inlet unit for inputting checks.

The check inlet unit 412, the customer-side display unit 421, and the customer-side operation unit 422 are arranged on a surface of the check processing apparatus 401; and the store-side display unit 416, the store-side operation unit 417, and the check dispensing unit 423 are arranged on a side opposing to the side where the customer-side display unit 421 and the customer-side operation unit 422 are arranged. Therefore, when the check processing apparatus 401 is to be installed at a payment counter of stores, the check processing apparatus 401 can be installed such that the check inlet unit 412, the customer-side display unit 421, and the customer-side operation unit 422 to be used by customers face a customer side, and the store-side display unit 416, the store-side operation unit 417, and the check dispensing unit 423 to be used by store staff face a store-staff side.

It is assumed that the store-side display unit 416 and the customer-side display unit 421 are arranged on opposing side surfaces of the check processing apparatus 401; however, it is not limited thereto. The store-side display unit 416 and the customer-side display unit 421 may be arranged on adjacent surfaces of the check processing apparatus 401. The same can be applied to the store-side operation unit 417 and the customer-side operation unit 422.

Furthermore, the store-side display unit 416, the customer-side display unit 421, the store-side operation unit 417, and the customer-side operation unit 422 are not necessarily arranged on the check processing apparatus 401, and may be provided separately. For example, a display unit and an operation unit arranged on the POS terminal may be used as alternatives to the store-side display unit 416 and the store-side operation unit 417, respectively. Moreover, the check processing apparatus 401 may be equipped with a single display unit and a single operation unit.

On the other hand, the check processing apparatus 401 includes the check reading unit 411, the printing unit 413, the transport unit 414, the storing unit 415, and a receipt dispensing unit 424. The receipt dispensing unit 424 issues a receipt with a written transaction result and the like when a transaction by check is normally completed. On the receipt, information for identifying a transaction is written, such as a transaction date, a check number, and a check amount. Furthermore, on the receipt, store information for identifying a store in which the check processing apparatus 401 is installed, staff information for identifying staff who has performed a process, a check image, and the like may be printed.

The check processing apparatus 401 need not necessarily include the receipt dispensing unit 424. For example, the check processing apparatus 401 may output a receipt from an external apparatus, such as the POS terminal or a printer, connected to the check processing apparatus 401. Furthermore, the check processing apparatus 401 and the external apparatus may add a check-processing transaction result to a normal receipt that is issued when a customer purchases a product.

As shown in the figure, the check reading unit 411 and the printing unit 413 are arranged on the transport unit 414. A check input from the check inlet unit 412 or the check dispensing unit 423 is transported by the transport unit 414 so that the check passes through the check reading unit 411 and the printing unit 413 and is stored in the storing unit 415.

It is possible to dispense the check from the check dispensing unit 423 or the check inlet unit 412 by driving the transport unit 414 reversely without storing the check in the storing unit 415.

Referring back to FIG. 29, the memory 419 is explained. The memory 419 is a memory device such as a nonvolatile memory and a hard disk drive, and stores therein the setting information 419a. The setting information 419a is information for defining contents of operations of the post-processing determining unit 420c to be described later. The setting information 419a contains a plurality of patterns of the contents of the operations. The store staff is allowed to select any contents of the operations to change the operations of the post-processing determining unit 420c.

The control unit 420 transmits the check information to the POS terminal, and determines post processing to be performed on a check from which the check information has been read, based on the check information. Furthermore, the control unit 420 drives the transport unit 414 according to the determined contents. More specifically, the control unit 420 includes the information replenishing unit 420a, the check-information transmitting unit 420b, the post-processing determining unit 420c, and the drive control unit 420d.

The control unit 420 is an integrated circuit such as an ASIC (Application Specific Integrated Circuit) or an FPGA (Field Programmable Gate Array), or an electronic circuit such as a CPU (Central Processing Unit) and an MPU (Micro Processing Unit).

The information replenishing unit 420a is a processing unit that replenishes, when the check information received from the check reading unit 411 contains an unreadable item, the check information with information input through the store-side operation unit 417 as information corresponding to the unreadable item.

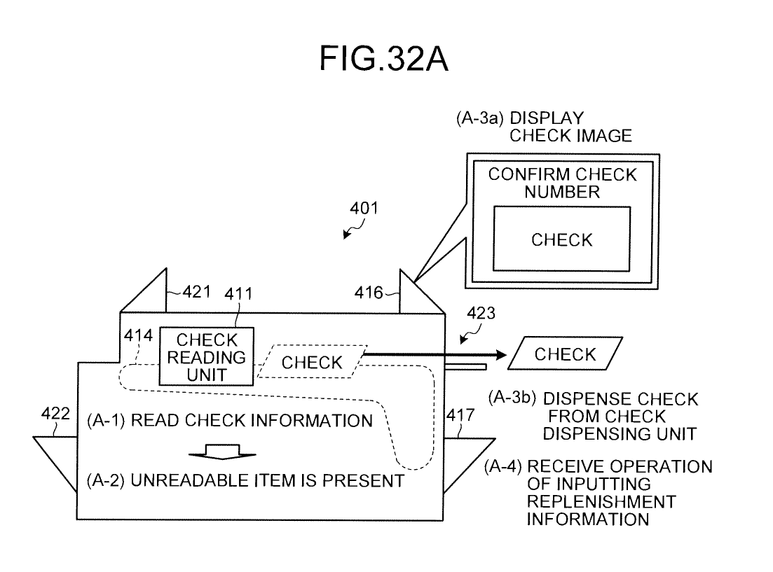

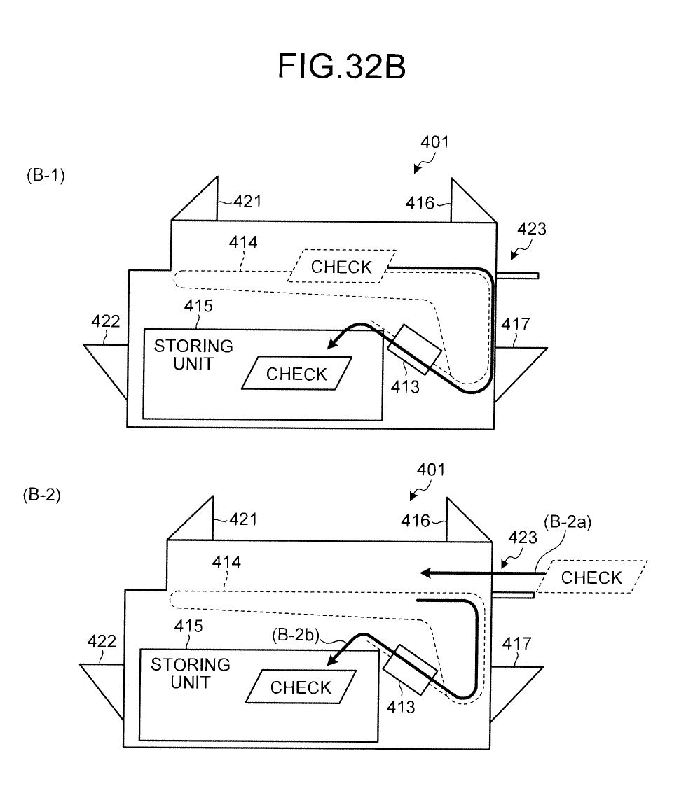

More specifically, when receiving the check information from the check reading unit 411, the information replenishing unit 420a confirms whether an unreadable item is contained in the received check information. Then, when the unreadable item is contained, the information replenishing unit 420a requests store staff to manually input information corresponding to the unreadable item, and replenishes the check information with the input information as the information corresponding to the unreadable item (hereinafter, referred to as “replenishment information”). An example of detailed operations performed by the information replenishing unit 420a will be described later with reference to FIGS. 32A and 32B.

When the unreadable item is not contained in the check information, i.e., when the check reading unit 411 has normally read the check information, the information replenishing unit 420a directly sends the check information received from the check reading unit 411 to the check-information transmitting unit 420b. On the other hand, when the unreadable item is contained in the check information, the information replenishing unit 420a sends, as new check information, the check information received from the check reading unit 411 and replenished with the replenishment information to the information replenishing unit 420a. In this case, when replenishing the check information, the information replenishing unit 420a sends a notice indicating that the check information is replenished to the check-information transmitting unit 420b together with the check information.

In this manner, even when an item that has not been read from the check by the check processing apparatus 401 is present, the information replenishing unit 420a acquires information corresponding to the unreadable item from the store staff via the store-side operation unit 417. Therefore, it is possible to send the check information replenished with all items to the check-information transmitting unit 420b.

The check-information transmitting unit 420b transmits the check information received from the information replenishing unit 420a to the POS terminal via the communication interface 418. When transmitting the check information to the POS terminal, the check-information transmitting unit 420b also performs a process of sending the check information to the post-processing determining unit 420c. When receiving a notice indicating that the check information is replenished from the information replenishing unit 420a, the check-information transmitting unit 420b also sends this notice to the post-processing determining unit 420c.

When acquiring the check information from the check-information transmitting unit 420b, the POS terminal performs a payment process for a product by using the acquired check information. When the check processing apparatus 401 is connected to a cash dispenser and a cash depositing/dispensing apparatus, the cash dispenser and the cash depositing/dispensing apparatus may cash the check by using the check information acquired from the check processing apparatus 401. Furthermore, the cash dispenser and the cash depositing/dispensing apparatus may update an account, e.g., dispense cash from a related account, by using the check information acquired from the check-information transmitting unit 420b.

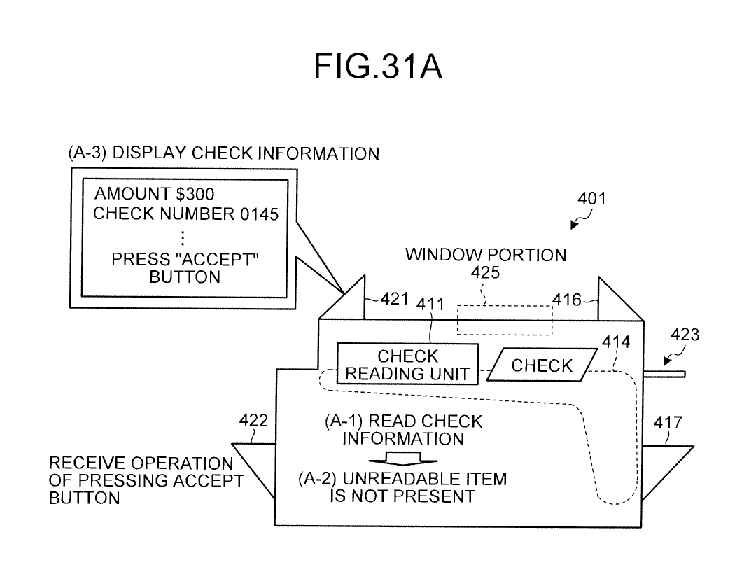

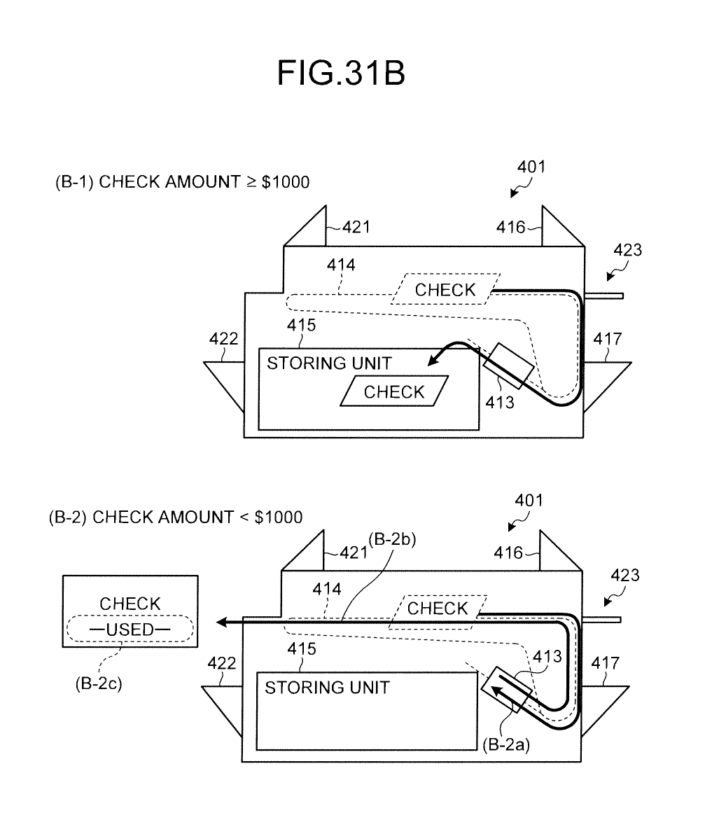

The post-processing determining unit 420c is a processing unit that determines whether to store the check in the storing unit 415 or to return the check based on the received check information upon receiving the check information from the check-information transmitting unit 420b. When determining a content of the post processing, the post-processing determining unit 420c instructs the drive control unit 420d to drive the transport unit 414. An example of detailed operations performed by the post-processing determining unit 420c will be described later with reference to FIGS. 31A, 31B, 32A, and 32B.

The drive control unit 420d is a processing unit that controls driving of the transport unit 414. More specifically, the drive control unit 420d drives the transport unit 414 in a normal transport direction or in a direction opposite to the normal transport direction according to a drive instruction received from the post-processing determining unit 420c.

An example of operations performed by the control unit 420 is described below with reference to FIGS. 31A, 31B, 32A, and 32B. An example of operations performed by the control unit 420 when the check processing apparatus 401 has normally read the check information is described first with reference to FIGS. 31A and 31B. FIGS. 31A and 31B are diagrams representing an example of operations performed by the control unit when the check information has normally been read.

As shown in FIG. 31A, in the check processing apparatus 401, when the check inlet unit 412 receives input of a check, the transport unit 414 transports the received check to the check reading unit 411, and the check reading unit 411 reads the check information, such as a check amount and an account number, from the transported check (see (A-1) of FIG. 31A). It is assumed here that the check information read by the check reading unit 411 does not contain an unreadable item (see (A-2) of FIG. 31A). In other words, it is assumed that the check reading unit 411 has normally read the check information from the check.

In this case, the post-processing determining unit 420c displays a confirmation screen containing the contents of the check information read by the check reading unit 411 and a request for acceptance from a customer on the customer-side display unit 421 (see (A-3) of FIG. 31A). Although not shown in (A-3) of FIG. 31A, the confirmation screen displayed on the customer-side display unit 421 may contain a check image. Also, the confirmation screen may be displayed on the store-side display unit 416.

When the check has passed through the check reading unit 411, i.e., when the check reading unit 411 has normally read the check information from the check, the post-processing determining unit 420c instructs the drive control unit 420d to temporarily stop the transport unit 414. Then, the drive control unit 420d that has received the instruction temporarily stops the transport unit 414. Accordingly, the check is temporarily held on the transport unit 414 until the acceptance from a customer is obtained. More specifically, the check is held on the transport path near the check reading unit 411.

As shown in FIG. 31A, the check processing apparatus 401 includes a window portion 425 that is arranged at an upper portion of a position where the check is stopped and that allows the inside of the apparatus to be viewed.

On the other hand, the customer views the confirmation screen displayed on the customer-side display unit 421 and checks the contents of the check information read by the check reading unit 411. Then, when receiving an operation of pressing the accept button from the customer (see (A-4) of FIG. 31A), the customer-side operation unit 422 transmits to the post-processing determining unit 420c a notice of acceptance containing a notice indicating that the contents of the check information is accepted.

Subsequently, when receiving the notice of acceptance from the customer-side operation unit 422, as shown in FIG. 31B, the post-processing determining unit 420c determines whether to store the check in the storing unit 415 or to return the check depending on a check amount contained in the check information.

More specifically, when the check amount contained in the check information is equal to or larger than a predetermined amount (in this example, $1000), the post-processing determining unit 420c determines to store the check in the storing unit 415 (see (B-1) of FIG. 318). This is because when the check amount is large, it is preferable to perform an ex-post confirmation operation by using actual paper checks in view of the security of the transaction.

When determining to store the check, the post-processing determining unit 420c instructs the drive control unit 420d to resume the driving of the transport unit 414. More specifically, the post-processing determining unit 420c instructs the drive control unit 420d to drive the transport unit 414 in a normal transport direction (i.e., a direction along which the check is transported from the check inlet unit 412 to the check reading unit 411) so as to transport the check to the storing unit 415. Then, the drive control unit 420d that has received the instruction drives the transport unit 414 in the normal direction, so that the check is transported to and stored in the storing unit 415.

As described above, when the check amount read by the check reading unit 411 is equal to or larger than the predetermined amount, the check is determined to be stored in the storing unit 415. Therefore, a transaction by a check can be performed safely.

Furthermore, the post-processing determining unit 420c displays the check information read by the check reading unit 411 on the customer-side display unit 421, and when receiving a notice of acceptance containing the notice indicating that the contents of the check information are accepted from the customer-side operation unit 422, the post-processing determining unit 420c determines the post processing of the check based on the check information.

Therefore, even when the check reading unit 11 has read the check information with error contents, it is possible to prevent a transaction from being performed with the check information containing the error contents. When the contents of the check information is determined to be incorrect according to the confirmation screen displayed on the customer-side display unit 421, it is possible to allow the store staff to correct the information by using the store-side operation unit 417. It is also possible to instruct the drive control unit 420d to drive the transport unit 414 in an opposite direction to return the check out of the check inlet unit 412.

Furthermore, when the check has passed through the check reading unit 411, the drive control unit 420d is instructed to temporarily stop the transport unit 414, and, when the notice of acceptance is received from the customer-side operation unit 422, the drive control unit 420d is instructed to resume the driving of the transport unit 414. In other words, the check is held on the transport unit 414 until the acceptance from the customer is obtained. Therefore, the check processing apparatus 401 can be downsized compared with ones equipped with an additional mechanism for holding checks.

When the check is stored in the storing unit 415, it is possible to endorse the check by using the printing unit 413 as an endorser.

On the other hand, when the check amount contained in the check information is smaller than the predetermined amount (in this example, $1000), the post-processing determining unit 420c determines to return the check (see (B-2) of FIG. 31B).

Furthermore, when determining to return the check, the post-processing determining unit 420c instructs the drive control unit 420d to resume the driving of the transport unit 414. More specifically, the post-processing determining unit 420c instructs the drive control unit 420d to drive the transport unit 414 in the normal transport direction so as to transport the check to the printing unit 413. Then, the drive control unit 420d that has received the instruction drives the transport unit 414 in the normal transport direction, so that the check is transported to the printing unit 413 (see (B-2a) of FIG. 313).

Subsequently, the post-processing determining unit 420c instructs the printing unit 413 to print a notice indicating that the check has been used on the check. Then, the printing unit 413 that has received the instruction prints descriptions such as “used” on the check. The printing unit 413 may print a check amount in magnetic ink characters or other characters instead of printing the notice indicating that the check has been used. Furthermore, the printing unit 413 may print information such as a check processing date, store information, and cashier information.

Subsequently, the post-processing determining unit 420c instructs the drive control unit 420d to drive the transport unit 414 in a direction opposite to the normal transport direction so as to transport the check to the check inlet unit 412. Then, the drive control unit 420d that has received the instruction drives the transport unit 414 in the opposite direction, so that the check is transported to the check inlet unit 412 (see (B-2b) of FIG. 31B). Consequently, the check is returned from the check inlet unit 412. The check returned from the check inlet unit 412 is printed with characters such as “used” as illustrated in (B-2c) of FIG. 31B.

As described above, in the check processing apparatus 1, when the check is returned to the customer, the transport unit 414 is driven in a direction opposite to the normal transport direction to return the check from the check inlet unit 412 to the customer. Furthermore, in the check processing apparatus 401, when the check is returned, a notice indicating that the check has been used is printed on the check surface to prevent the check from being reused. The check may be returned from the check dispensing unit 423 to the cashier.

Next, an example of operations performed by the control unit 420 when an unreadable item is present in the check information is described below with reference to FIGS. 32A and 32B. FIGS. 32A and 32B are diagrams representing an example of operations performed by the control unit 420 when an unreadable item is contained in the check information. More specifically, FIG. 32A illustrates an example of operations performed by the information replenishing unit 420a; and FIG. 32B illustrates an example of operations performed by the post-processing determining unit 420c and the drive control unit 420d.

As shown in FIG. 32A, in the check processing apparatus 1, the check reading unit 411 reads the check information from the check transported by the transport unit 414 (see (A-1) of FIG. 32A). At this time, it is assumed that the check information read by the check reading unit 411 contains an unreadable item (see (A-2) of FIG. 32A).

In this case, the information replenishing unit 420a displays a check image on the store-side display unit 416 (see (A-3a) of FIG. 32A) or instructs the drive control unit 420d to transport the check to the check dispensing unit 423 (see (A-3b) of FIG. 32A) so as to request the store staff to visually check the unreadable item. The store staff is allowed to arbitrarily set whether to display the check image on the store-side display unit 416 or to dispense the check from the check dispensing unit 423. Also the customer and the store staff can read the unreadable item on the actual paper check through a window portion 425 shown in FIG. 31A.

When the store staff can read the contents of the unreadable item by visually confirming the check image or actual paper check, the store staff inputs the read contents (replenishment information) by using the store-side operation unit 417. When receiving an operation of inputting the replenishment information (see (A-4) of FIG. 32A), the store-side operation unit 417 sends the received replenishment information to the information replenishing unit 420a. Then, when receiving the replenishment information from the store-side operation unit 417, the information replenishing unit 420a replenishes the check information with the received replenishment information, and sends the replenished check information as new check information to the check-information transmitting unit 420b.

On the other hand, as shown in FIG. 32B, when the check information is replenished with the replenishment information as described above, the post-processing determining unit 420c determines to store the check in the storing unit 415 regardless of the check amount.

More specifically, when the check image is displayed on the store-side display unit 416 as shown in (A-3a) of FIG. 32A, the post-processing determining unit 420c instructs the drive control unit 420d to drive the transport unit 414 in the normal transport direction so as to transport the check to the storing unit 415. Then, the drive control unit 420d that has received the instruction drives the transport unit 414 in the normal transport direction, so the that check is transported to and stored in the storing unit 415 (see (B-1) of FIG. 32B).

Furthermore, when the check is dispensed from the check dispensing unit 423 as shown in (A-3b) of FIG. 32A, the post-processing determining unit 420c instructs the drive control unit 420d to drive the transport unit 414 in the opposite direction so as to transport the check received from the check dispensing unit 423 to the inside of the apparatus. Then, the drive control unit 420d that has received the instruction drives the transport unit 414 in the opposite direction, so that the check is transported from the check dispensing unit 423 to the inside of the apparatus (see (B-2a) of FIG. 32B). Then, similarly to the situation illustrated in (B-1) of FIG. 32B, the post-processing determining unit 420c stores the check in the storing unit 415 (see (B-2b) of FIG. 32B).

As described above, when the unreadable item is present in the check information, the information replenishing unit 420a replenishes the check information with the replenishment information input through the store-side operation unit 417 as information corresponding to the unreadable item. Also, when the information replenishing unit 420a replenishes the check information with the information, the post-processing determining unit 420c determines to store the check in the storing unit 415.

Therefore, it is possible to perform ex-post confirmation to confirm whether the replenishment information input by the store staff is correct or not. It is also possible to prevent a fraudulent activity in which the customer does not correct the information maliciously even when the information input by the store staff is incorrect, or the store staff conspires with the customer to intentionally input incorrect information.

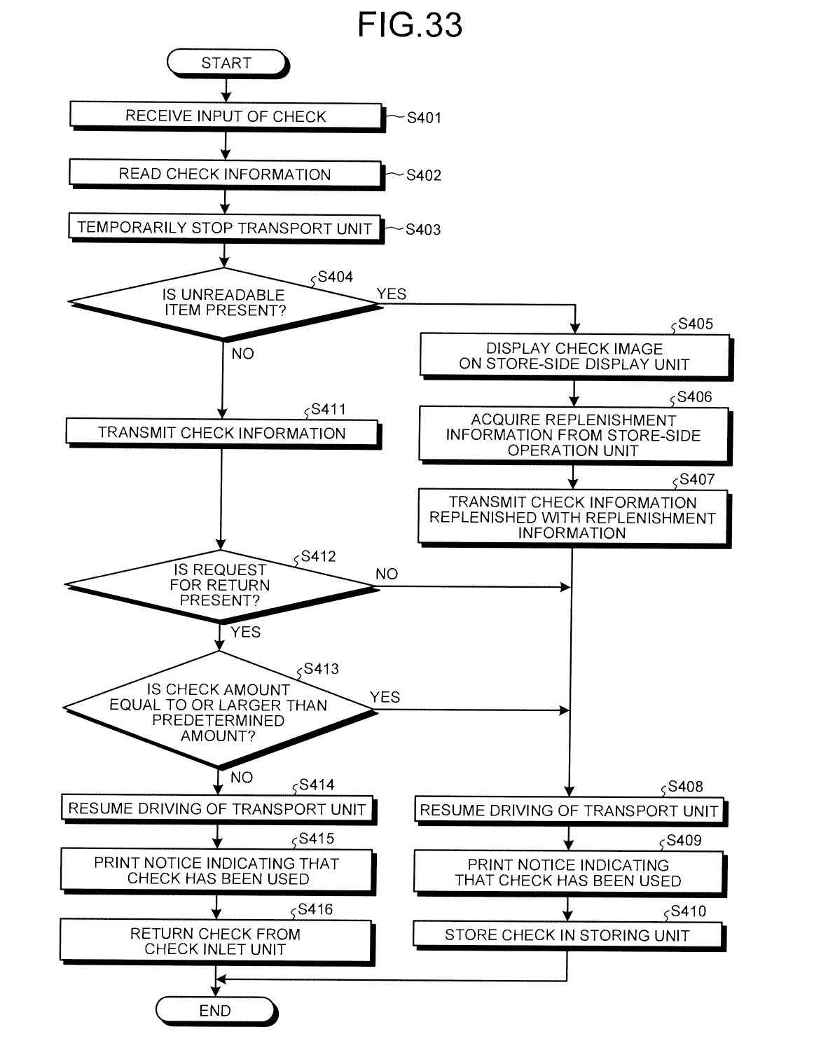

Next, an example of detailed operations performed by the check processing apparatus 401 according to the present embodiment is described below with reference to FIG. 33. FIG. 33 is a flowchart of a process procedure performed by the check processing apparatus 401 according to the present embodiment.

As shown in the figure, in the check processing apparatus 401, when the check inlet unit 412 receives the check (Step S401), the check reading unit 411 reads the check information from the check transported by the transport unit 414 (Step S402). Then, when reading of the check information is completed, the post-processing determining unit 420c instructs the drive control unit 420d to temporarily stop driving of the transport unit 414 (Step S403).

Subsequently, the information replenishing unit 420a determines whether an unreadable item is present in the check information read by the check reading unit 411 or not (Step S404). When determining that the unreadable item is present (YES at Step S404), the information replenishing unit 420a displays a check image on the store-side display unit 416 (Step S405). The information replenishing unit 420a may dispense the check from the check dispensing unit 423 at Step S405.

Subsequently, in the check processing apparatus 401, when the information replenishing unit 420a acquires the replenishment information from the store-side operation unit 417 (Step S406), the check-information transmitting unit 420b replenishes the check information with the replenishment information and then transmits the replenished check information to the POS terminal (Step S407).

When the check information is replenished with the replenishment information, the post-processing determining unit 420c instructs the drive control unit 420d to resume the driving of the transport unit 414 (Step S408). Accordingly, in the check processing apparatus 401, the drive control unit 420d drives the transport unit 414 to transport the check to the printing unit 413, and the printing unit 413 prints a notice indicating that the check has been used on the check (Step S409). Then, in the check processing apparatus 401, the drive control unit 420d drives the transport unit 414 to store the check in the storing unit 415 (Step S410), and the process ends.

On the other hand, when the unreadable item is not present in the check information read by the check reading unit 411 (NO at Step S404), the check-information transmitting unit 420b transmits the check information read by the check reading unit 411 to the POS terminal (Step S411).

Subsequently, the post-processing determining unit 420c determines whether a customer operates the customer-side operation unit 422 to request return of the check or not (Step S412). At this process, when the return of the check is not requested (NO at Step S412), the post-processing determining unit 420c performs the processes at Steps S408 and S410, and the process ends.

On the other hand, when determining that the return of the check is requested (YES at Step S412), i.e., when receiving from the customer-side operation unit 422 a notice indicating that an operation of requesting return has been performed, the post-processing determining unit 420c determines whether the check amount contained in the check information is equal to or larger than a predetermined amount or not (Step S413). At this process, when determining that the check amount is equal to or larger than the predetermined amount (YES at Step S413), the post-processing determining unit 420c performs the processes at Steps S408 and S410, and the process ends.

On the other hand, when the check amount is smaller than the predetermined amount (NO at Step S413), the post-processing determining unit 420c instructs the drive control unit 420d to resume the driving of the transport unit 414 (Step S414). Accordingly, in the check processing apparatus 401, the drive control unit 420d drives the transport unit 414 to transport the check to the printing unit 413, and the printing unit 413 prints a notice indicating that the check has been used on the check (Step S415). Then, in the check processing apparatus 401, the drive control unit 420d drives the transport unit 414 to return the check from the check inlet unit 412 (Step S416), and the process ends.

As described above, in the present embodiment, the check inlet unit 412 receives the check; the transport unit 414 transports the check input from the check inlet unit 412; and the check reading unit 411 reads the check information containing the check amount, from the check transported by the transport unit 414. Furthermore, in the present embodiment, whether to store the check in the storing unit 415 or to return the check is determined based on the check information, as the post processing of the check from which the check information has been read by the check reading unit 411. Therefore, the post processing can be performed appropriately on the check from which the check information has been read.

In the embodiment described above, it is explained that the check processing apparatus 401 is installed at the payment counter of a store together with the POS terminal. However, the check processing apparatus 401 may be installed at a teller window of a bank and the like. In this case, when a bank in which the check processing apparatus 401 is installed can handle electronic checks, a post-transaction process can be performed only by exchanging check images. In other words, it is not necessary to deal with actual paper checks after transactions, so that checks may be returned without being stored.

On the other hand, when the bank in which the check processing apparatus 401 is installed cannot handle electronic checks and can only handle actual paper checks, checks may be stored in the storing unit 415. In this manner, it is possible to return checks when the bank in which the check processing apparatus 401 is installed can handle electronic checks, and store checks to perform post processing by using actual paper checks when the bank cannot handle electronic checks.

The store stuff and bank stuff are allowed to input the above-mentioned settings by using the store-side operation unit 417 and the customer-side operation unit 422. Furthermore, it is possible to store the above-mentioned settings as the setting information 419a in the memory 419 in advance so that a desired setting content can be selected by using the store-side operation unit 417 and the customer-side operation unit 422. Moreover, it is possible to download the setting information stored in an upper-layer terminal (not shown) to the check processing apparatus 401 via a network.

It has been explained in the embodiment described above that, when the check information is replenished with the replenishment information, the check is always stored in view of the security of transactions; however, it is not limited thereto. For example, even when the check information is replenished with the replenishment information, the check processing apparatus 1 may return the check to a customer if the check amount is equal to or smaller than a predetermined amount.

In the embodiment described above, it has been explained that transported checks are stored in the storing unit 415 without being sorted; however, it is not limited thereto. For example, it is possible to stack checks in a sorted manner according to various types of conditions.

This is described below with reference to FIGS. 34A to 34C. FIGS. 34A to 34C are diagrams for explaining situations in which checks are stacked in a sorted manner. More specifically, FIG. 34A illustrates a situation in which checks for which ex-post confirmation by the store staff is necessary and checks for which the ex-post confirmation is not necessary are sorted from each other; FIG. 34B illustrates a situation in which checks are sorted according to check amounts; and FIG. 34C illustrates a situation in which checks are sorted according to banks that have issued the checks.

As shown in FIG. 34A, the storing unit 415 includes a storing unit 415a for storing checks for which the ex-post confirmation by the store staff is not necessary, and a separate storing unit 415b for storing checks for which the ex-post confirmation by the store staff is necessary.

With this configuration, when the check information read by the check reading unit 411 contains unreadable information, the post-processing determining unit 420c determines to store the check in the separate storing unit 415b.

When determining to store the check in the separate storing unit 415b, the post-processing determining unit 420c instructs the drive control unit 420d to drive the transport unit 414 in the transport direction so as to transport the check to the separate storing unit 415b. Accordingly, the check is transported to and stored in the separate storing unit 415b by the transport unit 414.

In this manner, when checks are stored by being sorted as checks for which the ex-post operation by the store staff is necessary and as checks for which the ex-post operation by the store staff is not necessary, efficiency of a check confirmation operation performed by the store staff can be improved. In other words, the store staff can perform the check confirmation operation without performing an operation of sorting checks for which confirmation is necessary and checks for which confirmation is not necessary from among checks stored in the storing unit 415.

The post-processing determining unit 420c may store checks whose check amounts are equal to or larger than a predetermined amount in the separate storing unit 415b, in addition to checks containing an unreadable item.

Furthermore, as shown in FIG. 34B, the storing unit 415 may include the separate storing unit 415a for stacking checks whose check amount is smaller than $100, the separate storing unit 415b for stacking checks whose check amounts are equal to or larger than $100 and smaller than $1000, and a separate storing unit 415c for stacking checks whose check amounts are equal to or larger than $1000.

With this configuration, when the check amount contained in the check information read by the check reading unit 411 is $500, the post-processing determining unit 420c determines to store the check in the separate storing unit 415b. Accordingly, similarly to the situation illustrated in FIG. 34A, the check is transported to and stored in the separate storing unit 415b by the transport unit 414.

In this manner, when checks are stored by being sorted according to the check amounts, it is possible to efficiently store and manage the checks. In other words, while checks are normally stored for a predetermined period to ensure the security of the transaction, it is desirable to store checks with large check amounts for a longer period. This is because a risk for handling a check is increased as a check amount is increased. Therefore, as shown in FIG. 34B, when checks are stored by being sorted according to check amounts, the checks can be sorted according to storage periods. As a result, it is possible to easily store and manage the checks.

Furthermore, as shown in FIG. 34C, the storing unit 415 may include the separate storing unit 415a for stacking checks issued by an A bank, the separate storing unit 415b for stacking checks issued by a B bank, and the separate storing unit 415c for stacking checks issued by a C bank.

With this configuration, when the check is identified to have been issued by the A bank based on a bank number contained in the check information read by the check reading unit 411, the post-processing determining unit 420c determines to store the check in the separate storing unit 415a.

When determining to store the check in the separate storing unit 415a, the post-processing determining unit 420c instructs the drive control unit 420d to drive the transport unit 414 in the transport direction so as to transport the check to the separate storing unit 415a. Accordingly, the check is transported to and stored in the separate storing unit 415a by the transport unit 414.

In this manner, when checks are stored by being sorted according to financial institutions that have issued the checks, it is possible to efficiently store and manage the checks. In other words, stores sometimes send an actual paper check received from the customer to a bank that has issued the check. In this case, because the checks are stored by being sorted according to the banks, it is possible to omit cumbersome operations of sorting the checks according to the banks that have issued the checks. Therefore, it is possible to efficiently store and manage the checks.

As described above, when the storing unit 415 includes a plurality of separate storing units and the post-processing determining unit 420c determines, upon determining to store a check in the storing unit 415, in what separate storing unit the check is stored based on the check information read by the check reading unit 411, it is possible to efficiently perform the ex-post operation, and the checks can be stored and managed efficiently.

The separate storing units may be formed by dividing the single storing unit 415 by using partition plates and the like. It is also possible to use, as the separate storing units, a plurality of storing units each formed separately.

As described above, the check processing apparatus according to the present embodiment is useful for appropriately performing post processing of a check from which check information has been read. More specifically, the check processing apparatus according to the present embodiment is suitable for appropriately determining whether to store the check or to return the check.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A paper sheet handling machine for handling a paper sheet including a check comprising:
a scanner for capturing an image of the check, and reading a check information including at least any one of a bank number, an account number, a check number, a date of drawing and a check amount, from the captured check image;
a memory for storing the check information related to the check transacted in the past, as a transaction history; and,
a controller for determining a risk level related to handling of the check by comparing the check information read by the scanner with the transaction history stored in the memory, and performing handling related to the check corresponding to the risk level.

2. The paper handling machine according to claim 1, wherein the controller determines the risk level by comparing a past date and/or a day of the week of drawing contained in one or a plurality of the transaction histories, with a date and/or a day of the week of drawing contained in the check information read from the check being handled.

3. The paper handling machine according to claim 1, wherein the controller determines the risk level by comparing a past check amount contained in one or a plurality of the transaction histories, with a check amount contained in the check information read from the check being handled.

4. The paper handling machine according to claim 1, wherein the controller determines the risk level by comparing a check number that has been handled and contained in one or a plurality of the transaction histories, with a check number contained in the check information read from the check being handled.

5. The paper handling machine according to claim 1, wherein the controller determines a handling charge required for cashing of the check corresponding to the risk level, and dispenses a currency of an amount calculated by subtracting the handling charge from the read check amount.

6. The paper handling machine according to claim 1, wherein the controller halts handling of the check in the case the risk level is higher than a predetermined level.

7. The paper handling machine according to claim 1, further comprising a biometric information obtaining unit for obtaining a biometric information of a user, wherein the controller requires the user to input the biometric information in the case the risk level is higher than a predetermined level.

8. The paper handling machine according to claim 7, wherein the controller performs handling of the check only in the case the biometric information obtained by the biometric information obtaining unit corresponds with a pre-registered biometric information of the user.

9. The paper handling machine according to claim 1, wherein the controller transmits, to an external machine, a signal indicating a remote confirmation is required in the case the risk level is higher than a predetermined level, and causes the paper sheet handling machine to perform handling of the check only in the case a permission is received from the external machine.

10. The paper handling machine according to claim 1, wherein the controller halts handling of the check in the case a check number read by the scanner corresponds with a check number that has been handled and contained in one or a plurality of the transaction histories.

11. A method of handling a paper sheet including a check comprising:
reading a check information including a check drawer information to identify a check drawer of the check, from the check;
obtaining a transaction history related to the check drawn by the drawer based on the read check drawer information;
comparing the obtained transaction history with the check information read by the scanner;
determining a risk level related to handling of the check based on a comparison result; and,
performing handling of the check in a manner corresponding to the risk level.

12. A method of handling a paper sheet including a check comprising:
capturing an image of the check;
reading a check information including at least any one of a bank number, an account number, a check number, a date of drawing, and a check amount, from the check image;
obtaining a transaction history including the check information related to a check transacted in the past;
determining a risk level related to handling of the check by comparing the read check information with the transaction history; and,
performing handling of the check in a manner corresponding to the risk level.

13. The method of handling a paper sheet according to claim 12, wherein the determining of the risk level comprises determining the risk level by comparing a past date and/or a day of the week of drawing contained in one or a plurality of the transaction histories, with a date and/or a day of the week of drawing contained in the check information read from the check being handled.

14. The method of handling a paper sheet according to claim 12, wherein the determining of the risk level comprises determining the risk level by comparing a past check amount contained in one or a plurality of the transaction histories, with a check amount contained in the check information read from the check being handled.

15. The method of handling a paper sheet according to claim 12, wherein the determining of the risk level comprises determining the risk level by comparing a check number that has been handled and contained in one or a plurality of the transaction histories, with a check number contained in the check information read from the check being handled.

16. The method of handling a paper sheet according to claim 12, wherein the performing handling of the check comprises determining a handling charge required for cashing of the check corresponding to the risk level, and dispensing a currency of an amount calculated by subtracting the handling charge from the read check amount.

17. The method of handling a paper sheet according to claim 12, wherein the performing handling of the check comprises halting handling of the check in the case the risk level is higher than a predetermined level.

18. The method of handling a paper sheet according to claim 12, wherein the performing handling of the check comprises requiring a user to input a biometric information in the case the risk level is higher than a predetermined level.

19. The method of handling a paper sheet according to claim 12, wherein the performing handling of the check comprises:
transmitting a signal, to an external machine, indicating a remote confirmation is required, in the case the risk level is higher than a predetermined level; and,
halting handling of the check only in the case a permission from the external machine is not received.

20. The method of handling a paper sheet according to claim 12, wherein the performing handling of the check comprises halting handling of the check, in the case the read check number corresponds with a check number that has been handled and contained in one or a plurality of the transaction histories.
